(19) United States
(12) Patent Application Publication
(10) Pub. No.: US 2016/0025286 A1
(43) Pub. Date: Jan. 28, 2016

(54) OUTDOOR LIGHTING FIXTURE

(71) Applicant: Orion Energy Systems, Inc., Manitowoc, WI (US)

(72) Inventors: Jun Wang, Sheboygan, WI (US); John Scribante, Manitowoc, WI (US); Zachary Kurtz, Manitowoc, WI (US)

(21) Appl. No.: 14/806,542

(22) Filed: Jul. 22, 2015

Related U.S. Application Data
(60) Provisional application No. 62/027,656, filed on Jul. 22, 2014.
(60) Provisional application No. 62/091,340, filed on Dec. 12, 2014.

(51) Int. Cl. F21S 8/08; F21V 29/76; F21V 21/116; F21V 29/10

(52) U.S. Cl. CPC F21S 8/086; F21V 29/10; F21V 29/763; F21V 21/116; F21Y 2101/02

(57) ABSTRACT

A lighting fixture includes a core member, a first elongated lamp extending outwardly from the core member, a second elongated lamp extending outwardly from the core member, a cap coupled to at least one of the first elongated lamp and the second elongated lamp, and a connector selectively coupling at least one of the first elongated lamp and the second elongated lamp to the core member. A space is defined between the first elongated lamp and the second elongated lamp. The first elongated lamp and the second elongated lamp are positioned such that the space at least one of (a) allows debris to pass therethrough and (b) increases the heat transfer coefficient of the first elongated lamp and the second elongated lamp by at least reducing an overlap between boundary layers, developed from natural convection, associated with the first elongated lamp and the second elongated lamp.

### CROSS-REFERENCE TO RELATED PATENT APPLICATIONS

This application claims the benefit of U.S. Provisional Patent Application No. 62/027,656, titled “Outdoor Lighting Fixture,” filed on Jul. 22, 2014, and U.S. Provisional Patent Application No. 62/091,340, titled “Lighting Fixture with Modular Features,” filed on Dec. 12, 2014, the disclosures of which are hereby incorporated by reference in their entireties.

### BACKGROUND

This application relates generally to the field of lighting systems. In particular, this application relates to outdoor lighting systems having improved heat transfer, self-cleaning, and modularity capabilities for light output and light distribution. This application further relates to outdoor lighting systems having interchangeable end caps which may be changed to alter the look and feel of the lighting system, provide customized features such as advertising, and/or otherwise alter the lighting system. This application still further relates to outdoor lighting systems having mounting systems for mounting the lighting system in a variety of configurations.

Lighting systems may be used in several outdoor applications which include illuminating highways, parking lots, exteriors of buildings, and other outdoor areas. Outdoor lighting systems typically include some type of light-emitting device. Some light-emitting devices which are known in the art include: high-pressure mercury vapor lamps (HPM), metal-halide lamps, sodium vapor lamps, incandescent lamps, and light-emitting diode (LED) lamps. Each lighting system may be characterized by a variety of factors, such as the efficiency of the lighting system, the overall useful life of the lighting system, the color temperature of the lighting system, and the start-up cost of the lighting system. Further, a variety of factors may determine which type of outdoor lighting system to use for a particular application. These factors may include, but are not limited to, the efficiency of a lighting system, the number of lumens a lighting system can generate, the start-up cost of a lighting system, the amount of illumination a particular area requires, and the “light pollution” a particular area is allowed to tolerate.

### SUMMARY

One embodiment relates to a lighting fixture that includes a core member, a first elongated lamp including a first light-emitting device, the first elongated lamp extending outwardly from the core member in a first longitudinal direction, a second elongated lamp including a second light-emitting device, the second elongated lamp extending outwardly from the core member in a second longitudinal direction, a cap coupled to at least one of the first elongated lamp and the second elongated lamp, and a connector selectively coupling at least one of the first elongated lamp and the second elongated lamp to the core member. The second longitudinal direction is parallel to and offset from the first longitudinal direction such that a space is defined between the first elongated lamp and the second elongated lamp. The first elongated lamp and the second elongated lamp are positioned such that the space at least one of (a) allows debris to pass therethrough and (b) increases the heat transfer coefficient of the first elongated lamp and the second elongated lamp by at least reducing an overlap between boundary layers, developed from natural convection, associated with the first elongated lamp and the second elongated lamp.

Another embodiment relates to a lighting fixture that includes a core member, a first modular lamp including a first light-emitting device and a first cover configured to be positioned above the first light-emitting device, the first modular lamp configured to extend outwardly from the core member in a longitudinal direction, a second modular lamp including a second light-emitting device and a second cover configured to be positioned above the second light-emitting device, the second modular lamp configured to extend outwardly from the core member in the longitudinal direction, a cap configured to be coupled to at least one of the first modular lamp and the second modular lamp, and a connector configured to selectively couple at least one of (a) the first modular lamp to the core member, (b) the second modular lamp to the core member, and (c) the first modular lamp to the second modular lamp such that the first modular lamp and the second modular lamp are selectively reconfigurable between a plurality of orientations to provide a plurality of different lighting profiles.

Still another embodiment relates to a lighting fixture that includes a core member, a first set of one or more elongated lamps each including a light-emitting device and a cover positioned above the light-emitting device, the first set of one or more elongated lamps having a proximal end and an opposing distal end, a second set of one or more elongated lamps each including a light-emitting device and a cover positioned above the light-emitting device, the second set of one or more elongated lamps having a proximal end and an opposing distal end, a cap coupled to the second set of one or more elongated lamps, and one or more connectors coupling (a) the proximal end of the first set of one or more elongated lamps to the core member and (b) the proximal end of the second set of one or more elongated lamps to the opposing distal end of the first set of one or more elongated lamps, the one or more connectors configured to facilitate selectively reconfiguring the lighting fixture between two or more multi-tiered operating configurations.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1A illustrates a lighting fixture having modular components including interchangeable end caps, according to an exemplary embodiment.

FIG. 1B illustrates a sleeve for mounting a lighting fixture to a pole, according to an exemplary embodiment.

FIG. 2A illustrates a top view of a core member of a lighting fixture, having features for accepting modular components, mounted to a pole, according to an exemplary embodiment.

FIG. 2B illustrates a side view of a lighting fixture mounted to a pole, according to an exemplary embodiment.

FIG. 3A illustrates a top perspective view of a lighting fixture having lamp modules according to one embodiment.

FIG. 3B illustrates a bottom view of the lighting fixture illustrated in FIG. 3A.

FIG. 4A illustrates a top perspective view of a lighting fixture having lamp modules according to one embodiment.

FIG. 4B illustrates a bottom view of the lighting fixture illustrated in FIG. 4A.

FIG. 5A illustrates a top perspective view of a lighting fixture having lamp modules according to one embodiment.

FIG. 5B illustrates a bottom view of the lighting fixture illustrated in FIG. 5A.

FIG. 6A illustrates a top perspective view of a lighting fixture having lamp modules according to one embodiment.

FIG. 6B illustrates a bottom view of the lighting fixture illustrated in FIG. 6A.

FIG. 7A illustrates a top view of a lighting fixture and the possible configurations for including modular components according to one embodiment.

FIG. 7B illustrates a top view of a lighting fixture having four interchangeable end caps, according to an exemplary embodiment.

FIG. 7C illustrates a lighting fixture having modular components and an interchangeable end cap with visual elements, according to one embodiment.

FIG. 8A illustrates a core member of a lighting fixture and a mounting system for mounting the lighting fixture to a pole with a circular cross section, according to one embodiment.

FIG. 8B illustrates a core member of a lighting fixture and a mounting system for mounting the lighting fixture to a pole with a square cross section, according to one embodiment.

FIG. 8C illustrates a core member of a lighting fixture and a mounting system for mounting the lighting fixture to a ceiling or other structure above the lighting fixture, according to one embodiment.

FIG. 8D illustrates a core member of a lighting fixture and a mounting system for mounting the lighting fixture to a horizontally oriented pole, according to one embodiment.

FIG. 8E illustrates a core member of a lighting fixture and a mounting system, including a pivot mechanism, for mounting the lighting fixture to a pole, according to one embodiment.

FIG. 8F illustrates a core member of a lighting fixture and a mounting system, including arms, for mounting the lighting fixture to a pole, according to one embodiment.

FIG. 8G illustrates a plate for connecting to arms of a mounting system and a core member of a lighting fixture, according to one embodiment.

FIG. 8H illustrates a core member of a lighting fixture configured to receive interchangeable plates and an interchangeable plate having a light source, according to one embodiment.

FIG. 9 illustrates a perspective view of an outdoor light fixture, according to an exemplary embodiment.

FIG. 10 illustrates another perspective view of the outdoor light fixture shown in FIG. 9.

FIG. 11 is a top plan view of the outdoor light fixture shown in FIG. 9.

FIG. 12 is a left plan view of the outdoor light fixture shown in FIG. 9.

FIG. 13 is a front plan view of the outdoor light fixture shown in FIG. 9.

FIG. 14 is a detail view of a bottom portion of the outdoor light fixture shown in FIG. 9.

FIG. 15 is a cross-sectional view of the outdoor light fixture shown in FIG. 9.

FIG. 16 is another cross-sectional view of the outdoor light fixture shown in FIG. 9.

FIG. 17 is a detail view of a bottom portion of the outdoor light fixture shown in FIG. 9.

FIG. 18 is a detail view of a cross-sectional view of the outdoor light fixture shown in FIG. 9.

FIG. 19 illustrates a perspective view of an outdoor light fixture, according to an exemplary embodiment.

FIG. 20 illustrates another perspective view of the outdoor light fixture shown in FIG. 19.

FIG. 21 illustrates a perspective view of an outdoor light fixture, according to an exemplary embodiment.

FIG. 22 illustrates another perspective view of the outdoor light fixture shown in FIG. 21.

FIG. 23 illustrates a perspective view of an outdoor light fixture, according to an exemplary embodiment.

FIG. 24 illustrates another perspective view of the outdoor light fixture shown in FIG. 23.

FIG. 25 illustrates an exploded view of the components of the outdoor light fixture according to one embodiment.

FIG. 26 illustrates an alternative exploded view of the components of the outdoor light fixture according to one embodiment.

FIG. 27 illustrates a prospective view of the outdoor light fixture having plates on the end of the covers of a plurality of modular sections according to one embodiment.

FIG. 28 illustrates a plurality of lamp modules and their respective relationships according to one embodiment.

FIGS. 29A-G illustrate various views of a lamp module according to one embodiment.

FIGS. 30A-G illustrate various views of a cap for connecting to the end of an individual lamp module according to one embodiment.

FIGS. 31A-G illustrate various views of a cap for connecting to the ends of a plurality of lamp module modules according to one embodiment.

FIGS. 32A-58C illustrate modular components arranged into lighting fixtures having various alternative configurations, according to various embodiments.

### DETAILED DESCRIPTION

Compared to other types of lighting systems, LEDs may advantageously provide illumination at higher efficiencies over a longer useful life. However, LEDs generate greater amounts of heat compared to some other types of lighting systems. Over 80% of the energy that an LED consumes may be given off as heat. Further, the useful life and the efficiency of an LED may undesirably decrease if heat is not adequately transferred from the internal junction of the LED to the surrounding environment. The designs of the outdoor lighting systems known in the art may undesirably accumulate contaminants, such as dirt, dust, etc. As a result, these contaminants may insulate the lighting system, or otherwise impair the transfer of heat generated from the internal junction to the surrounding environment. Thus, it would be advantageous to provide an outdoor lighting system with improved heat transfer characteristics. Further, it would be advantageous to provide an improved modular outdoor lighting system that may assembled in different size configurations, according to a particular application. A modular optical system can provide different combinations of light distribution lenses to provide a variety of possible light distributions and/or meet a variety of light distribution requirements. Furthermore, it would be advantageous to provide a lighting system interchangeable end caps facilitating different lighting configurations, a mounting system operable to mount the lighting system in a variety of configurations, and/or interchangeable end caps with different designs.

Referring generally to the FIGURES, disclosed herein are exemplary embodiments for a lighting fixture. According to an exemplary embodiment, the lighting fixtures described herein are configured to prevent dirt and other contaminants from accumulating thereon, such that heat generated from the lighting fixture may be effectively transferred therefrom. The lighting fixtures described herein may also be configured to have a geometry maximizing heat transfer from natural convection. According to another exemplary embodiment, the lighting fixtures described herein are configured as modular assemblies such that a number of lamp modules comprising the lighting fixture may be based on the lighting needs of a particular location and/or the lighting distribution or desired lighting distribution for the particular location. The modular nature of the lighting fixture also allows for the use of interchangeable end caps to change the light output, aesthetics, lamp module configuration, or other characteristics of the lighting fixture. In further embodiments, the lighting fixture includes or may be used with a sleeve and/or other mounting components as part of an adaptable mounting system.

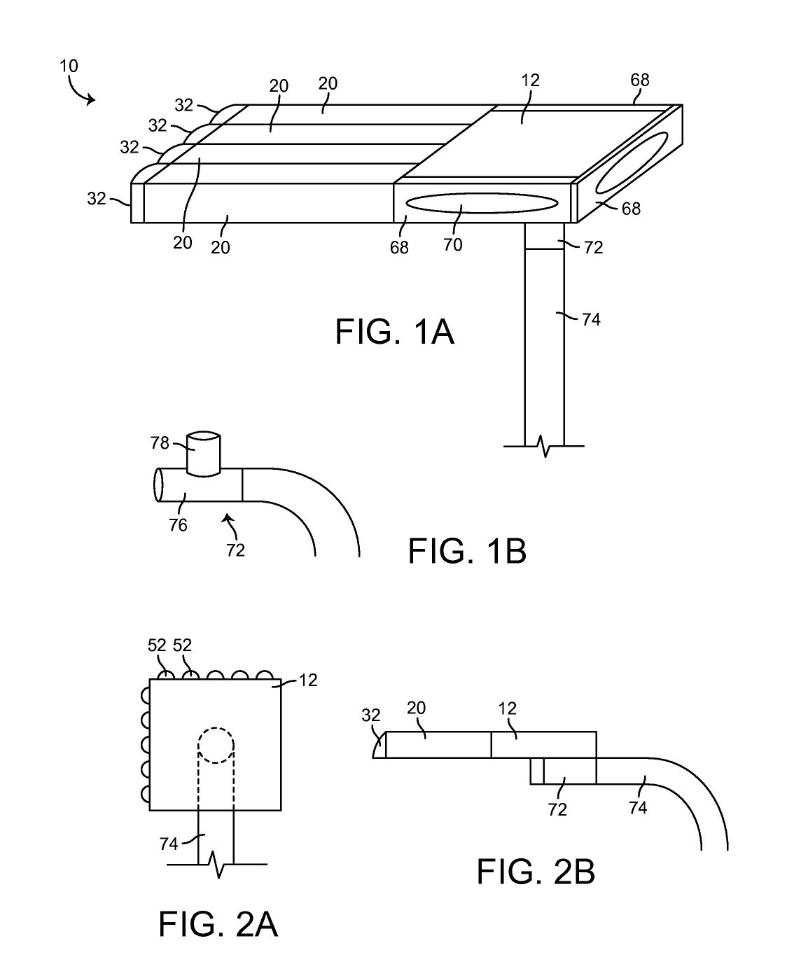

Referring now to FIG. 1A, lighting fixture 10 is illustrated according to one embodiment. Lighting fixture 10 is a modular system which allows for different numbers, types, and/or configurations of components. Lighting fixture 10 includes a core member 12 (referred to first member 12 herein) which is configured to be mounted to a pole, ceiling, and/or other structure. Lighting fixture 10 is further configured to and/or includes components or features which allow for lamp modules 20 to be coupled to core member 12. Lamp modules 20 may be removably coupled to core member 12 to allow for changes to the number and/or type of lamp modules 20 coupled to core member 12 and included in lighting fixture 10. The same features of lighting fixture 10 which allow for lamp modules 20 to be coupled to core member 12 may be used to couple one or more end caps 68 to core member 12. Caps 32 (also referred to as support members 32 herein) may be attached to the ends of one or more lamp modules 20.

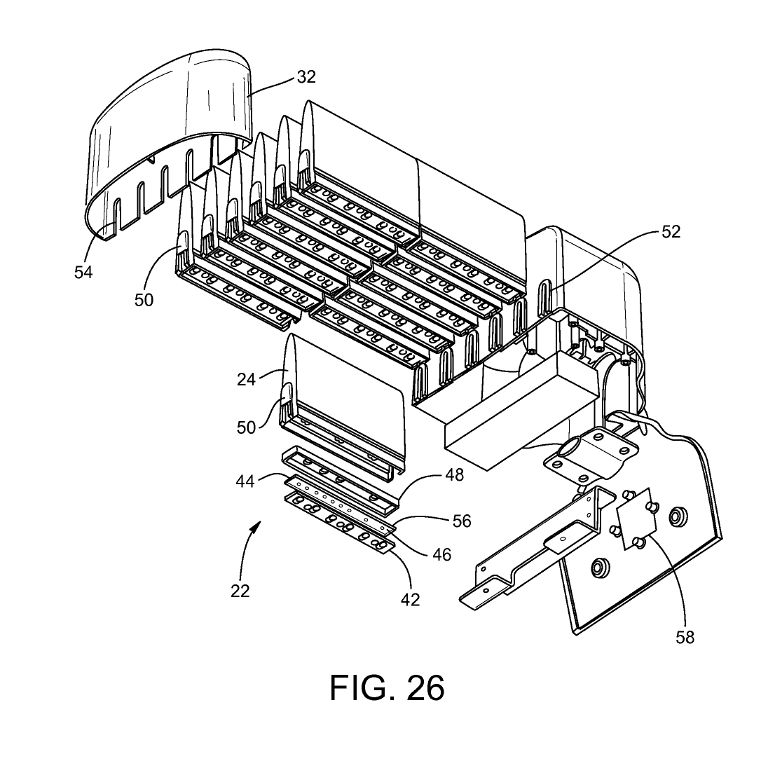

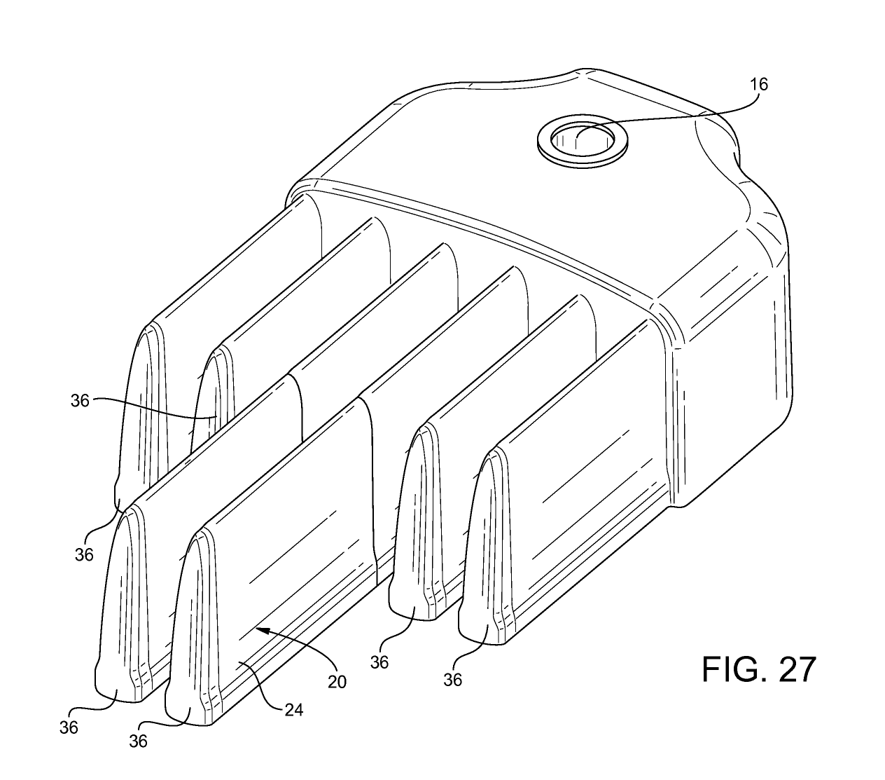

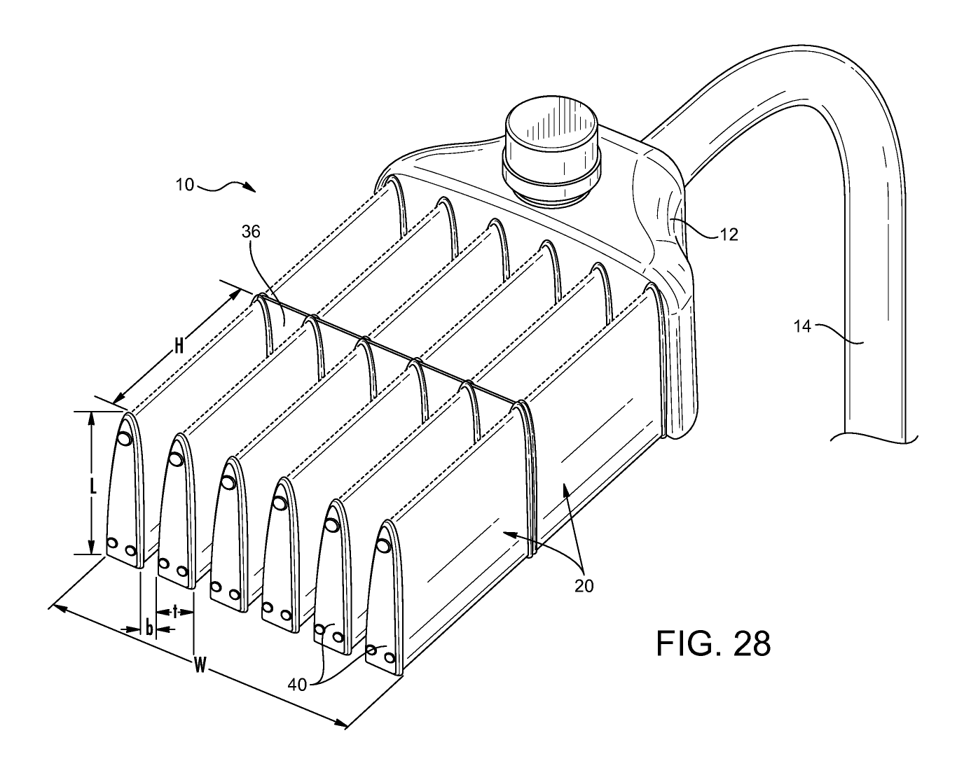

Core member 12 serves as the base of lighting fixture 10 to which additional modular components are attached. This allows lighting fixture 10 to be customized to suit lighting needs and/or a desired light output or aesthetic look. Referring now to FIG. 2A, core member 12, illustrated in a top view, includes a plurality of flanges 52 on one or more sides. Flanges 52 may be used to accept and/or secure lamp modules 20, caps 32, interchangeable end caps 68, and/or other modular components attached to the exterior of core member 12. Flanges 52 may be configured to support or otherwise interface with cutouts 54 (first shown in FIG. 26) in lamp modules 20, caps 32, interchangeable end caps 68, and/or other modular components. The coupling of modular components to core member 12, using these and/or other components, is described in more detail herein.

Referring again to FIG. 1A, core member 12 is configured to accept modular components on all four sides in one embodiment. For example, all four sides of core member 12 may include flanges 52 to which other modular components may be mounted. In alternative embodiments, first member 12 is configured to accept modular components on only a subset of the sides of core member 12. For example, only one side of core member 12 may include flanges 52 or other components for accepting modular components (e.g., lamp modules 20, caps 32, end caps 68, and/or other components). As described in more detail herein, modular components may be wired or otherwise electrically connected to one or more components housed in core member 12. For example, core member 12 may include a connection to a power supply, power supply, power regulation equipment or circuitry, control circuitry, sensors, transceivers, and/or other electronic equipment. Lamp modules 20, end caps 68, and/or other modular components may be wired to or otherwise put in electrical contact with these and/or other components as the modular components are attached to core member 12. The electronic components which may be included within core member 12 are described in more detail herein.

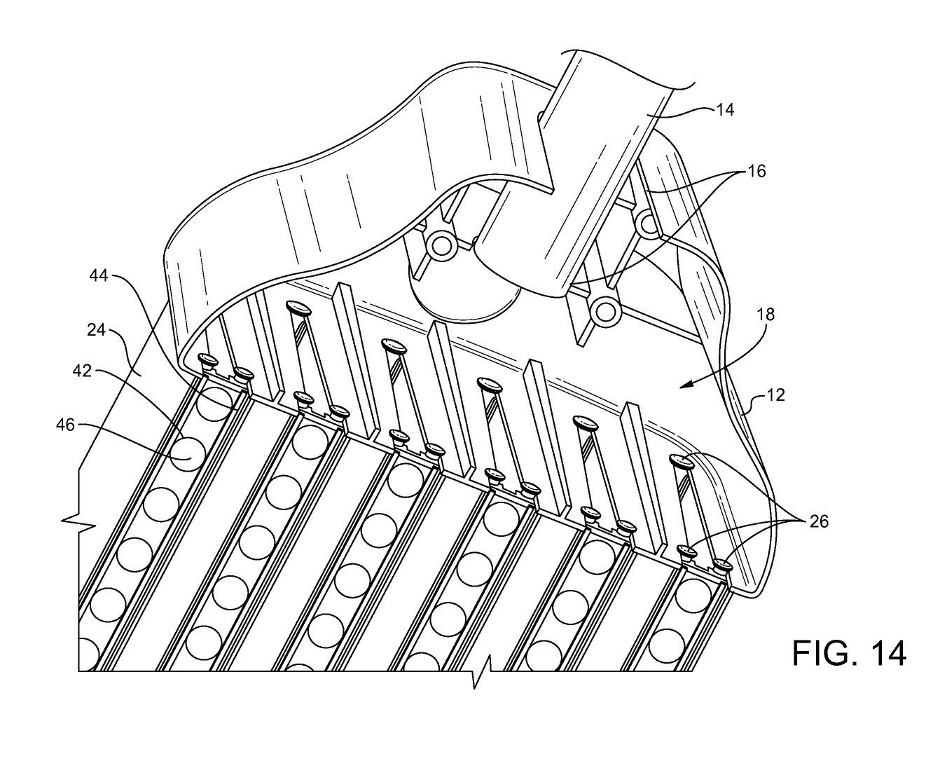

In some embodiments, modular components (e.g., lamp modules, end caps 68, caps 32, and/or other modular components) can be coupled to and/or uncoupled from core member 12 without the use of tools. For example, core member 12 may include flanges 52 onto which cutouts 54 included in the modular component are placed. This allows the flange 52 to support cutout 54 and the modular component. Modular components can be added by placing cutout 54 above flange 52 and lowering the modular component onto core member 12. The modular component may be removed without tools in some embodiments. For example, pushing up on the modular component or otherwise lifting the modular component may cause cutout 54 to disengage with flange 52 allowing for the modular component to be removed. In some embodiments, flanges 52 and/or cutouts 54 may include contacts for establishing an electrical connection between modular components and core member 12 and/or other modular components. In further embodiments, fasteners and/or other connectors which do not require tools may be used in place of or in conjunction with flanges 52 and cutouts 54. For example, modular components may be wired to core member 12 using quick disconnect type connectors. A snap fit between components, quarter turn screw, latch, and/or other fastener may be used to removably couple modular components to core member 12 and/or other modular components. In further embodiments, flanges 52 and/or rods 26 (first shown in FIG. 14) may be used to removably couple modular components to core member 12 and/or other modular components as described herein. In some embodiments, modular components are not permanently connected to core member 12. For example, modular components are not welded to, glued to, screwed to, riveted to, or otherwise permanently attached to core member 12. Advantageously, tool-less interchangeability of modular components of lighting fixture 10 allows lighting fixture 10 to be easily and quickly customized for producing different light outputs, producing different aesthetics, changing advertising via end caps 68, upgrading lamp modules 20, replacing components, and/or otherwise modifying lighting fixture 10.

End caps 68 are configured to be interchangeably coupled to core member 12. In some embodiments, end cap 68 includes one or more cutouts 54. Cutouts 54 may allow for the end cap 68 to be removably coupled to one or more flanges 52 of core member 12. In alternative embodiments, other components and/or features may be used to removably couple end cap 68 to core member 12. End cap 68 maybe coupled to core member 12 using the same components, features, and/or techniques as described with respect to cap 32 and/or lamp module 20 herein. In further alternative embodiments, end cap 68 couples to core member 12 using a technique other those using flanges 52 and/or rods 26 as described herein. For example, core member 12 may have or include a slot configured to accept end cap 68. End cap 68 may be inserted into the slot. End cap 68 may be secured by the operation of gravity, an interference fit, a latch, and/or other fastener or technique. In other cases, end cap 68 may be removably coupled to core member 12 using a fastener. For example, core member 12 may include a notch or slot to accept a quarter turn screw included in end cap 68.

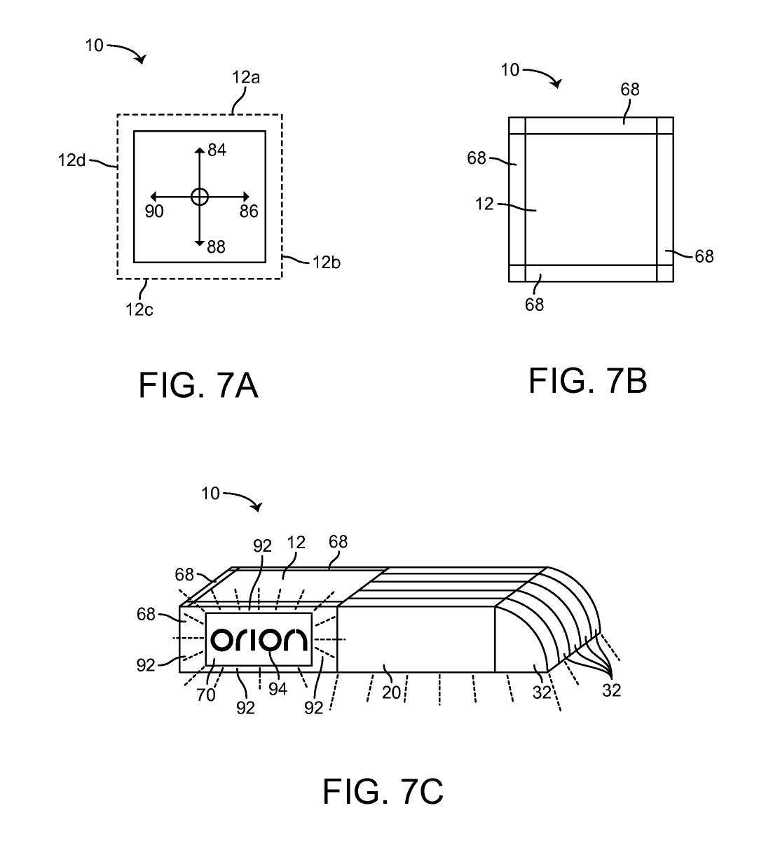

In some embodiments, end cap 68 is backlit. This may provide aesthetic value to lighting fixture 10. In further embodiments, described in more detail with reference to FIGS. 7B-C, end cap 68 may include a message, design, logo, image, and/or other feature. End cap 68 may be back lit in order to draw attention to one or more of these features and/or improve visibility of such a feature. End cap 68 may include a light source (e.g., an LED) within end cap 68 for providing backlighting. In further embodiments, the light source may be used for useful illumination beyond backlighting (e.g., general lighting, task lighting, etc.). The light source may be coupled to control, power supply, and/or other electronics located within core member 12. End cap 68 may include a driver and/or other features to support or facilitate the use of the light source. In alternative embodiments, end cap 68 is backlit from a light source included within core member 12 (e.g., an LED). The interface between core member 12 and end cap 68 may be translucent or transparent to allow for light produced within core member 12 to enter end cap 68 and provide backlighting and/or other types of lighting.

In some embodiments, end cap 68 includes one or more lenses 70. Lenses 70 may be used to provide an outlet for light generated within or passing through end cap 68. Lenses 70 may be rectangular, square, ovals, and/or other shapes. Lenses 70 may be convex, concave, flat, or have other three dimensional structures or shapes. In some embodiments, lenses 70 alter the light output by or from end cap 68. For example, lenses 70 may filter, direct, or otherwise control the light provided by end cap 68.

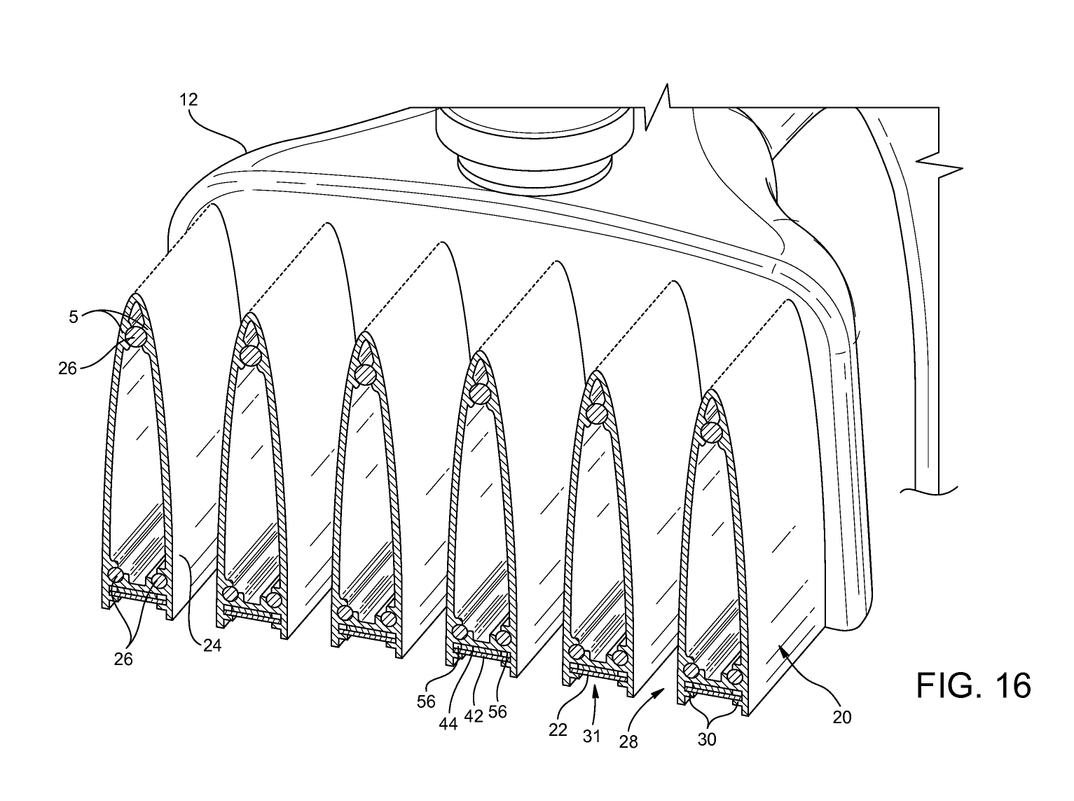

Still referring to FIG. 1A, lighting fixture 10 includes one or more lamp modules 20, caps 32, and/or plates 36 (shown in FIG. 19). Lamp modules 20 are modular and may be coupled to one another, core member 12, cap 32, plate 36, and/or other components. Lamp modules 20 include one or more light source (e.g., LEDs) for providing light. The number, arrangement, and/or types of lamp modules 20 included in lighting fixture 10 may be used to control the light output of lighting fixture 10. As illustrated, a single lamp module 20 may be provided for each flange 52 of core member 12. Each row includes a single lamp module 20. In other embodiments, each row may include any number of lamp modules 20. For example, each row may include two lamp modules 20 coupled to one another with one lamp module 20 coupled to core member 12. In alternative embodiments, each row may have different numbers of lamp modules 20 and/or other numbers of lamp structures may be used. Lamp modules 20 may be capped by a cap 32 or plate 36. Lamp modules 20, caps 32, and/or plates 36 components are discussed in greater detail herein. In some embodiments, lamp modules 20 have 50% of the mass of the lamp structures described herein. In order to achieve this mass savings, lamp modules 20 may have smaller dimensions (e.g., shorter length, width, or height), may constructed of different materials (e.g., plastic vs. metal, less dense metal alloy, etc.), may have thinner covers 24 (first shown in FIG. 16), and/or otherwise have design changes resulting less mass.

In one embodiment, core member 12 and/or lamp modules 20 are configured or shaped such that there is substantially no space between rows of lamp modules 20. In alternative embodiments, core member 12 and/or lamp modules 20 are configured such that the space between rows of lamp modules 20 enhances the natural heat convection of heat away from lamp modules 20 and/or the light source located therein. Lamp module 20 may also be shaped in order to enhance heat transfer and/or avoid the accumulation of debris between rows of lamp modules. The heat transfer enhancing structure and/or debris avoiding structure of the components of lighting fixture 10 are described in greater detail herein.

Core member 12 includes one or more components or features for mounting lighting fixture 10 in some embodiments. In one embodiment, core member 12 includes sleeve 72. Sleeve 72 is configured to mount lighting fixture 10 to pole 74. Pole 74 may be a lighting pole of any type or configuration (e.g., circular cross section, square cross section, etc.). Pole 74 may be a pole used in conjunction with a light fixture for illuminating a roadway, parking lot, sidewalk, driveway, exterior of a structure, and/or other outdoor area. In further embodiments, lighting fixture 10 is used in indoor lighting applications. Sleeve 72 may fit over pole 74. Sleeve 72 may be secured to pole 74 due to the operation of gravity, an interference fit, using an adhesive, using a fastener, and/or otherwise be secured to pole 74. Sleeve 72 may be an integral part of the core member 12. For example, sleeve 72 may be cast with a housing of core member 12, welded to core member 12, and/or otherwise incorporated into core member 12. In alternative embodiments, sleeve 72 is removably attached to core member 12. For example, sleeve 72 may be inserted into a receiving portion (e.g., a cutout or other space) extending within core member 12. Sleeve 72 may be secured to core member 12 using the operation of gravity, an interference fit, adhesives, fasteners, and/or other techniques. The mounting of lighting fixture 10 is described in more detail with reference to FIGS. 1B-2B and 8A-8H.

Referring now to FIG. 1B, sleeve 72 is illustrated according to one embodiment. Sleeve 72 may include a first portion 76 and a second portion 78. Sleeve 72 may include two portions in order to mount lighting fixture 10 vertically on a pole 74 with a horizontal orientation. First portion 76 may be configured to be coupled to pole 74. As previously described, first portion 76 of sleeve 72 may be coupled to pole 74 using the operation of gravity, welding, an interference fit, adhesive fasteners (e.g., screws, set screws, rivets, quarter turn screws, and/or other fasteners), and/or other techniques. First portion 76 may be substantially horizontal. Second portion 78 may extend at a 90 degree angle from first portion 76. This allows for core member 12 to be coupled to sleeve 72 via second portion 78 in such a way that lighting fixture 10 is horizontal relative to the ground. Second portion 78 may be coupled to core member 12 using any of the techniques previously described herein for coupling sleeve 72 to other components. Advantageously, sleeve 72 allows for installation of lighting fixture 10 on horizontally oriented poles 74. In further embodiments, first portion 76 and second portion 78 may be oriented at other angles.

In some embodiments, sleeve 72, having first portion 76 and second portion 78, also allows for installation of lighting fixture 10 on vertically oriented poles. First portion 76 may be coupled to the vertically oriented pole 74. Core member 12 may be coupled to the opposing side of first portion 76. Second portion 78 may go unused. Advantageously, this allows a single sleeve 72 to be used while allowing lighting fixture 10 to be installed on either vertically or horizontally oriented poles 74.

In FIG. 1B, sleeve 72 is illustrated as having a circular cross section. In alternative embodiments, sleeve 72 may have other cross sections. For example, sleeve 72 may have a square or rectangular cross section. In FIG. 1B, sleeve 72 is illustrated as separable from core member 12. In alternative embodiments, sleeve 72 is an integral portion of core member 12.

Referring now to FIG. 2A, a top view of core member 12 and pole 74 is illustrated according to one embodiment. Pole 74 is a horizontally oriented pole 74. Core member 12 is coupled to pole 74 via sleeve 72. Sleeve 72 extends within the underside of core member 12. Lighting fixture 10 and core member 12 are illustrated with no end caps 68, lamp modules 20, caps 32, or other modular components coupled to core member 12. Flanges 52 extend from core member 12 to allow for the installation of one or more modular components. In the illustrated embodiment, core member 12 includes flanges 52 on only two sides. Therefore, modular components may only be installed on two sides of core member 12. In alternative embodiments, flanges 52 and/or other components for received modules are on other, fewer, or more sides of core member 12. In still further embodiments, the sides without flanges 52 may support end caps 68. For example, those sides of core member 12 may include slots and/or other features to accept end caps 68.

Referring now to FIG. 2B, a side view of lighting fixture 10 is illustrated according to one embodiment. Lighting fixture 10 and core member 12 are mounted to a horizontally oriented pole 74. Sleeve 72 is coupled to both pole 74 and to core member 12. Lighting fixture 10 includes at least one lamp module 20 and at least one cap 32. Advantageously, sleeve 72 allows lighting fixture 10 to be mounted with a horizontal orientation on a horizontally oriented pole 74 without changing the mounting location on core member 12. The mounting location remains on the underside of core member 12.

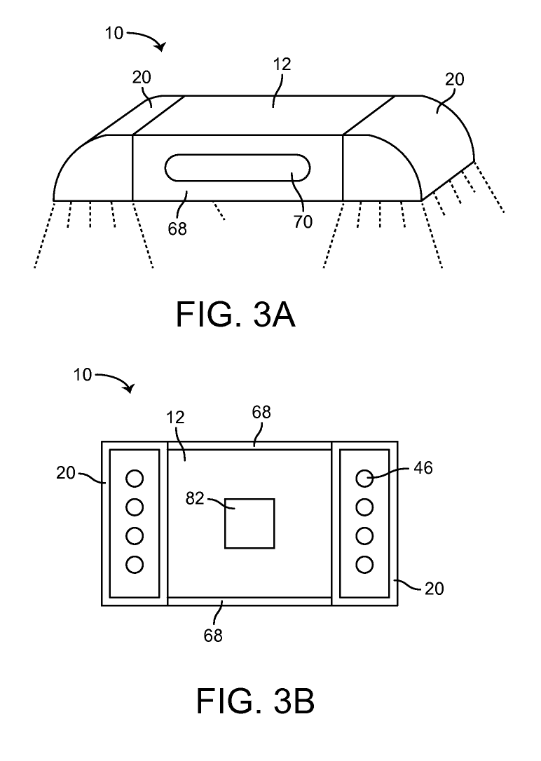

Referring now to FIGS. 3A-3B, lighting fixture 10 is illustrated according to one alternative embodiment. FIG. 3A illustrates a top perspective view of lighting fixture 10 and FIG. 3B illustrates a bottom view of lighting fixture 10 according to one embodiment. In some embodiments, lighting fixture 10 may include lamp modules 20 having a substantially quarter circle cross section. In some embodiments, lamp modules 20 having a substantially quarter circle cross section are configured such that multiple lamp modules 20 may not be used on the same side of core member 12. In alternative embodiments, lamp modules 20 having a substantially quarter circle cross section may be used in conjunction with one or more lamp modules 20 as described and illustrated in FIG. 1 and herein.

In some embodiments, two lamp modules 20 are located on opposing sides of core member 12. In alternative embodiments, more or fewer lamp modules 20 may be coupled to core member 12. In some embodiments, the sides of core member 12 not having or being configured to receive lamp modules 20 (e.g., not including flanges 52 in some embodiments) include and/or are configured to receive end caps 68.

Referring now to FIG. 3B, the underside of core member 12 may include a square opening 82 used for mounting lighting fixture 10. Square opening 82 may be configured to receive a pole 74 and/or sleeve 72 with a square cross section. Lamp modules 20 may extend the width of core member 12 as illustrated. In alternative embodiments, lamp modules 12 may have a width which varies from that of core member 12 (e.g., greater or lesser than the width of core member 12). Lamp modules 20 may include one or more light sources. In some embodiments, lamp modules include a plurality of LEDs 46. LEDs 46 may include individual lenses or a single lens spanning a plurality of LEDs 46. In some embodiments, lamp module 20 includes a lens in addition to or in place of one or more lenses for LEDs 46.

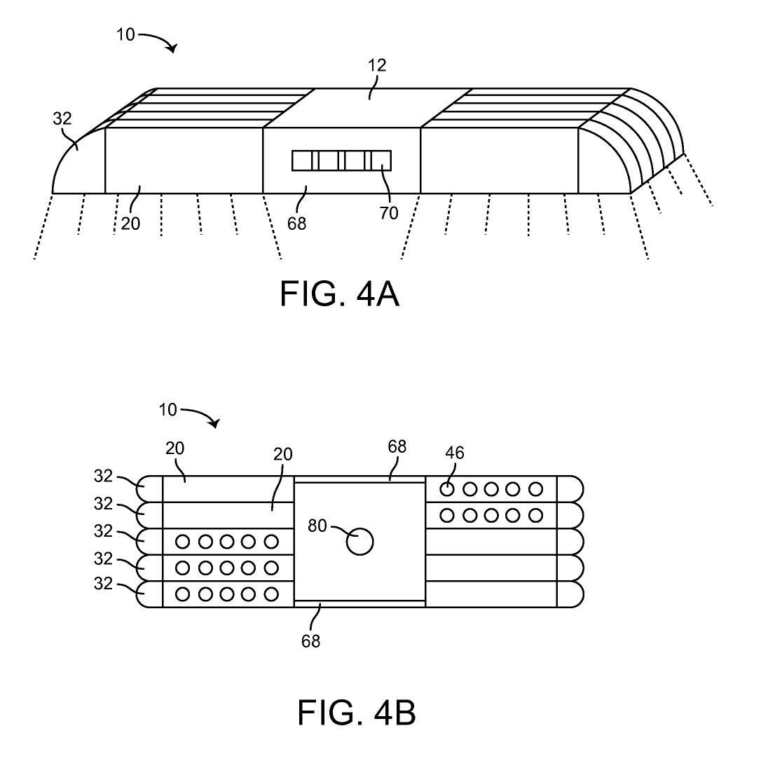

Referring now to FIGS. 4A-4B, lighting fixture 10 is illustrated according to one alternative embodiment. FIG. 4A illustrates a top perspective view of lighting fixture 10 and FIG. 4B illustrates a bottom view of lighting fixture 10 according to one embodiment. In some embodiments, lighting fixture 10 may include lamp modules 20 having a substantially rectangular cross section. Lamp modules 20 may be used in conjunction with one or more lamp modules 20 as described with reference to FIG. 1 and herein. Lamp modules 20 may be capped with caps 32 as described herein.

In some embodiments, lamp modules 20 are located on opposing sides of core member 12. In alternative embodiments, more, fewer, or other sides of core member 12 includes lamp modules 20. In some embodiments, the sides of core member 12 not having or being configured to receive lamp modules 20 (e.g., not including flanges 52 in some embodiments) include and/or are configured to receive end caps 68.

Referring now to FIG. 4B, the underside of core member 12 may include a circular opening 80 used for mounting lighting fixture 10. Circular opening 80 may be configured to receive a pole 74 and/or sleeve 72 with a circular cross section. Multiple lamp modules 20 may be coupled to a single side of core member 12. Lamp modules 20 may include one or more light sources. In some embodiments, lamp modules include a plurality of LEDs 46. LEDs 46 may include individual lenses or a single lens spanning a plurality of LEDs 46. In some embodiments, lamp module 20 includes a lens in addition to or in place of one or more lenses for LEDs 46. In some embodiments, lighting fixture 10 includes lamp modules 20 which do not include light sources. These lamp modules 20 may be used for aesthetic purposes. The placement, number, combination, and/or other characteristics of lamp modules 20 not having light sources and/or lamp modules 20 having light sources may be customized to produce a specific light output from lighting fixture 10.

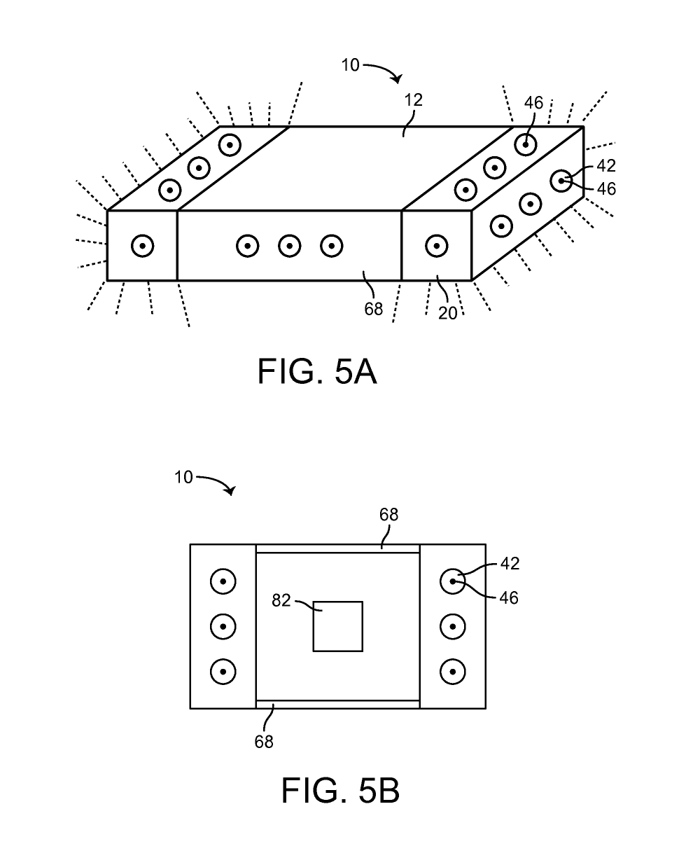

Referring now to FIGS. 5A-5B, lighting fixture 10 is illustrated according to one alternative embodiment. FIG. 5A illustrates a top perspective view of lighting fixture 10 and FIG. 5B illustrates a bottom view of lighting fixture 10 according to one embodiment. In some embodiments, lighting fixture 10 may include lamp modules 20 having a substantially rectangular cross section and a substantially rectangular profile. In some embodiments, only a single lamp module 20 may be used on a side of core member 12. In other embodiments, lamp modules 20 having a substantially rectangular cross section and a substantially rectangular profile may be used in conjunction with one or more lamp modules 20 as described with reference to FIG. 1 and herein. Lamp modules 20 as illustrated in FIGS. 5A and 5B may include at least one light source. In some embodiments, lamp modules 20 include a plurality of LEDs 46. Each LED 46 may have an LED lens 42. In some embodiments, each side of lamp module 20, except for the side facing core member 12, includes a light source (e.g., one or more LEDs 46). Advantageously, this may allow lighting fixture 10 to provide light in all directions in the case in which lighting fixture 10 includes lamp modules 20 on opposing sides of core member 12.

In some embodiments, lamp modules 20 are located on opposing sides of core member 12. In alternative embodiments, more, fewer, or other sides of core member 12 include lamp modules 20. In some embodiments, the sides of core member 12 not having or being configured to receive lamp modules 20 (e.g., not including flanges 52 in some embodiments) include and/or are configured to receive end caps 68. End caps 68 may include one or more light sources. In some embodiments, end caps include one or more LEDs 46. Each LED 46 may have an LED lens 42. In other embodiments, other light sources and/or LED 46 configurations are possible. Advantageously, end caps 68 may provide additional illumination.

Referring now to FIG. 5B, a bottom view of lighting fixture 10 is illustrated in an embodiment corresponding to the top perspective view illustrated in FIG. 5A. The underside of core member 12 may include an opening for mounting lighting fixture 10. Lamp modules 20 may include one or more light sources directed downward. In some embodiments, lamp modules include a plurality of LEDs 46. LEDs 46 may include individual lenses or a single lens spanning a plurality of LEDs 46. In some embodiments, lamp module 20 includes a lens in addition to or in place of one or more lenses for LEDs 46. Lighting fixture 10 further includes square opening 82 used for mounting lighting fixture 10.

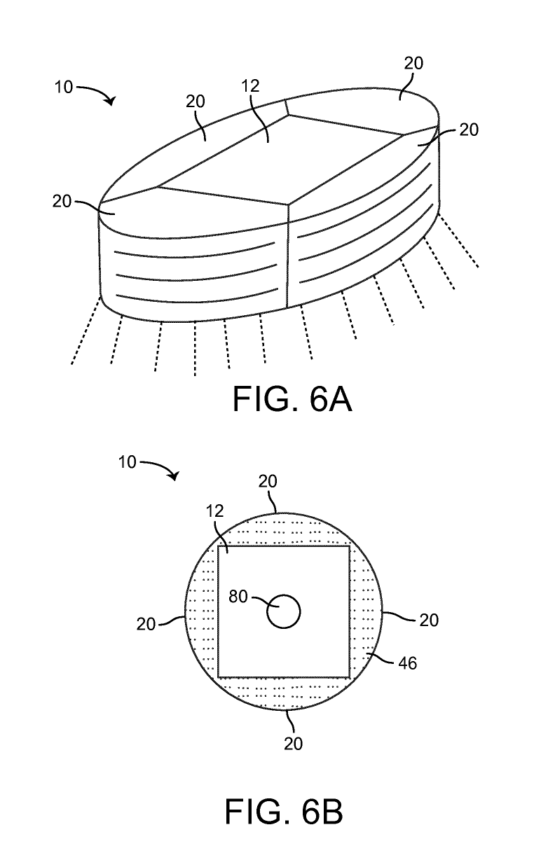

Referring now to FIGS. 6A-6B, lighting fixture 10 is illustrated according to one alternative embodiment. FIG. 6A illustrates a top perspective view of lighting fixture 10 and FIG. 6B illustrates a bottom view of lighting fixture 10 according to one embodiment. In some embodiments, lighting fixture 10 may include lamp modules 20 having a substantially hemispherical shape when viewed from above. In some embodiments, only a single lamp module 20 may be used on a side of core member 12. In other embodiments, lamp modules 20 having a substantially hemispherical shape when viewed from above may be used in conjunction with one or more lamp modules 20 of the type described with reference to FIG. 1 and herein. Lamp modules 20 as illustrated in FIGS. 6A and 6B, may include at least one light source. In some embodiments, lamp modules 20 include a plurality of LEDs 46. Each LED 46 may have an LED lens 42. Alternatively, a single lens may be used for all or a plurality of LEDs 46. In some embodiments, the light source of lamp module 20 only produces light in a downward direction. The light source may only be included on the bottom surface of lamp module 20. In alternative embodiments, light sources may also be included on the side and/or top of lamp module 20.

In some embodiments, lamp modules 20 are located on all sides of core member 12. In alternative embodiment, fewer sides of core member 12 includes lamp modules 20. In one embodiment, lighting fixture 10 does not include an end cap 68. In some embodiments, the sides of core member 12 not having or being configured to receive lamp modules 20 (e.g., not including flanges 52 in some embodiments) include and/or are configured to receive end caps 68.

Referring now to FIG. 6B, a bottom view of lighting fixture 10 is illustrated in an embodiment corresponding to the top perspective view illustrated in FIG. 6A. The underside of core member 12 may include an opening for mounting lighting fixture 10. Lamp modules 20 may include one or more light sources directed downward. In some embodiments, lamp modules include a plurality of LEDs 46. LEDs 46 may include individual lenses or a single lens spanning a plurality of LEDs 46. In some embodiments, lamp module 20 includes a lens in addition to or in place of one or more lenses for LEDs 46. Lighting fixture 10 further includes circular opening 80 used for mounting lighting fixture 10.

Referring now to FIG. 7A, a top view of lighting fixture 10 is illustrated according to one embodiment. The top view of lighting fixture 10 includes sides 12a-12d of core member 12. Sides 12a-12d correspond to directions 84-90 as illustrated. Advantageously, core member 12 may include hardware, components, and/or other features (e.g., flanges 52) such that modular components (e.g., lamp modules 20, end caps 68, and/or other modules) may be included on any of sides 12a-12d. This allows core member 12 to be used as a universal housing for lamp modules 20. Combinations of lamp modules on sides 12a-12d of core member 12 may be used to provide light in different situations. All of sides 12a-12d may have lamp modules 20 attached. In alternative embodiments, lamp modules 20 may be attached to opposing sides (e.g., attached to sides 12a and 12c or attached to sides 12d and 12b). In further alternative embodiments, lamp modules 20 may be attached to adjacent sides of core member 12 (e.g., attached to sides 12a and 12b, 12b and 12c, 12c and 12d, or 12d and 12a). In still further embodiments, lamp modules 20 may be attached only to a single side. In still further embodiments, lamp modules 20 may be attached to three sides (e.g., 12a, 12b, and 12c). Various combinations of sides are possible. End caps 68 and/or other modular components may be similarly attached to various sides. Referring now to FIG. 7B, a top view of lighting fixture 10 is illustrated according to one embodiment. In some embodiments, lighting fixture 10 includes an interchangeable end cap 68 on all sides of core member 12. In alternative embodiments, end caps 68 may be on fewer numbers of sides.

Referring now to FIG. 7C, lighting fixture 10 is illustrated with an end cap 68 having a logo according to one embodiment. End cap 68 may include a logo, information, design, text, images, and/or other visual elements 94. Visual elements 94 may be illuminated from one or more light sources and/or one or more light sources of different colors. In some embodiments, the visual elements 94 are achieved by incorporating or applying a filter to lens 70. A light source may back light lens 70 displaying and/or providing contrast for the visual elements 94. In other embodiments, the visual elements 94 are a printed image behind lens 70 and illuminated by the light source. In still further embodiments, the visual elements 94 may be applied directly to an outer surface of the end cap 68. The end cap may not include lens 70 and/or backlighting in some cases. The visual elements 94 may be applied directly to end cap 68 using techniques such as applying a visual wrap, using adhesives to attach an image printed on another material, printing on metal, engraving on anodized or otherwise colorized metal, and/or using other techniques. Advantageously, the interchangeable nature of end caps 68 allow for updated visual elements 94 to be displayed using lighting fixture 10.

In some embodiments, end cap 68 may be rectangular and/or have other shapes. End cap 68 may include lens 70 for backlighting and/or providing a logo, design, or other feature. In alternative embodiments, end cap 68 may be opaque or otherwise not include lens 70. In one embodiment, end cap 68 includes frame members 92. Frame members 92 may secure lens 70. In some embodiments, lens 70 is removable from frame members 92. Frame members 92 may also support or include one or more features for coupling end cap 68 to core member 12. For example, one or more frame embers may include one or more cutouts 54 for securing end cap 68 to flanges 52 of core member 12. In alternative embodiments, frame members 92 may include other features for securing end cap 68 to core member 12. For example, frame member 92 may include a quarter turn screw which passes through frame member 92. A screw head may remain accessible on the side surface and/or another surface of frame member 92 for securing and removing end cap 68. Core member 12 may include a notch or other feature on one or more surfaces for accepting the quarter turn screw. In still further embodiments, frame members 92 are configured such that end cap 68 fits into a slot included in core member 12. In further embodiments, end cap 68 may be configured to snap onto core member 12. For example, core member 12 may have a ridge and/or other protrusion onto which frame member 92 snaps. Frame member 92 may include a notch or groove into which the ridge or other protrusion of the core member 12 fits. In alternative embodiments, end cap 68 may be an integral piece without frame member 92.

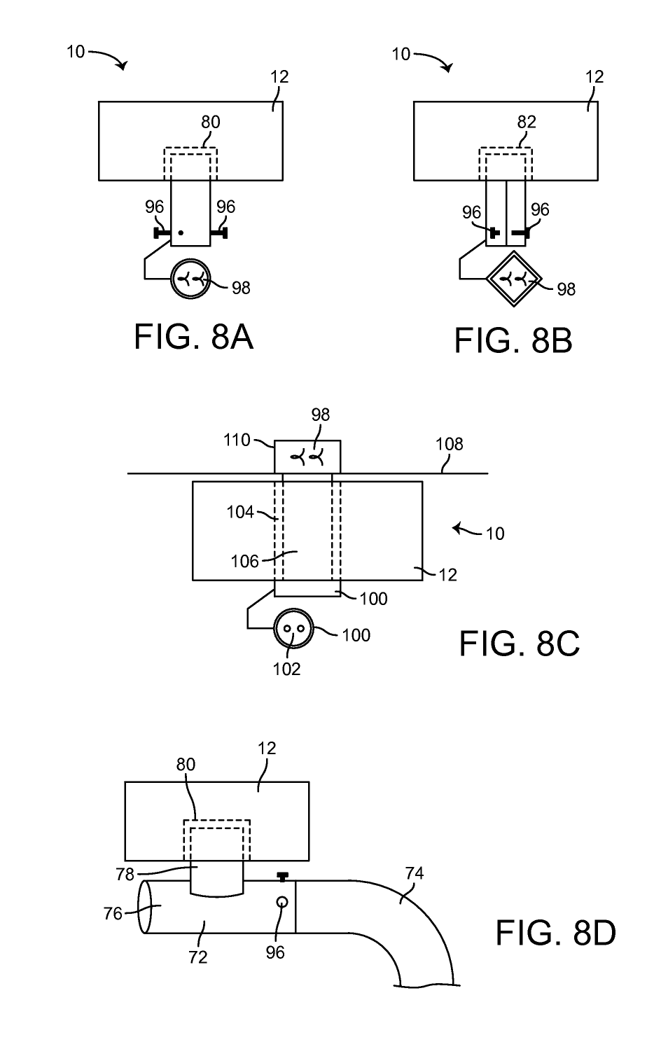

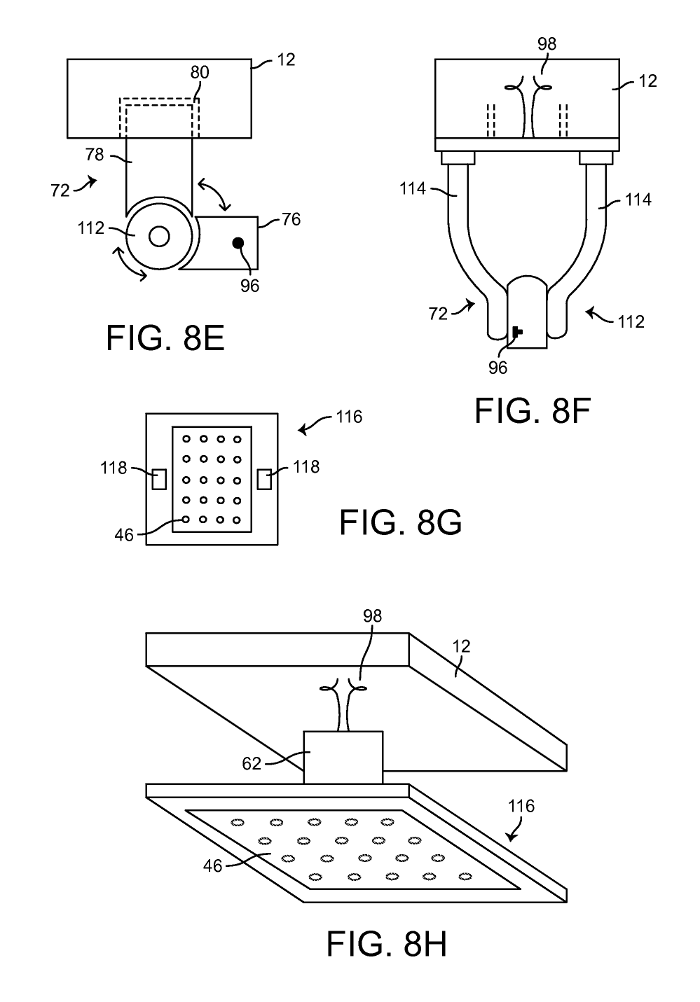

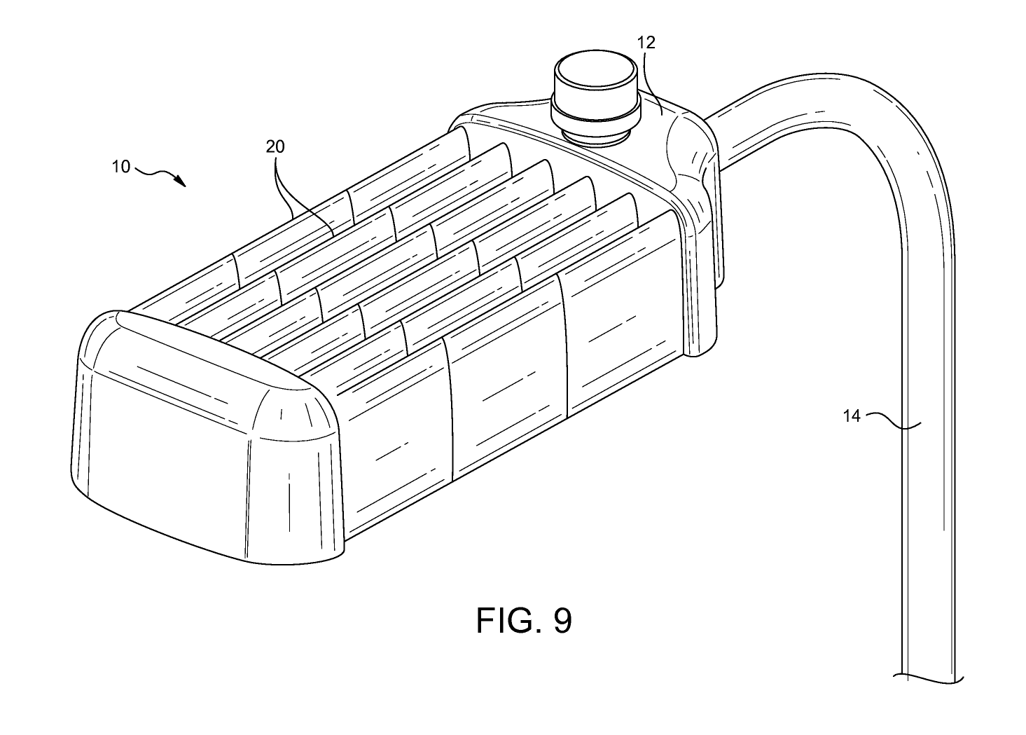

Referring now to FIGS. 8A-8H, lighting fixture 10 is illustrated with various mounting systems according to various embodiments. Referring now to FIG. 8A, core member 12 is illustrated with a mount having a circular cross section. The mount may be configured with an inner diameter such that the mount fits over a pole 74 having a circular cross section. The mount may include one or more screws 96 to secure the mount to the pole 74. In some embodiments, the screws are set screws and do not penetrate the pole 74. In alternative embodiments, screws 96 do penetrate the pole 74 to secure the mount to the pole 74. In alternative embodiments, the mount does not include screws 96. The mount maybe secured to pole 74 by gravity, an interference fit, adhesives, welding, other fasteners, and/or using other techniques and/or components.

In some embodiments, the mount is an integral portion of core member 12. In alternative embodiments, the mount is secured to or within a circular opening 80 in core member 12. The mount may be secured by gravity, an interference fit, adhesives, welding, other fasteners, and/or using other techniques and/or components. In some embodiments, the mount is or includes sleeve 72. In alternative embodiments, core member 12 is mounted directly to pole 74 using circular opening 80. Core member 12 may be wired to one or more external components via wiring 98 ran through the mount (e.g., sleeve 72) and/or pole 74. Core member 12 may be wired to a power source, control equipment, communication equipment, and/or other electronics. In some embodiments, core member 12 includes a segment of wiring 98 with a quick disconnect type connector for easily wiring core member 12 to wiring exiting pole 74.

Referring now to FIG. 8B, core member 12 is illustrated with a mount having a square cross section. The mount may be configured with inner dimensions such that the mount fits over a pole 74 having a square cross section. The mount may include one or more screws 96 to secure the mount to the pole 74. In some embodiments, the screws are set screws and do not penetrate the pole 74. In alternative embodiments, screws 96 do penetrate the pole 74 to secure the mount to the pole 74. In alternative embodiments, the mount does not include screws 96. The mount may be secured to pole 74 by gravity, an interference fit, adhesives, welding, other fasteners, and/or using other techniques and/or components.

In some embodiments, the mount is an integral portion of core member 12. In alternative embodiments, the mount is secured to or within a square opening 82 in core member 12. The mount may be secured by gravity, an interference fit, adhesives, welding, other fasteners, and/or using other techniques and/or components. In some embodiments, the mount is or includes sleeve 72. In alternative embodiments, core member 12 is mounted directly to pole 74 using square opening 82. Core member 12 may be wired to one or more external components via wiring 98 ran through the mount (e.g., sleeve 72) and/or pole 74. Core member 12 may be wired to a power source, control equipment, communication equipment, and/or other electronics. In some embodiments, core member 12 includes a segment of wiring 98 with a quick disconnect type connector for easily wiring core member 12 to wiring exiting pole 74.

Referring now to FIG. 8C, lighting fixture 10 is illustrated as mounted in a ceiling 108 according to one embodiment. Lighting fixture 10 may extend below ceiling 108 and be supported by a mounting pole 106. Core member 12 may include a cavity 104 through which mounting pole 106 extends. Mounting pole 106 may be secured to a structure within the ceiling, secured to a junction box 110, or otherwise provide support to lighting fixture 10. Flush mount 100 may be secured to mounting pole 106 using one or more fasteners 102. Flush mount 100 has dimensions larger than cavity 104 such that flush mount 100 and mounting pole 106 support lighting fixture 10. Interference between core member 12 and flush mount 100 supports core member 12. Advantageously, flush mount 100 may be flush or substantially flush with core member 12 maximizing head space below ceiling 108 and lighting fixture 10. Similarly, lighting fixture 10 may be mounted flush or substantially flush with ceiling 108. This type of mounting may be used for mounting lighting fixture 10 in parking garages, under canopies, or elsewhere in outdoor applications, and/or in indoor applications.

A junction box 110 may be located within ceiling 108. Junction box 110 may include wiring 98 for wiring lighting fixture 10 to one or more power sources, control equipment, communication equipment, and/or other electronics. Core member 12 may include a segment of wiring 98 which extends through cavity 104 for wiring lighting fixture 10 to wiring in junction box 110. The segment of wiring 98 may include a quick disconnect type connector for easily wiring core member 12 to wiring within junction box 110.

Referring now to FIG. 8D, lighting fixture 10 is illustrated with a mounting system including sleeve 72. Sleeve 72 may be used to mount lighting fixture 10 on horizontally oriented poles 74. Advantageously, this may allow lighting fixture 10 to be used in applications such as roadway lighting in which pole 74 is oriented horizontally in order to extend over the area being illuminated while being anchored away from the area (e.g., a roadway). Sleeve 72 may include a first portion 76 and a second portion 78. Sleeve 72 may include two portions in order to mount lighting fixture 10 vertically on a pole 74 with a horizontal orientation. First portion 76 may be configured to be coupled to pole 74. In some embodiments, first portion 76 is secured to pole 74 using one or more screws 96. In some embodiments, the screws are set screws and do not penetrate the pole 74. In alternative embodiments, screws 96 do penetrate the pole 74 to secure the mount to the pole 74. In alternative embodiments, first portion 76 of sleeve 72 may be coupled to pole 74 using the operation of gravity, welding, an interference fit, adhesives, fasteners (e.g., screws, set screws, rivets, quarter turn screws, and/or other fasteners), and/or other techniques. First portion 76 may be substantially horizontal. Second portion 78 may extend at a 90 degree angle from first portion 76. This allows for core member 12 to be coupled to sleeve 72 via second portion 78 and circular opening 80 in such a way that lighting fixture 10 is horizontal relative to the ground. Second portion 78 may be coupled to core member 12 using any of the techniques previously described herein for coupling sleeve 72 to other components. Advantageously, sleeve 72 allows for installation of lighting fixture 10 on horizontally oriented poles 74.

Referring now to FIG. 8E, core member 12 is illustrated with pivoting sleeve 72 according to one embodiment. In some embodiments, sleeve 72 includes pivot mechanism 112. Pivot mechanism may be any type of hinge or other mechanism which allows first portion 76 of sleeve 72 to pivot relative to second portion 78 of sleeve 72. In some embodiments, pivot mechanism 112 is a portion of sleeve 72 to which first portion 76 and/or second portion 78 are attached with one or more fasteners. The fasteners may allow for first portion 76 and/or second portion 78 to rotate relative to the pivot mechanism 112. In alternative embodiments, other types of pivot mechanisms 112 are used. In some embodiments, the fasteners of pivot mechanism 112 may be loosened or tightened to allow pivoting or to secure first portion 76 and/or second portion 78 such that unintentional pivoting is prevented. In some embodiments, pivot mechanism 112 may include one or more set screws which can be loosened or tightened to allow or prevent pivoting. In still further embodiments, pivot mechanism relies of an interference fit with first portion 76 and/or second portion 78 to prevent unintentional pivoting. Pivoting may be achieved by applying a sufficient force.

As previously explained, first portion 76 and/or second portion 78 may be secured using one or more techniques including using gravity, using screws 96, using interference fits, and/or other techniques. Advantageously, sleeve 72 with pivot mechanism 112 allows lighting fixture 10 to be mounted in various orientations relative to a pole 74 or other structure. Thus, a single sleeve 72 allows for mounting to poles 74 with vertical, horizontal, or other orientations. As previously explained, sleeve 72 may be integral to core member 12 in some embodiments. In other embodiments, sleeve 72 is removable from core member 12. Second portion 78 of sleeve 72 may be coupled to circular opening 80 of first portion 76. In alternative embodiments, sleeve 72 may have a square cross section allowing sleeve 72 to be coupled to a square opening 82 of core member 12.

Referring now to FIG. 8F, sleeve 72 is illustrated according to one embodiment including arms 114. Arms 114 may extend from sleeve 72 and attach to core member 12. In some embodiments, core member 12 does not include circular opening 80 or square opening 82. Arms 114 attach to core member 12 at different points. Arms 114 may include wiring 98 running through an interior opening to allow for wiring of core member 12. Sleeve 72 may include screws 96 for mounting to a pole 74.

In some embodiments, sleeve 72 may include both arms 114 and pivot mechanism 112. Arms 114 may be second portion 78 of sleeve 72 and pivot relative to first portion 76. First portion 76 may be used to couple sleeve 72 to pole 74 (e.g., using screws 96).

Referring now to FIG. 8G, in some embodiments, a plate 116 of core member 12 includes slots 118 and/or other features to couple core member 12 to arms 114 of sleeve 72. In some embodiments, slots 118 accept arms 114. Arms 114 may include tabs which pass through slots 118 and then expand or spring back to secure arms 114 within slots 118. In further embodiments, arms 114 are secured within slots 118 using an interference fit, force of gravity, fasteners, adhesives, welding, and/or other techniques and/or components. In further embodiments, arms 114 may include pivots at or near the end of arms 114 farthest from the portion configured to couple to pole 74. This may allow core member 12 to pivot relative to sleeve 72. In some embodiments, plate 116 may include one or more light sources. Plate 116 may include one or more LEDs 46 for illuminating an area near or below plate 116. In some embodiments, plate 116 also includes one or more lenses.

Referring now to FIG. 8H, core member 12 is illustrated with a removable plate 116 according to one embodiment. Plate 116 be detachable from core member 12. Advantageously, this allows for interchangeable plates 116 to be installed for different light output and/or energy usage. Plate 116 includes a light source (e.g., LEDs 46), a driver 62, and/or other components for providing light output in some embodiments. Plate 116 may include one or more lenses 70. Plate 116 and/or core member 12 may be configured such that any side of core member 12 may be replaced by removing plate 116 and adding a different plate 116 in its place. In one embodiment, only the bottom of core member 12 is configured to accept interchangeable plates 116. In other embodiments, only the top of core member 12 is configured to accept interchangeable plates 116. Interchangeable plates 116 may include wiring 98 for wiring to electronics and/or a power source or supply in core member 12. Wiring 98 may include a quick disconnect type connector for easily wiring plate 116 to core member 12. In some embodiments, core member includes wiring 98 and/or a quick disconnect type connector for wiring plates 116 to core member 12.

In some embodiments, plate 116 is coupled to core member 12 using quarter turn screws. Plate 116 may include quarter turn screws with screw heads remaining accessible when plate 116 is coupled to core member 12. Core member 12 may include slots, notches, or other features for accepting the quarter turn screws. In some embodiments, plate 116 is coupled to core member 12 using a snap fit connection. For example, a groove, notch, and/or other feature of one component may be configured to accept an edge, flange, or other protrusion of another component. In further embodiments, other techniques may be used to removably secure plate 116 to core member 12. For example, an interference fit, flange 52 and cutout 54 combination, and/or other features or techniques may be used.

In some embodiments, lighting fixture 10 includes a core member 12 configured to accept interchangeable plates 116 and is configured to accept other modular components (e.g., lamp modules 20). In other embodiments, lighting fixture 10 is configured to accept interchangeable plates 116 and is configured not to accept other modular components. For example, core member 12 may not include flanges 52 in some embodiments. In other embodiments, core member 12 is configured to accept interchangeable plates 116 and end caps 68 but not lamp modules 20.

Referring now to the FIGURES generally, various embodiments of lighting fixture 10 and mounting systems for lighting fixture 10 are illustrated. Features from any embodiment may be combined with features from any other embodiment. For example, the mounting system as described in reference to FIG. 8C may be used in combination with the lighting fixture 10 or features thereof described with reference to FIG. 8H. Various combinations of features are possible in various embodiments. The combinations described herein are exemplary.

Referring to FIG. 9, according to an exemplary embodiment, a lighting fixture 10 is disclosed. Lighting fixture 10 may be mounted outdoors (e.g., on a pole, the exterior of a building, or any other suitable mounting location) and used to illuminate an area such as a street, a parking lot, an exterior of a building, or any other suitable outdoor area. Alternatively, lighting fixture 10 may be mounted indoors and used to illuminate an indoor area.

Referring to FIG. 9, according to an exemplary embodiment, a first member 12 (also called core member as described above) may be coupled to a mounting location, such as a top of a pole 14 or the side of a building. First member 12 may be coupled (i.e., secured, mounted, fastened, etc.) to pole 14 via fasteners (e.g., bolts and nuts, screws, etc.), welds, or in any suitable manner. First member 12 may be formed from any suitable material and have any suitable shape, and the shapes of first member 12 illustrated in the FIGURES are not limiting.

Referring to FIG. 14, according to an exemplary embodiment, first member 12 may be used to house (i.e., contain, enclose, protect, etc.) various electronics (not shown in FIG. 14, but, e.g., wires, sensors, ballasts, drivers, circuitry, electrical controls, etc.) used to control lamp module 20. For example, first member 12 may include one or more slots (alternatively, e.g., a hole) 16 and a central cavity 18. Slots 16 may receive and be coupled to pole 14. Thus, various electronics for lighting fixture 10 may be routed through pole 14 and be received within central cavity 18 of first member 12.

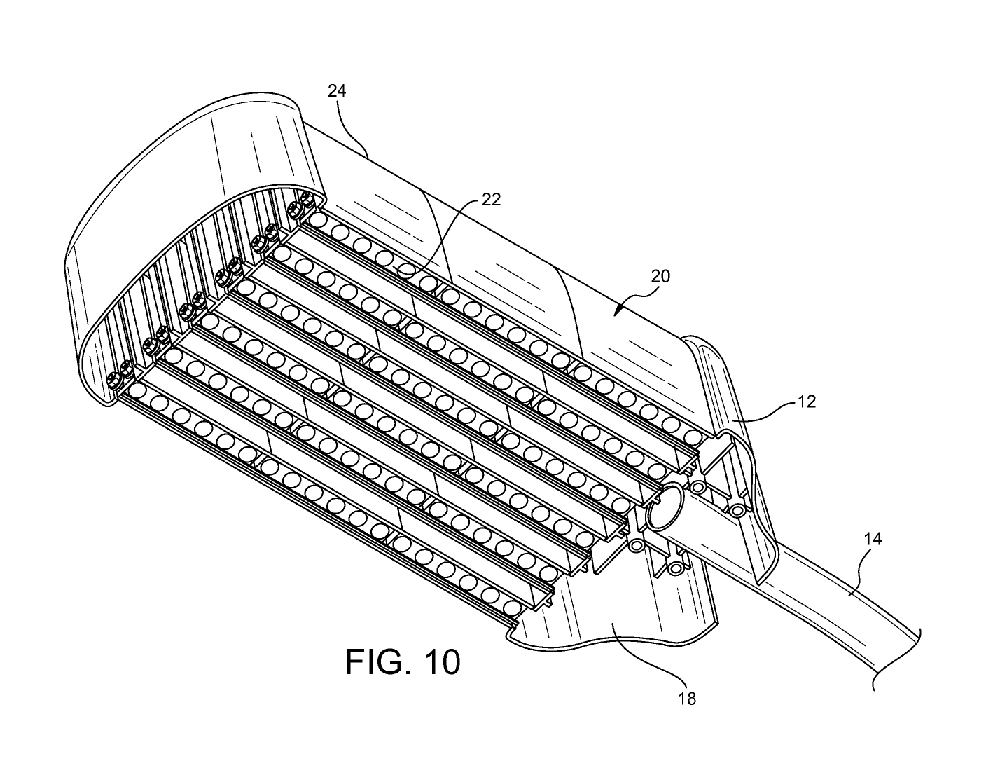

Also illustrated in FIG. 14 are LED board 44, LEDs 46, and LED lens 42. In some embodiments, a light emitting device 22 (illustrated in FIG. 10) includes or is LED board 44. On LED board 44 are LEDs 46. LEDs 46 produce light in response to electricity provided by LED board 44. The light produced by LEDs 46 can be emitted through LED lens 42. LED lens 42 may be modular. The modular LED lens allows for the LED lens to be substituted for other LED lenses depending on the desired light output from the light fixture. LED lens 42 can be used to affect the light emitted by the light fixture. For example, the beam pattern of the emitted light, temperature of the emitted light, intensity of the emitted light, and/or other parameters of the emitted light can be altered, selected, and/or manipulated using one of a plurality of different LED lenses 42. In alternative embodiments, LED lens 42 can be fixed to lamp module 20. Different lamp modules 20 can have different LED lenses 42. Lamp modules 20 can be switched or combined in different combinations using the modular nature of lamp modules 20 to achieve different light distributions through varying LED lenses 42.

Referring to FIGS. 9-11, according to an exemplary embodiment, at least one lamp module 20 is coupled to first member 12. Eighteen (18) lamp modules 20 are shown in FIGS. 9-11. According to other exemplary embodiments, a light fixture may include any suitable number of lamp modules 20 which are coupled to a first member, and the exemplary embodiments disclosed herein are not limiting.

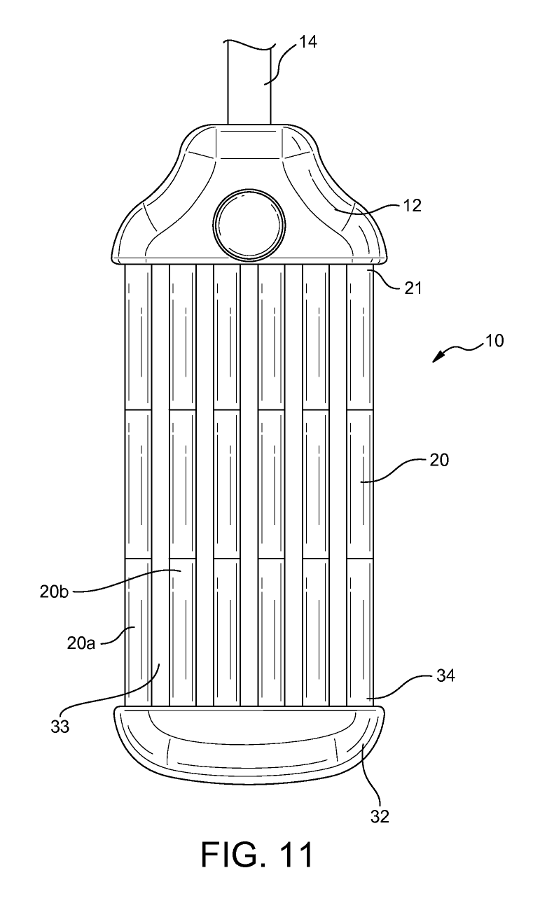

According to an exemplary embodiment, a length of each lamp module 20 is greater than a width of each lamp module 20. Referring to FIG. 11, the length of each lamp module 20 is illustrated as being approximately fifteen times its corresponding width. According to other exemplary embodiments, a lamp module 20 may have any suitable length. The length of lamp module 20 may define a longitudinal dimension of the lamp module. For example, referring still to FIG. 11, the lamp modules 20 may extend (i.e., project, protrude, etc.) outwardly from first member 12 in a longitudinal direction. In particular, a first end 21 of lamp modules 20 may be configured to be coupled to first member 12 such that lamp modules 20 extend outwardly from first member 12 in a longitudinal direction.

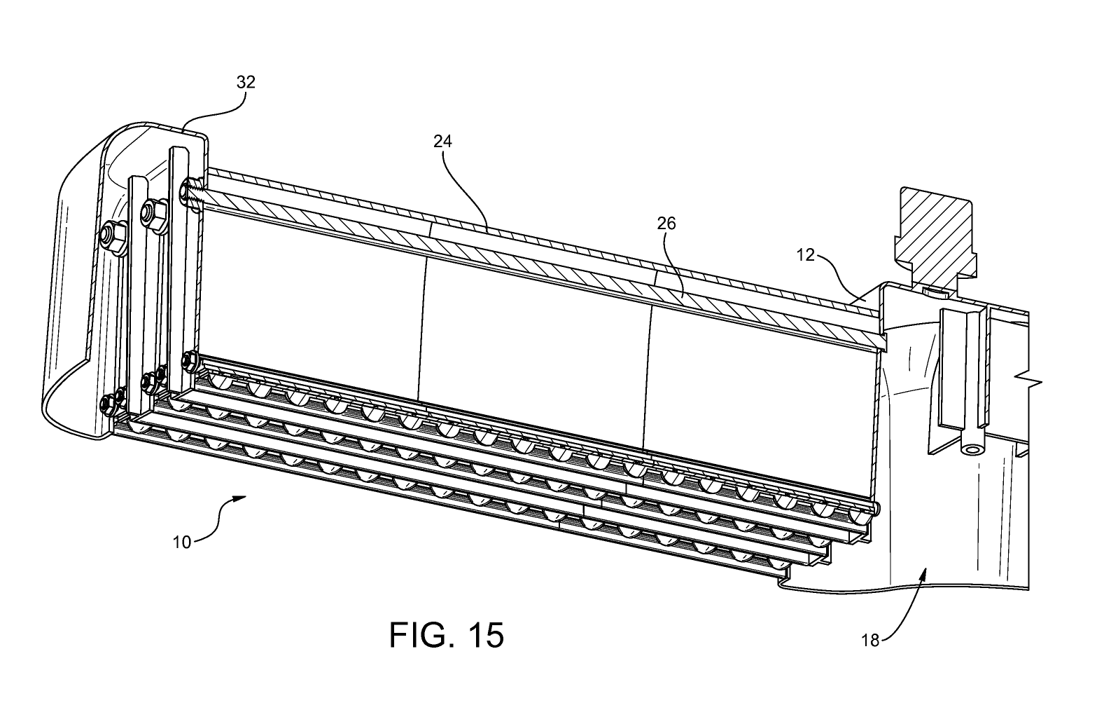

Referring now to FIGS. 10 and 15, according to an exemplary embodiment, the lamp modules 20 may include a light-emitting device 22 which includes light emitting diodes (LEDs) 46, LED lens 42, and a cover 24 provided above the light emitting device 22. In alternative embodiments, the light emitting device 22 may be or include organic light emitting diodes (OLEDs), a backlight and liquid crystal display lighting system, and/or other light sources. Further, light emitting device 22 may be electrically coupled to various electronics (not shown) contained in cavity 18 of first member 12. When light fixture 10 is mounted, such that light emitting device 22 is oriented to illuminate an area below the light fixture, cover 24 is positioned (i.e., provided, located, situated, etc.) above light emitting device 22. Further, cover 24 may be configured to protect light emitting device 22 from the sun, rain, snow, and other elements which may cause damage to light emitting device 22.

Referring to FIGS. 14-16, according to an exemplary embodiment, one or more rods 26 may be used to couple cover 24 of lamp module 20 to first member 12. As shown in FIG. 16, three (3) rods 26 are illustrated. Further, a rod 26 may be coupled to cover 24 in a variety of ways. For example, as shown in FIG. 14, first member 12 may include a series of notches and an end portion of rod 26 may include a flange, such that the flange is configured to be held (i.e., retained) within cavity 18 of first member 12. According to another exemplary embodiment, at least an end portion of rod 26 may be threaded (i.e., the end portion may include outer threads). Further, a fastener (not shown, but, e.g., a nut) may be used to couple cover 24 to first member 12. According to another exemplary embodiment, an end portion of rod 26 may be formed having a particular shape (not shown, but, e.g., a “T” shape), such that the end portion may be received within a corresponding hole of first member 12, and thereby secured within cavity 18 when rod 26 is rotated a half-turn. It should be understood by those skilled in the art that the exemplary embodiments disclosed and described herein are not limiting, and that the lamp module may be coupled to the first member in any suitable manner, unless explicitly limited in one or more claims.

Referring now to FIG. 16, according to an exemplary embodiment, cover 24 may be configured to be coupled to rod 26. For example, various hardware and techniques could be used to connect (i.e., attach, mount, secure, couple, etc.) cover 24 to rod 26. Various hardware and techniques could also be used to position cover 24 relative to first member 12. As shown in FIG. 16, a projection 5 (e.g., a flange, protrusion, member, etc.) is provided on both a left and right side of a top portion of cover 24 and the left and right projections 5 are cooperatively configured to receive rod 26 therebetween. According to an exemplary embodiment, cover 24 may be configured to be sufficiently flexible (i.e., elastic, deformable, resilient, etc.) such that projections 5 may “snap” on to rod 26 when cover 24 is forced thereon. According to another exemplary embodiment, cover 24 is rigid, and projections 5 are configured to receive rod 26 therethrough.

Although cover 24 is illustrated as including a pair of projections 5, cover 24 may be configured in other ways to couple to rod 26. For example, a top portion of cover 24 may include a hole which extends longitudinally therethrough. The hole may be received by rod 26 such that cover 24 is coupled and positioned relative thereto. Alternatively, according to an exemplary embodiment, an inside top surface of cover 24 may be configured to rest upon rod 26, in order to couple and position cover 24 relative thereto. It should be understood by those skilled in the art that the exemplary embodiments disclosed and described herein are not limiting, and that cover 24 may be coupled to, and/or positioned relative to, rod 26 or first member 12 in any suitable manner.

Referring still to FIGS. 14-16, according to an exemplary embodiment, cover 24 and light emitting device 22 may be cooperatively configured to be coupled together. For example, as shown in FIG. 16, a bottom portion of each cover 24 includes a base 28. Each side of base 28 includes a flange 30 that extends inwardly therefrom, and the flanges 30 of each base 28 may define a longitudinal slot 31. Light emitting device 22 may be received within longitudinal slot 31. According to other exemplary embodiments, light emitting device 22 may be coupled to cover 24 in another manner.

Referring still to FIG. 16, according to an exemplary embodiment, cover 24 may include a profile which is configured such that contaminants (e.g., dirt, sand, dust, leaves, etc.) do not accumulate thereon. As shown in FIG. 16, cover 24 has a tapered profile, such that cover 24 is tapered from the bottom (proximate light-emitting device 22) to the top (distal relative to light emitting device 22). The tapered profile of cover 24 may be defined by a steep slope or curvature (e.g., such that a vertical portion of the slope/curvature is much greater than a horizontal portion of the slope/curvature). Thus, the force of gravity may pull contaminants downwards off cover 24, such that contaminants do not accumulate thereon. Further, in the event that gravity does not pull contaminants off cover 24, water (e.g., rain water) may easily wash the contaminants downwards off cover 24. Therefore, advantageously, the tapered profile of cover 24 is configured such that heat does not build up near light emitting device 22 as a result of accumulation of contaminants on lamp modules 20. Therefore, because the overall useful life of certain light-emitting devices may decrease if heat is allowed to build-up within a light fixture, the useful life of light fixture 10 may be advantageously prolonged.

Referring still to FIG. 16, lamp module 20 includes LED board 44, LED lens 42, and gasket 56 in some embodiments. These components may be part of light emitting device 22. As previously described, LED board 44 includes LEDs 46 for producing light. This light is emitted through LED lens 42. LED lens 42 is modular and may be removed from lamp module 20 and replaced with a different LED lens 42. In some embodiments, rain, water, moisture, dust, particulates, and/or other environmental contaminants can enter lamp module 20. For example, environmental contaminants can enter lamp module 20 while LED lens 42 is removed and/or substituted for a different LED lens 42. To protect LED board 44, LEDs 46, and/or other components of light emitting device 22, LED board 44 is surrounded by gasket 56 in some embodiments. Gasket 56 seals LED board 44 against cover 24 of lamp module 20. Together with cover 24, gasket 56 can keep all or substantially all environmental contaminants from coming into contact with LED board 44, LEDs 46, and/or other components. Gasket 56 may be made of materials such as rubber, silicone gel, polymers, and/or other materials.

Referring again to FIG. 11, according to an exemplary embodiment, lamp modules 20 which are adjacent (as utilized herein, the term “adjacent” is intended to refer to lamp modules which are next to each other, consecutive, neighboring, bordering, etc.; see, e.g., lamp modules 20a and 20b shown in FIG. 11) are separated by a distance, such that a space (i.e., a gap, cavity, etc.) 33 is defined therebetween. According to an exemplary embodiment, space 33 between adjacent lamp modules 20 is openly disposed between a top and bottom thereof. For example, a top plane may be defined by a top surface of lamp modules 20 and a bottom plane may be defined by a bottom surface of lamp modules 20, and space 33 between adjacent lamp modules 20 may be openly disposed between the top and bottom planes.

According to an exemplary embodiment, space 33 between adjacent lamp modules 20 is configured to allow contaminants (e.g., dirt, sand, dust, leaves, snow, dead insects, etc.) to fall therethrough. Consequently, and advantageously, because contaminants are allowed to fall between adjacent lamp modules 20, such contaminants are prevented from inhibiting, or negatively affecting, the transfer of heat from light emitting device 22 to the surroundings. Therefore, because the overall useful life of certain light emitting devices may decrease if heat is allowed to build-up within a light fixture, the useful life of light fixture 10 may be advantageously prolonged.

In some embodiments, space 33 between adjacent lamp modules 20 and/or the geometry of lamp modules 20 (e.g., the height, width, and/or shape of lamp modules 20) facilitate heat transfer from lamp modules 20. Lamp modules 20 generate heat as a result of producing light from light emitting device 22. This heat can be dissipated by lamp module 20.

In some embodiments, lamp module 20 is shaped with a width and/or height such that lamp module 20 approximates a plate or fin. Advantageously, lamp module 20 can transfer heat through natural convection. The shape of lamp module 20 and the arrangement of a plurality of modular lamp modules 20 can facilitate cooling of light emitting devices 22 and lamp modules 20 by utilizing natural convection.

Taking a single lamp module 20, lamp module 20 can be approximated as a plate. Lamp module 20 has a width, length, and height. As heat is generated in lamp module 20 from light emitting device 22 (e.g., heat is generated by one or more LEDs 46), natural convection can take place. As heat is transferred from lamp module 20 via natural convection, a boundary layer will develop along the surfaces of lamp module 20 in the direction of natural convection. For example, a boundary layer can develop from the base of lamp module 20 up along the side of lamp module 20 and towards the rounded top of lamp module 20.

In a system of a plurality of lamp modules 20 aligned in rows, the boundary layer due to natural convection from one lamp module 20 may interfere with another boundary layer from an adjacent lamp module 20. The interference of boundary layers between two or more lamp modules 20 can impede or reduce the heat transfer from lamp module 20 by natural convection. In other words, adjacent lamp modules 20 can cool by natural convection. However, if adjacent lamp modules 20 are too close (e.g., such that their respective boundary layers overlap) the cooling effect of natural convection is reduced. For lamp modules 20 which are sufficiency far apart such that their boundary layers do not substantially interfere, the heat transfer coefficient will be the same or substantially the same as for individual single plates. If the boundary layers do interfere, the heat transfer coefficient for lamp modules 20 will fall below that for a single plate thus reducing the amount heat transferred by natural convection (e.g., reducing the effectiveness of cooling by natural convection).

In order to increase the heat transfer from lamp modules 20 by natural convection (e.g., maximize the heat transfer coefficient), lamp modules 20 are spaced apart from one another. In some embodiments, lamp modules 20 are separated by space 33 of a sufficient dimension to allow for lamp modules 20 to approximate single plates undergoing natural convection. The boundary layers of each lamp module 20 do not interfere. Advantageously, this may maximize the cooling of lamp modules 20 by natural convection.

Alternatively, space 33 can be of a greater width than the width at which the boundary layers no longer interfere. For example, lamp modules 20 may be separated by a width 33 of 25.4 millimeters (1 inch). This arrangement can allow for the greatest possible heat transfer by natural convection but results in a light fixture of a larger overall size.

The width and height of each lamp module 20 can be selected to further optimize heat transfer from lamp modules 20. For example, the width and height of lamp modules 20 can be increased to increase the surface area of lamp module 20. The height of lamp module 20 can be increased and/or the width of lamp module 20 decreased such that lamp module 20 approximates a fin. In some embodiments, the height of lamp module 20 may be a specific value optimizing heat transfer and the size of the light fixture. For example, the height of lamp module 20 may be at a value such that the theoretical heat transferred by lamp module 20 is a percentage of the theoretical heat transferred by an infinite fin (e.g., 90% of the theoretical heat transfer of an infinite fin). In one embodiment, lamp modules 20 taper to a point. This may reduce the space in which boundary layers from adjacent lamp modules 20 would normally interfere as space 33 between lamp modules 20 increases as lamp modules 20 narrow to a point.

In one embodiment, the width of space 33 (i.e., between adjacent lamp modules 20) is 15 millimeters (approximately 0.748 inches). Advantageously, this width may provide for optimal or maximized heat transfer from light emitting device 22 (e.g., one or more LEDs 46). The boundary layers of adjacent lamp modules 20 may not substantially interfere or interfere at all. This width may also provide for maximum heat transfer while minimizing the width of space 33. In other words, heat transfer by natural convection from lamp modules 20 can be maximized while the overall size of a light fixture having two or more rows of lamp modules 20 is minimized. The distance between rows is minimized while being sufficiently large to prevent or reduce overlap between boundary layers. The height of space 33 (e.g., the height of lamp modules 20) is approximately 203.2 millimeters (8 inches). The height may be sufficient to dissipate heat from light emitting device 22 (e.g., one or more LEDs 46). In other words, the height and width of lamp module 20 in combination with the width of space 33 between lamp modules 20 may be sufficient to dissipate the heat produced by the light fixture.

In other embodiments, the dimensions of and spacing between lamp modules 20 can be adjusted to optimize a light fixture for other parameters. For example, space 33 may be reduced such that the boundary layers of lamp modules 20 interfere but a desired overall size of the light fixture is achieved. Similarly, space 33 may be sufficiently large so as to achieve acceptable levels of heat transfer by natural convection in order to cool light emitting device 22.

Still referring to FIG. 11, the geometry and spacing of lamp modules 20 can also be adjusted based on the heat load created by light emitting device 22. For example, a lamp module 20 including a light emitting device 22 with six LEDs 46 can be shaped and spaced from other lamp modules 20 in order to maximize heat transfer. Continuing the example, a lamp module 20 including a light-emitting device 22 with three LEDs 46 (e.g., a smaller heat load) can be spaced closer together with other lamp modules 20 while maintaining adequate heat transfer and cooling for LEDs 46.

Referring now to FIG. 28 lamp modules 20 are illustrated according to one embodiment. The optimization of natural convection for the light fixture is now discussed in additional detail. Lamp module 20 has a length L in direction of natural convection flow. Lamp module 20 has a depth, H. Lamp module 20 further has a thickness, t. The relationship between lamp modules 20 is defined by the distance between lamp modules 20, b, and the total width of all lamps structures 20, W.

As plates undergoing natural convection are moved closer, the boundary layers can merge, and the heat transfer coefficient for all the plates falls below the value for a single plate. Lamp modules 20 can be approximated as plates. The natural convection heat transfer coefficient for this configuration can be estimated based on experimental correlations. For the example, the following correlation may be used:

$$Nu = \frac{h \times b}{k} = \frac{Ra}{24} {( 1 - {e}^{- \frac{35}{Ra}} )}^{0.75}$$

where the Rayleigh number, Ra, is given by:

$$Ra = \frac{{ρ}^{2} {ℊ}_{c} β {c}_{p} {b}^{4} Δ T}{μ kL}$$

and where cₚ is specific heat at constant pressure, g_{c} is gravitational acceleration, h is the heat transfer coefficient, k is the thermal conductivity of air, Nu is the Nusselt number, Ra is the Rayleigh number, ΔT is the temperature difference between the heat source and the air, ρ is the density of air, β is the coefficient of thermal expansion for air, and μ is the dynamic viscosity of air. This correlation can be the Elenbaas correlation. The gap between lamp modules 20 can be determined by:

$$b = \frac{W - {N}_{f} \times t}{{N}_{f} - 1}$$

where N_{f} is the number of lamp modules 20. Additionally, the total heat transfer rate, q, can be found by:

q=h×A×ΔT=h×(N_{f}×2×H×L×η)×(Tₛ−Tₐ)

where η is the fin efficiency, Tₐ is the temperature of ambient air, and Tₛ is the temperature of the heat source. As the value of b decreases, the number of lamp modules 20 in a given width can be increased which may increase the overall heat transfer area. However, maximizing the overall heat transfer area may not maximize the overall heat transfer rate due to boundary layer interference. The optimum distance b between lamp modules 20, referred to herein as bₒₚₜ, can be defined by the following equation:

$$\frac{{b}_{opt}}{L} = \frac{b}{L} \times \frac{β \times {ℊ}_{c} \times {ρ}^{2} \times {b}^{3} \times Δ T}{{μ}^{2}} \times \frac{μ \times {c}_{p}}{k}$$

In some embodiments, this equation may be set equal to a value determined by experiment. For example, this equation may be set equal to approximately 50. In some embodiments, 50 may be the value of the channel Rayleigh number which results in the optimum spacing of lamp modules 20. The above relationships can be used to solve for an equation which gives the optimum space bₒₚₜ. The solution can be as follows:

$${b}_{opt} = 2.659 {( \frac{μ Lk}{β {g}_{c} Δ {Tc}_{p}} )}^{0.25} \times {ρ}^{- 0.5}$$

Using the above equations and relationships, the optimum spacing between lamp modules 20 is determined in some embodiments. The overall heat transfer rate can be maximized for a light fixture of a given width. In other embodiments, other techniques may be used in addition or in place of those described herein. In still further embodiments, other parameters may be optimized in place of the overall heat transfer rate or in addition to the overall heat transfer rate.

Referring generally to the FIGURES, each lamp module 20 can be a modular component. Lamp modules 20 can be lamp modules which includes a lighting element such as light emitting device 22. The lamp modules 20 includes cover 24 over and behind the lighting element to protect the lighting element and provide for heat transfer from the lighting element. As described above, the geometry of each lamp module 20 and/or the space 33 between adjacent lamp modules 20 can be optimized for heat transfer via natural convection. Advantageously, this optimization allows for any number or configuration of lamp modules 20 without substantially affecting the heat transfer from the light fixture. Therefore, any number or arrangement of lamp modules 20 can be provided in the light fixture to create the desired light output. In one embodiment, lamp modules 20 can be added to or removed from the light fixture during manufacture or assembly of the light fixture. The number, arrangement, and/or type of lamp module 20 can be changed to meet specifications for certain lighting environments or requirements. In further embodiments, lamp modules 20 can be added to or removed from the light fixture while the light fixture is in the field. This can allow the light fixture to be customized in the environment in which it provides light. Advantageously, this can allow for more accurate customization as effects of customization can be seen in the field. Additionally, the light fixture can be modified to adapt to changing conditions in the field and/or changing customer or user preferences.

In order to support the above described heat transfer, one or more components of lamp module 20 can be made of materials suitable for use as a cooling fin and/or heat sink. For example, cover 24 made be made of aluminum or another metal with a relatively high thermal conductivity. Cover 24 and/or other components of lamp module 20 can function as a heat sink and draw heat away from light emitting device 22 (e.g., transfer heat from LEDs 46 via conduction). Cover 24 and/or other components of lamp module 20 can then dissipate this heat through natural convection as described above.

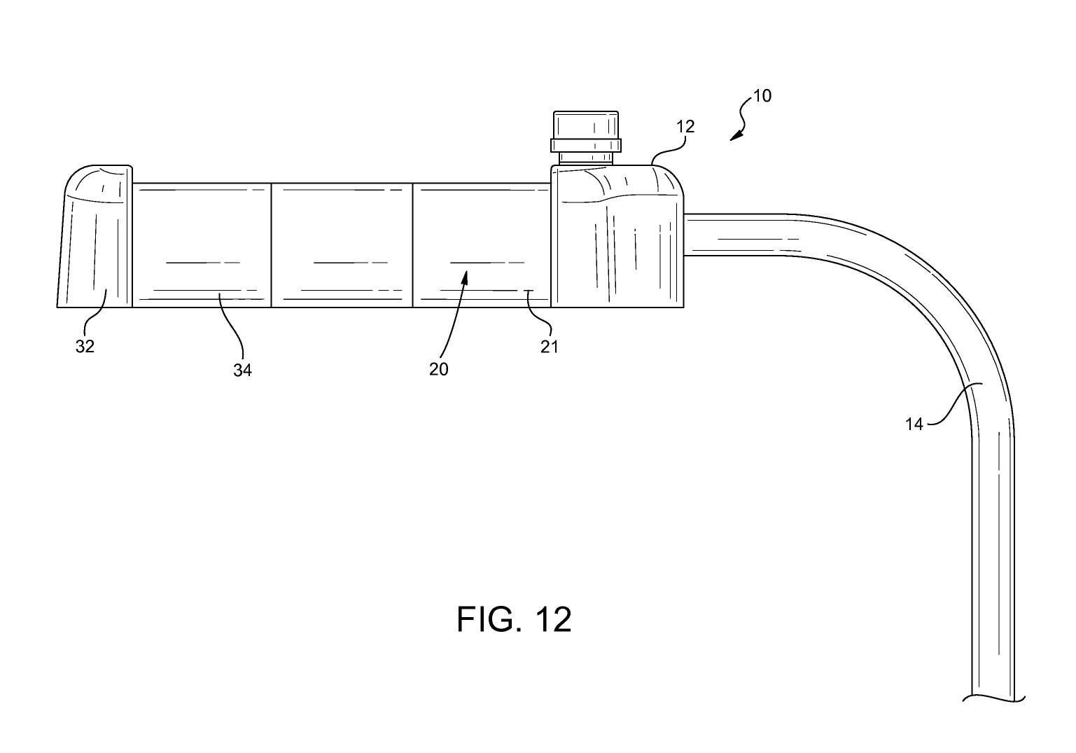

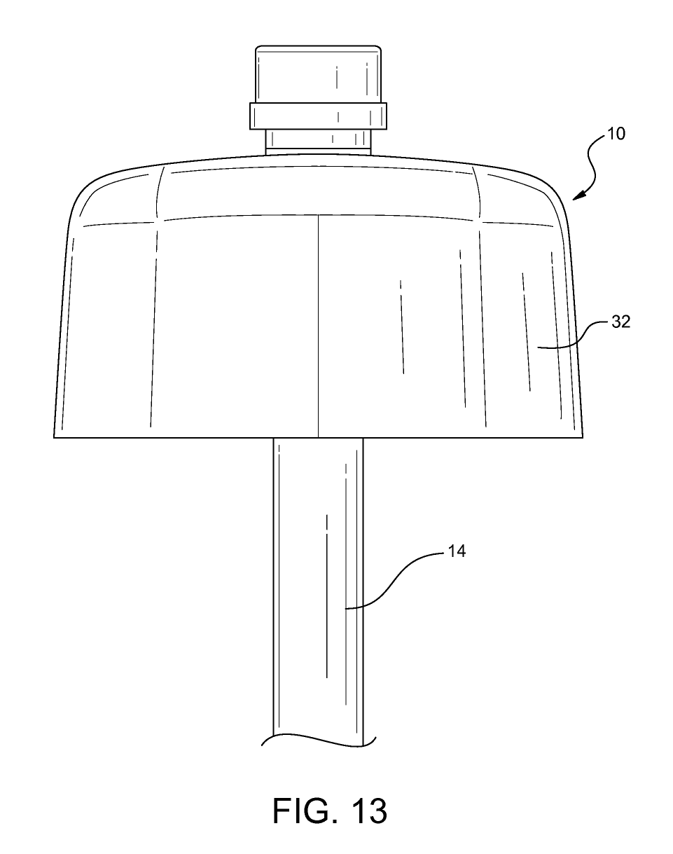

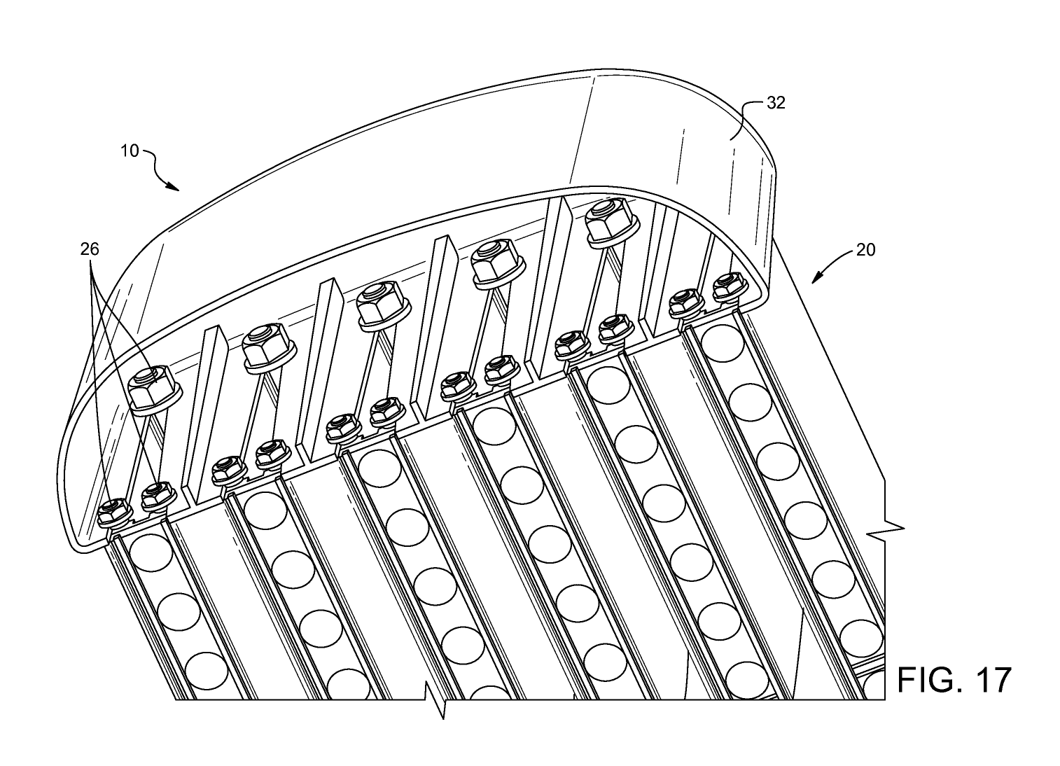

Referring to FIGS. 11-13 and 17, according to an exemplary embodiment, light fixture 10 may further include a support member 32. Support member 32 may be configured to support the lamp modules 20, thereby improving the strength and stability of light fixture 10. For example, support member 32 is configured to be coupled to a second end 34 of the lamp modules 20 opposite the first end (which is coupled to first member 12). For example, support member 32 may include a series of notches which are configured to be coupled to rods 26. Alternatively, support member 32 may include another feature, such as a series of holes or slots, which are configured to receive rods 26. An end portion of rods 26 may be configured to be coupled to support member 32. For example, as shown in FIG. 17, an end portion of rods 26 may include outer threads. The end portion of rods 26 are received within the notches of support member 32, and fasteners (e.g., threaded nuts) may be used to fasten (i.e., secure, hold, assemble, connect, couple, etc.) support member 32 to rods 26 and lamp modules 20. Although only some exemplary embodiments have been disclosed, it should be understood by those skilled in the art that support member 32 may be coupled to a second end of lamp modules 20 in a variety of ways, according to other exemplary embodiments.

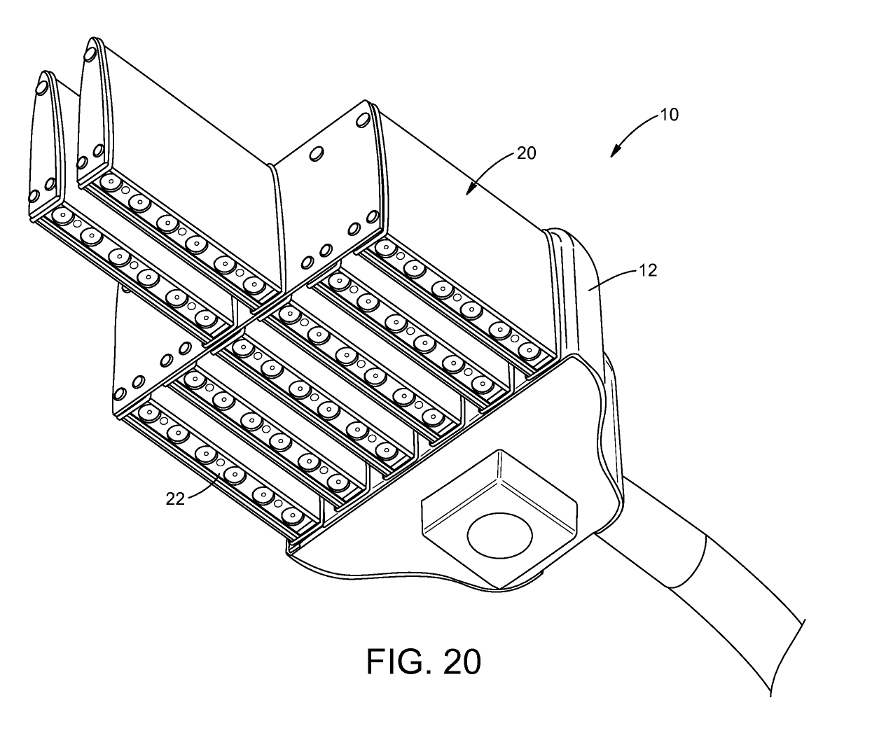

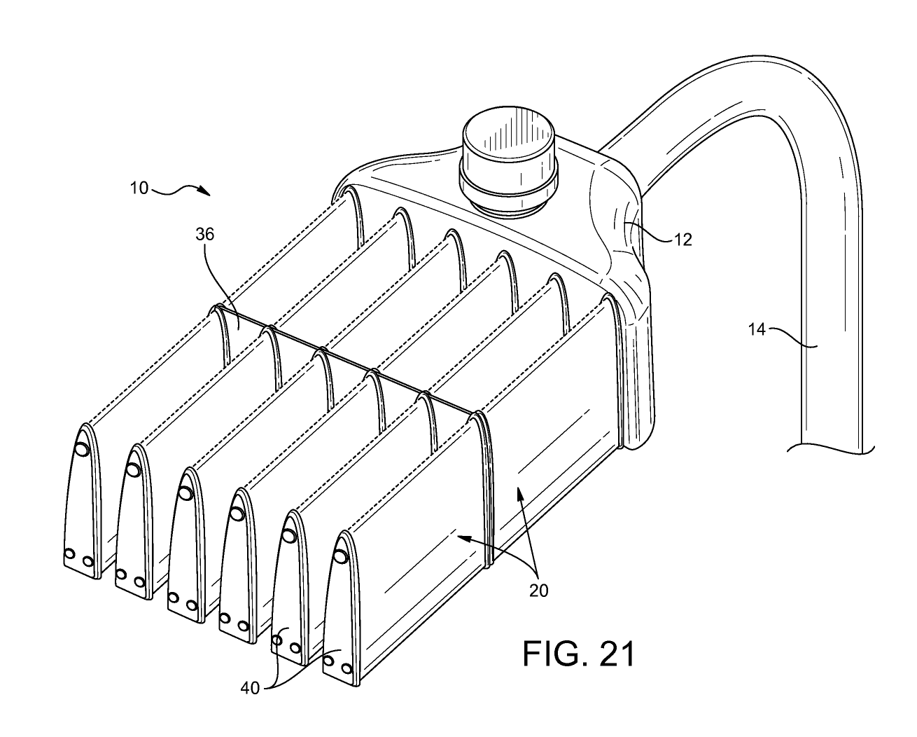

Referring now to FIGS. 19-20, according to an exemplary embodiment, a support member for light fixture 10 may be configured as a plate 36. Plate 36 may be formed of metal, a polymeric material, or any suitable material. Further, plate 36 may be configured to support lamp modules 20, thereby improving the strength and stability of light fixture 10. For example, plate 36 is configured to be coupled to second end 34 of lamp modules 20 opposite the first end (which is coupled to the first member 12). Plate 36 may be configured to be coupled to second end 34 in a variety of ways. For example, plate 36 may include a series of holes 38 having inner threads. As shown in FIGS. 19-20, holes 38 may align with rods 26 of multiple lamp modules 20 such that the ends of rods 26 (having outer threads) may be threadably coupled to plate 36, thereby securing lamp modules 20 between first member 12 and plate 36. It should be understood by those skilled in the art that plate 36 may be coupled to second end 34 of lamp modules 20 in other ways, according to other exemplary embodiments.

Referring still to FIGS. 19-20, according to an exemplary embodiment, a side of plate 36 opposite second end 34 of lamp modules 20 may be configured to be coupled to additional lamp modules 20. For example, two such lamp modules 20c and 20d are shown in FIG. 19. Thus, light fixture 10 may be configured as a modular assembly, such that the light and light distribution needs and demands for a particular location/application may determine the number of lamp modules 20 used for a particular light fixture 10. In other words, if it is determined that a greater amount of light is needed to illuminate a particular area, additional lamp modules 20 may be assembled to light fixture 10, as needed.

Additional lamp modules 20 may be assembled to light fixture 10 as modules in a variety of ways. For example, longer rods 26 may be used. The length of the longer rods 26 may extend from first member 12 to a first row of lamp modules 20, plate 36, a second row of lamp modules 20, and second plate 40. The second plate 40 may be coupled to longer rods 26 similarly to the way the shorter rods are coupled to second plate 40. For example, second plate 40 may include a series of holes having inner threads. As shown in FIGS. 19-20, the holes may align with the longer rods 26 of individual lamp modules 20 such that the ends of the longer rods 26 (having outer threads) may be threadably coupled to second plate 40, thereby securing lamp modules 20 between first member 12 and second plate 40. It should be understood by those skilled in the art that second plate 40 may be coupled to the end of lamp modules 20 opposite plate 36 in other ways, according to other exemplary embodiments.

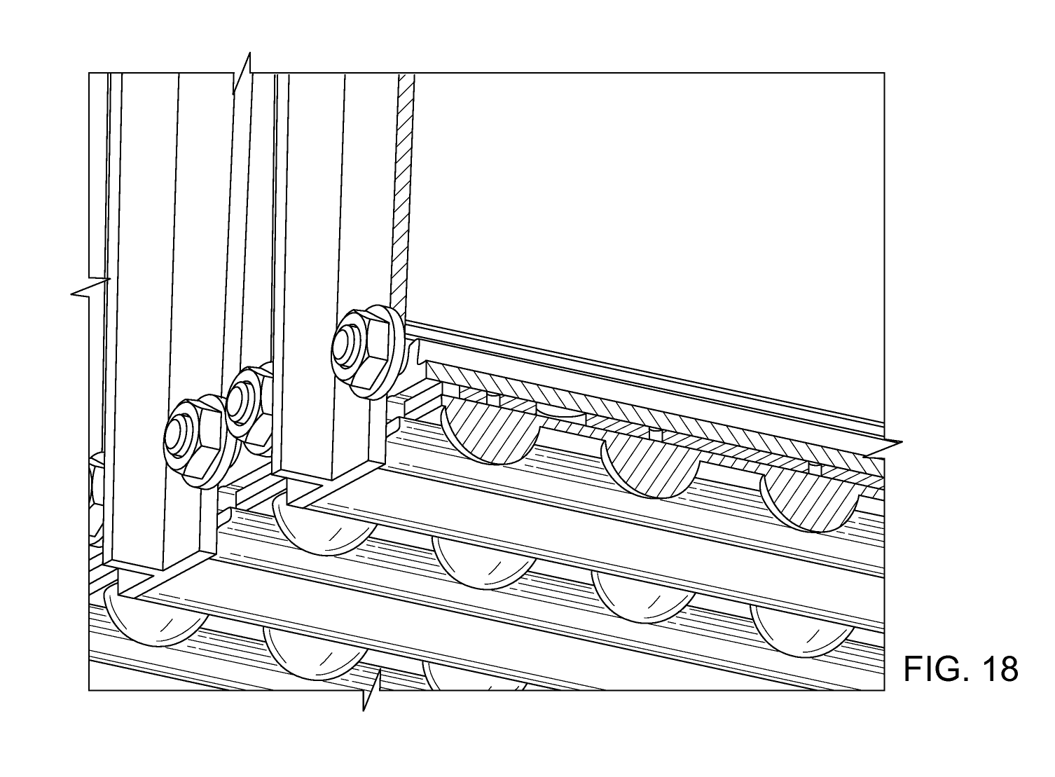

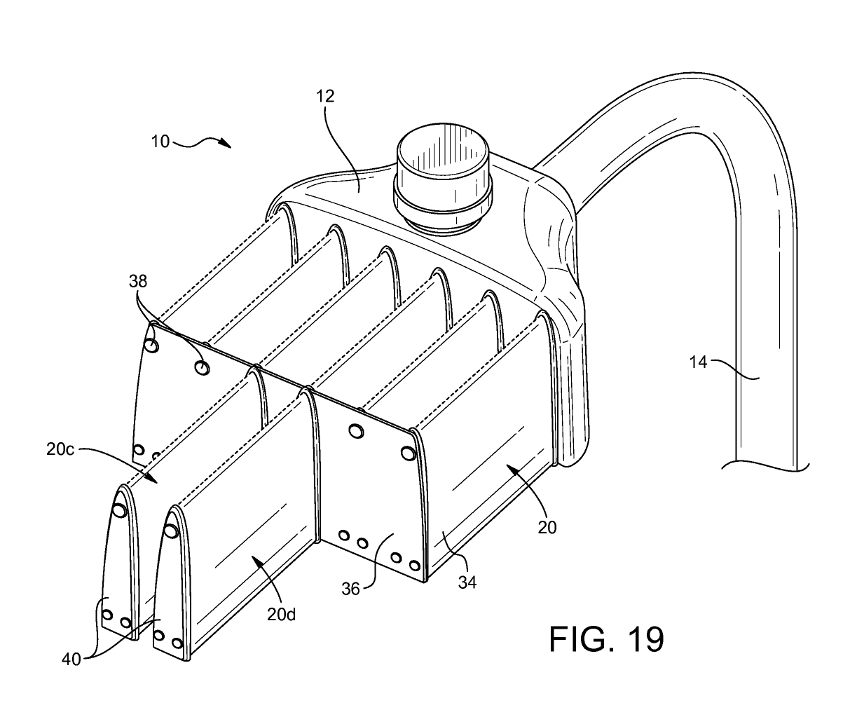

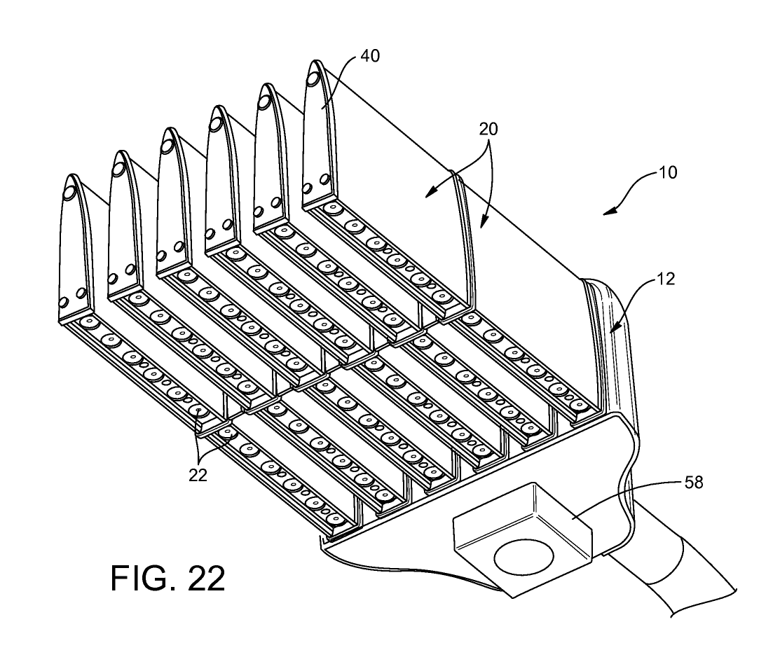

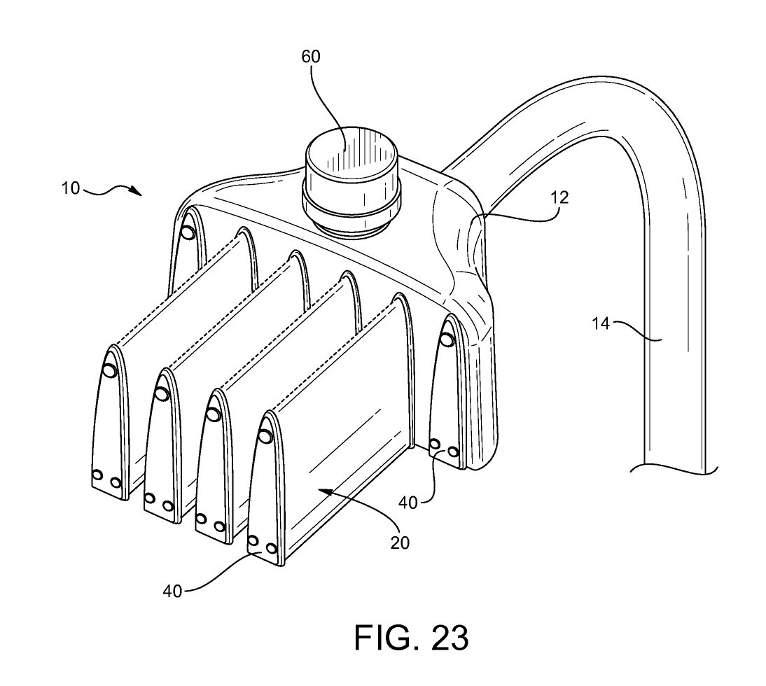

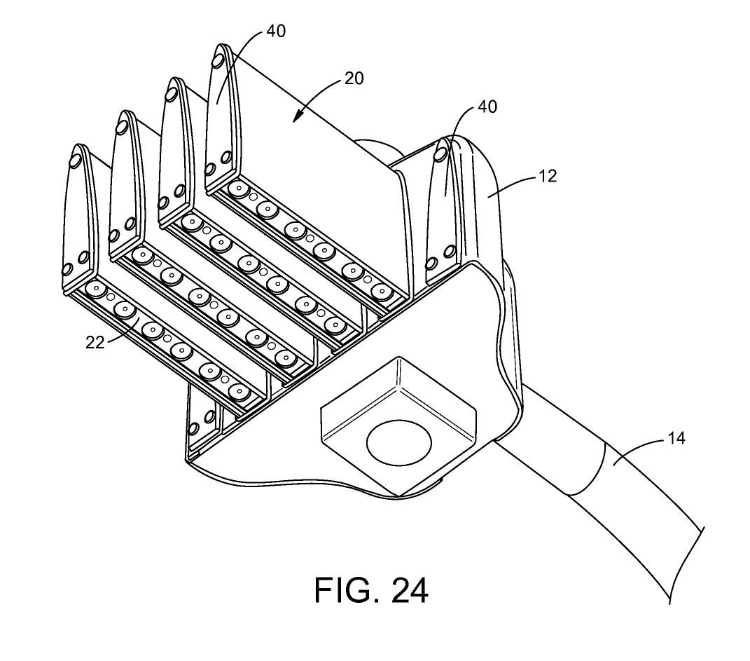

According to another exemplary embodiment, second plate 40 may be configured to be coupled to multiple lamp modules 20, much like plate 36 shown in FIGS. 19-22. Alternatively, referring to FIGS. 18-24, according to another exemplary embodiment, a plate may be configured to be coupled to an individual lamp module 20. For example, as shown in FIGS. 21-22, a plate 40 may be configured to be coupled to individual lamp modules 20 within a second row of lamp modules. Also, as shown in FIGS. 23-24, a plate 40 may be configured to be coupled to individual lamp modules 20 within a first row of lamp modules. Thus, light fixture 10 may be configured without support member 32. Larger debris (e.g., twigs, sticks, leaves, etc.) may not become lodged (or may be less prone to become lodged) within space 33 of a light fixture 10 which does not include support member 32.

According to an exemplary embodiment, a fewer number of lamp modules may be used in a modular light assembly 10. For example, as shown in FIGS. 23-24, first member 12 may accommodate a maximum of six (6) lamp modules 20. For some locations, or for some particular applications, less light may be needed for illumination. Accordingly, a fewer number of lamp modules 20 may be coupled to first member 12, thereby reducing light pollution, the start-up costs of light fixture 10, and the electrical costs of operating light fixture 10. A plate, similar to plate 36 or second plate 40, may be coupled to the unused ports (i.e., sections, openings, notches, etc.) of first member 12, in order to protect the electrical components within central cavity 18 and to provide a more aesthetic appearance to light fixture 10.

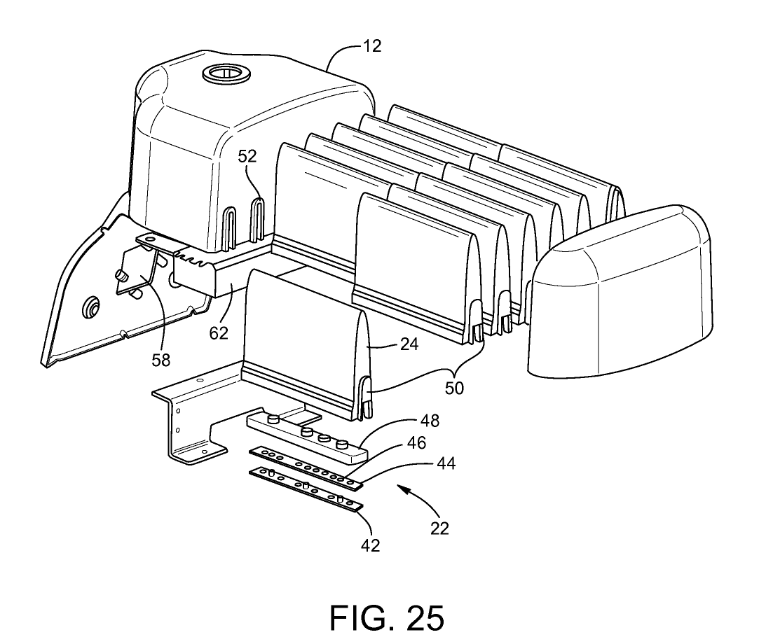

Referring now to FIGS. 25-26, an exploded view of the components of modular light assembly 10 is illustrated according to one embodiment. Light emitting device 22 can include an LED lens 42, an LED board 44 having one or more LEDs 46, a gasket 56 for sealing LED board 44, and a cover interface 48 for connecting light emitting device 22 to cover 24.

In alternative embodiments, cover interface 48 is part of cover 24 rather than part of light emitting device 22. Cover interface 48 as part of cover 24 can be configured to accept light emitting device 22. For example, cover interface 48 may include a slot or channel into which all or a portion (e.g., a flange) of light emitting device 22 may be inserted. In some embodiments, cover interface 48 allows for light emitting devices 22 to be interchangeably inserted into cover 24. Cover interface 48 can also function as a heat sink in some embodiments. Cover interface 48 can transfer heat from LED board 44, LEDs 46 and/or other components to cover 24. Cover 24 may in turn be cooled by natural convection as described herein.

Also illustrated are LED board 44, LEDs 46, and LED lens 42. On LED board 44 are LEDs 46. LEDs 46 produce light in response to electricity provided by LED board 44. The light produced by LEDs 46 can be emitted through LED lens 42. LED lens 42 may be modular. The modular LED lens allows for LED lens 46 to be substituted for other LED lenses depending on the desired light output from the light fixture. LED lens 42 can be used to affect the light emitted by the light fixture. For example, the beam pattern of the emitted light, temperature of the emitted light, intensity of the emitted light, and/or other parameters of the emitted light can be altered, selected, and/or manipulated using one of a plurality of different LED lenses 42. LED lens 42 can include a plurality of hemispherical domes or other structures which align with LEDs 46. These structures may perform the light altering techniques described herein (e.g., diffuse light, focus light, create a specific beam shape, and/or otherwise manipulate light from LEDs 46). The additional material of LED lens 42 can facilitate in aligning LED lens 42 with LEDs 46 and/or otherwise facilitating the modular use of LED lens 42. LED lens 42 may be made from glass, polymers, and/or other materials.

In some embodiments, LED board 44 is sealed with gasket 56. Gasket 56 seals LED board 44 against cover 24 of lamp module 20 or cover interface 48. Together with cover 24, gasket 56 can keep all or substantially all environmental contaminants from coming into contact with LED board 44, LEDs 46, and/or other components. Gasket 56 may be made of materials such as rubber, silicone gel, polymers, and/or other materials. Advantageously, gasket 56 can allow for LED lens 42 to be removed without exposing LED board 44 and/or other components to environmental contaminants.

Referring now to FIGS. 22, 25, and 26, in some embodiments, the light fixture includes one or more motion sensors 58. Motion sensor 58 can be any sensor for detecting motion. For example, motion sensor 58 can be or include an infrared sensor, ultrasound sensor, or other sensor designed to detect motion. In some embodiments, motion sensor 58 includes circuitry, a processor, memory, and/or other hardware or software for detecting motion. For example, motion sensor 58 may have a threshold below which detected movement is not output to other electronics of the light fixture.

LED board 44 can receive inputs from motion sensor 58. Using these inputs, LED board 44 can control LEDs 46. For example, LED board 44 can provide power to LEDs 46 in response to receiving a signal from motion sensor 58. In further embodiments, LED board 44 can stop providing power to LED 46 after a predetermined amount of time during which no movement has been detected by motion sensor 58. In still further embodiments, LED board 44 dims the light output of LEDs 46 to a preset level. LED board 44 can provide further functions such as modulating and/or regulating a power supply for input to LEDs 46, controlling sensors included in the light fixture, controlling communication equipment in the light fixture, and/or otherwise performing the functions described herein.

In some embodiments, LED board 44 is or includes one or more of a control circuit, a processor, and memory. LED board 44 may contain circuitry, hardware, and/or software for facilitating and/or performing the functions described herein. LED board 44 may handle inputs, process inputs, run programs, handle instructions, route information, control memory, control a processor, process data, generate outputs, communicate with other devices or hardware, and/or otherwise perform general or specific computing tasks.

A processor and/or LED board 44 may be implemented as a general-purpose processor, an application specific integrated circuit (ASIC), one or more field programmable gate arrays (FPGAs), a digital-signal-processor (DSP), a group of processing components, or other suitable electronic processing components. Memory is one or more devices (e.g. RAM, ROM, Flash Memory, hard disk storage, etc.) for storing data and/or computer code for facilitating the various processes described herein. Memory may be or include non-transient volatile memory or non-volatile memory. Memory may include database components, object code components, script components, or any other type of information structure for supporting various activities and information structures described herein. Memory may be communicably connected to a processor and provide computer code or instructions to the processor for executing the processes described herein.

In alternative embodiments, motion sensor 58 may be coupled to an LED driver 62. LED driver 62 can include hardware and/or software components for controlling LEDs 46. LED driver 62 can provide power to LEDs 46 which cause LEDs 46 to output light. LED driver 46 can dim the light output of LEDs 46 by controlling the power provided to LEDs 46. For example, LED driver 62 can use pulse width modulation to control the light output or light intensity of LEDs 46. LED driver 62 can be controlled by and/or handle inputs from motion sensor 58. Motion sensor 58 can control LED driver 62 such that LED driver 62 provides power to LEDs 46 based on detected motion or the lack of detected motion as determined by motion sensor 58. For example, motion sensor 58 can cause LED driver 62 to dim or turn off LEDs 46 in the absence of motion (e.g., motion sensor 58 does not detect motion for a predetermined amount of time. As an additional example, motion sensor 58 can cause LED driver 62 to increase the light output of LEDs 46 or turn on LEDs 46 in response to detected motion.

In some embodiments, cover 24 includes a flange 50. Flange 50 allows for one cover 24 to connect to another cover 24. First member 12 also includes a flange 52 for receiving covers 24 and the light emitting device 22 attached to cover 24. Cover 24 and/or support member 32 include cutout 54. Cutout 54 is configured (e.g., shaped) to slip over, receive, and/or otherwise engage with flange 50 or flange 52. Cutout 54 and flange 50 or flange 52 can operate as a self-lock mechanism to secure lamp modules 20. These features may be used instead of the rod as described in alternative embodiments. Cutout 54 and flange 50 or flange 52 can be rain water tight when engaged. Advantageously, cutout 54 and flange 50 or flange 52 allow two lamp modules 20 to be connected without the use of a sealing gasket. Multiple lamp modules 20 can be wired together (e.g., power and/or control wiring can be connected between LED boards 44 of different lamp modules 20). In some embodiments, this allows a single LED driver 62 to control and/or provide power to a plurality of lamp modules 20. Cover 24 may include a slot which allows wiring to be run from one LED board 44 to another. Wiring may be connected to LED board 44 using a variety of techniques (e.g., quick disconnect connectors included in LED board 44, soldering, and/or other wiring techniques).

Referring now to FIG. 27, modular light assembly 10 including a plurality of plates 36 is illustrated according to one embodiment. Plates 36 can include a cutout 54 as described above with reference to FIGS. 25 and 26. Cutout 54 allows plates 36 to attach to cover 24 and/or support member 32. Cutout 54 of plates 36 can be slipped over, receive, and/or otherwise engage (e.g., snap onto) flange 50 or flange 52 of cover 24 or support member 32 respectively. Advantageously, this may provide modular light assembly 10 with an aesthetically pleasing appearance. Additionally, plates 36 may seal the end of cover 24 and provide protection to light emitting device 22 located within cover 24. Furthermore, plates 36 can be attached using cutout 54 to avoid exposed fasteners or other hardware such as a nut. Advantageously, this may reduce the risk that a fastener is inadvertently or otherwise loosened or removed. Plates 36 may also be or include one or more support members 32 as described with reference to FIGS. 26 and 30A-31G.

Modular light assembly 10 may further include slot 16. Slot 16 is configured to accept pole 14 on which modular light assembly 10 may be mounted. Slot 16 may be sized to accept pole 14. In some embodiments, the radius of slot 16 may decrease from the bottom of modular light assembly 10 towards the top of modular light assembly 10. This can provide an interference fit between modular light assembly 10 and pole 14.

Referring now to FIG. 23, modular light assembly 10 includes an ambient light sensor 60 in some embodiments. Ambient light sensor 60 detects the intensity of ambient light around module light assembly 10. Ambient light sensor 60 may be or include a photodiode, photodetector, photosensor, or other light sensor. In some embodiments, ambient light sensor 60 is coupled to LED driver 62. Ambient light sensor 60 can control and/or provide inputs to LED driver 62. For example, LED driver 62 can turn on or increase the light output of LEDs 46 in response to ambient light sensor 60 detecting ambient light below a predetermined threshold. As an additional example, LED driver 62 can turn off or dim LEDs 46 in response to ambient light sensor 60 detecting ambient light above a pre-determined threshold. In alternative embodiments, ambient light sensor 60 and/or a central timing controller may be located remote from modular light assembly 10.

In some embodiments, module light assembly 10 can include an antenna and/or other communications hardware. The antenna and/or other communications hardware can allow the light fixture to communicate with remote devices (e.g., a controller, diagnostics machinery, other light fixtures in a network, and/or other devices). The antenna and/or other communication electronics can be in communication with one or more LED boards 44, a controller, control circuitry, a processor, and/or other hardware included in the light fixture. This hardware can control and/or use the antenna and/or other electronics for communication purposes.

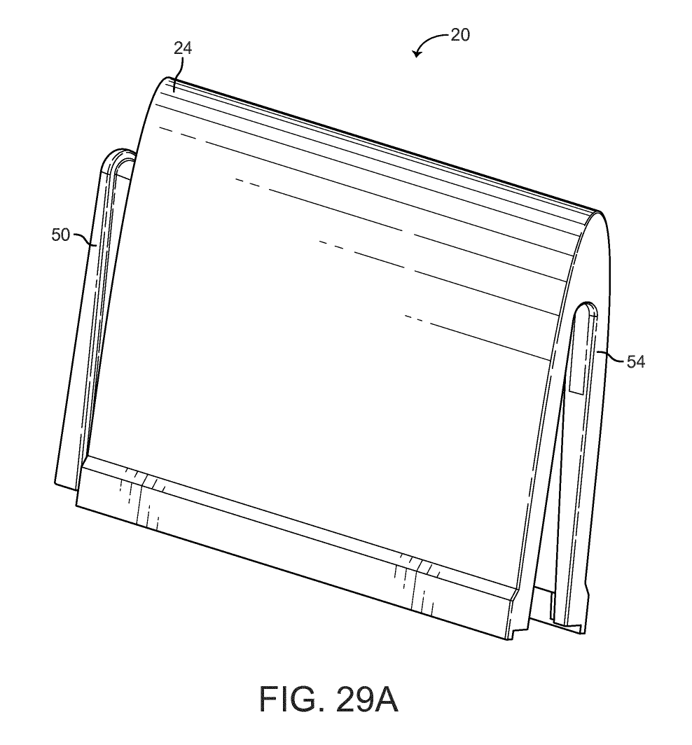

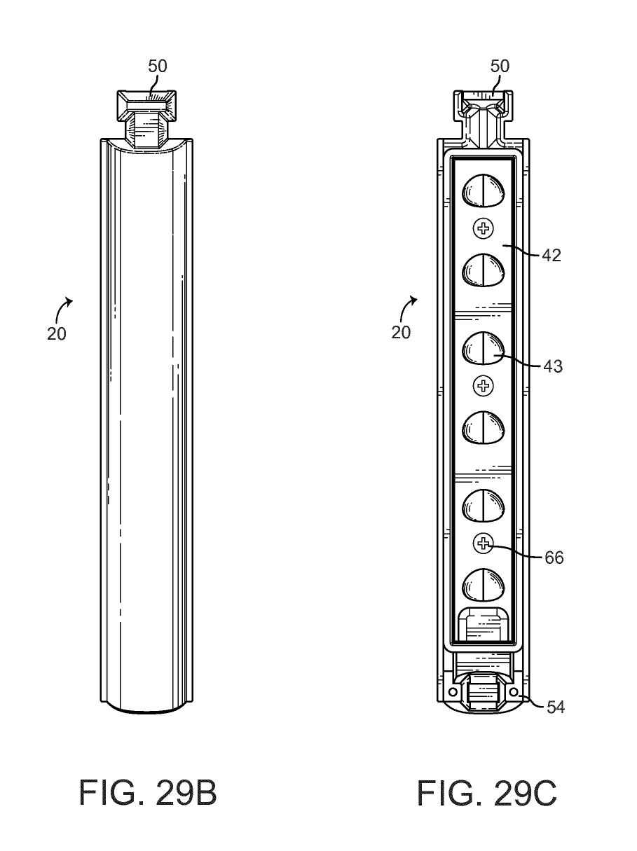

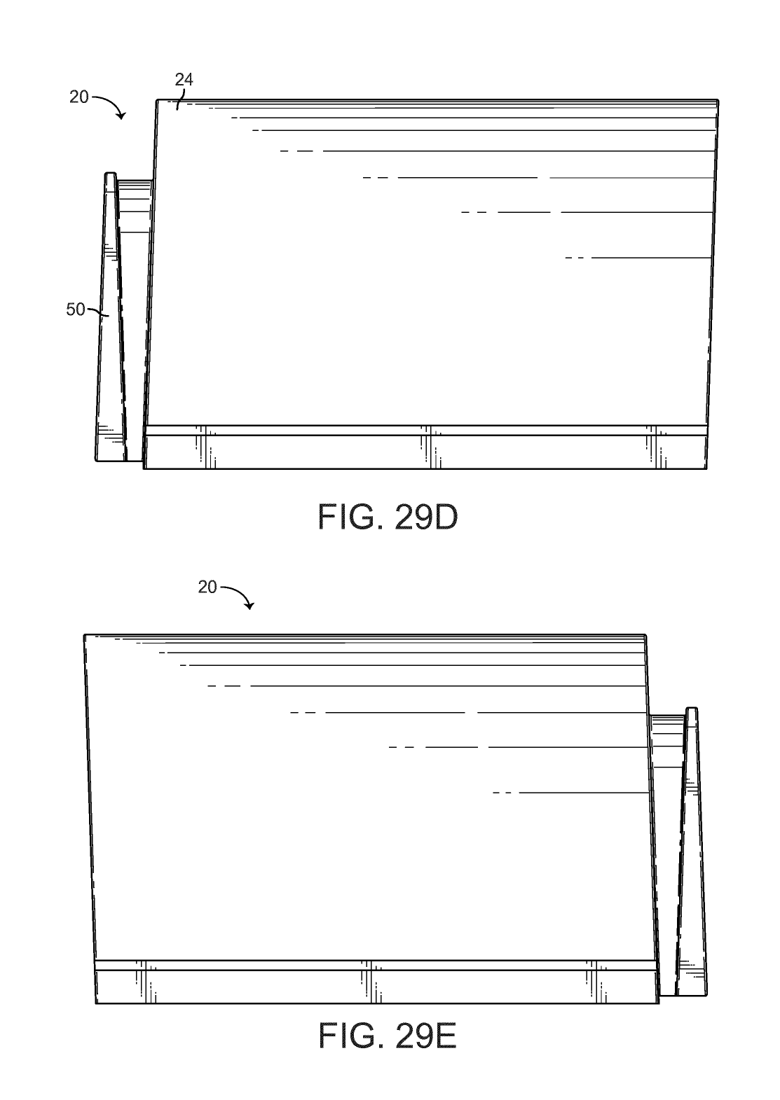

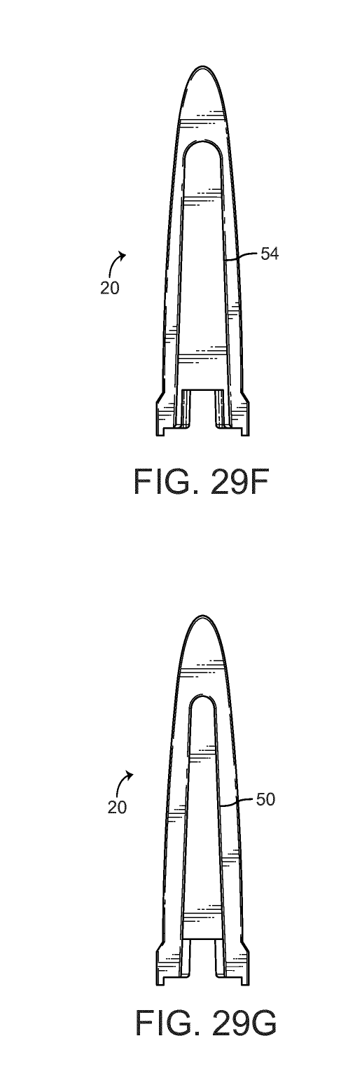

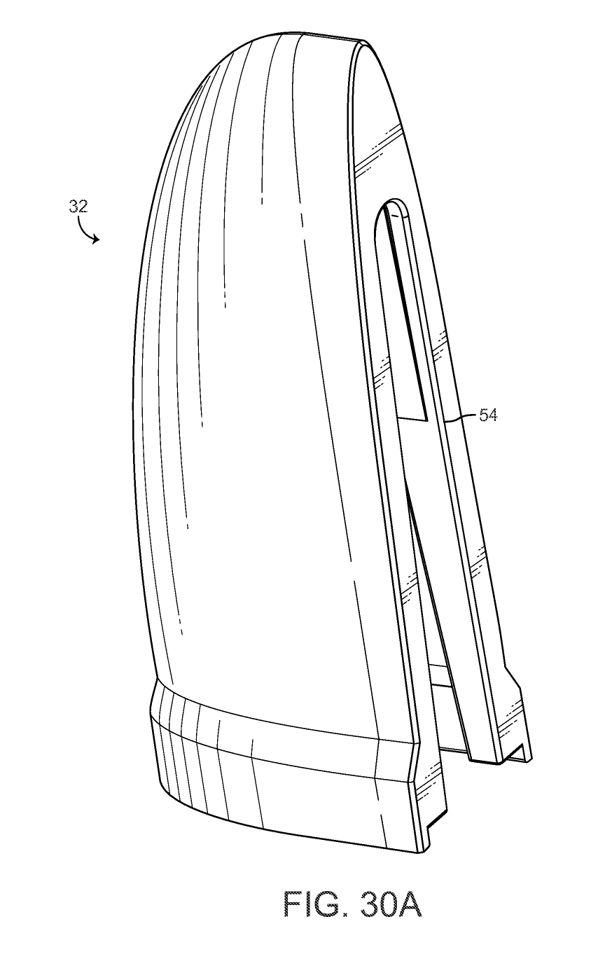

Referring now to FIGS. 29A-G, lamp module 20, a module of lighting fixture 10, is illustrated in various views according to one embodiment. Lamp module 20 is a module which may connect to first member 12 of lighting fixture 10, another lamp module 20, and/or support member 32 (e.g., a cap or terminal component for a string of one or more lamp modules 20 extending from first member 12). Lamp module 20 may be coupled to other components using flange 50 configured to be inserted into cutout 54. Lamp module 20 may also be coupled to other components using cutout 54. Cutout 54 may accept, receive, slip over, or otherwise interface with flange 50 of a lamp module 20 or flange 52 of first member 12. Lamp module 20 may be shaped to enhance heat transfer from lamp module 20 and/or light producing components therein. LED board 42 is fastened to lighting fixture by screws 66.

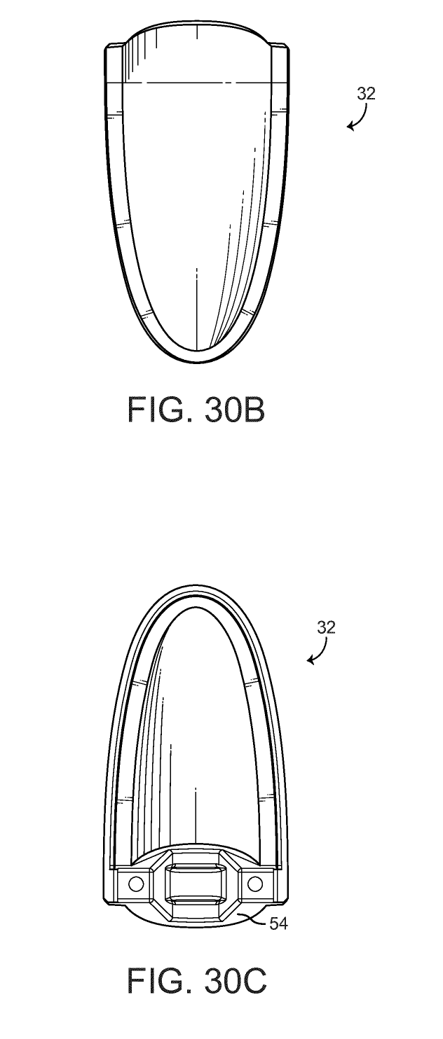

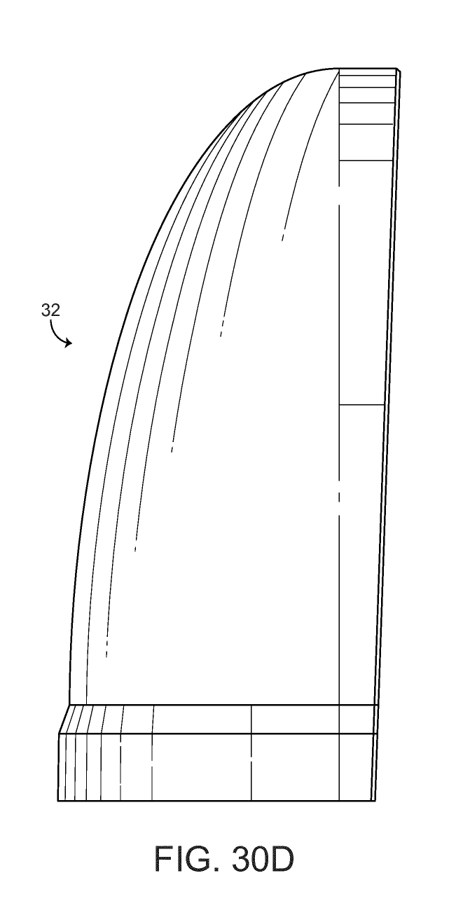

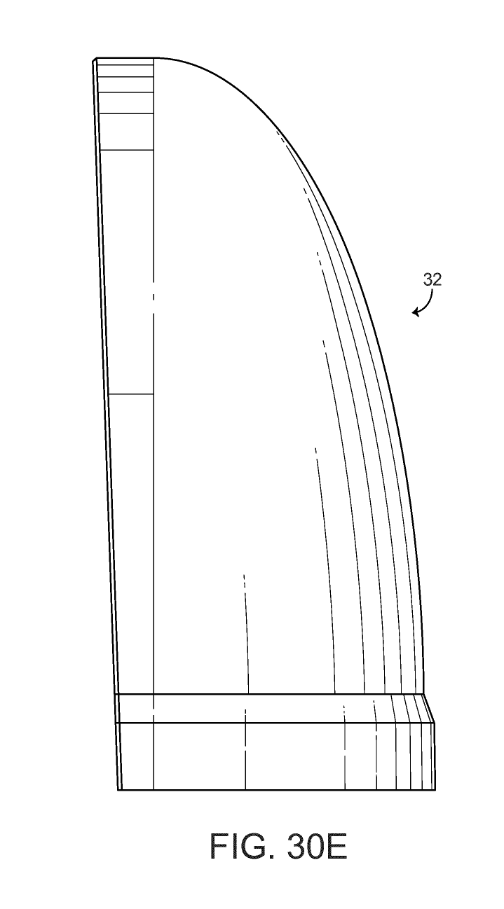

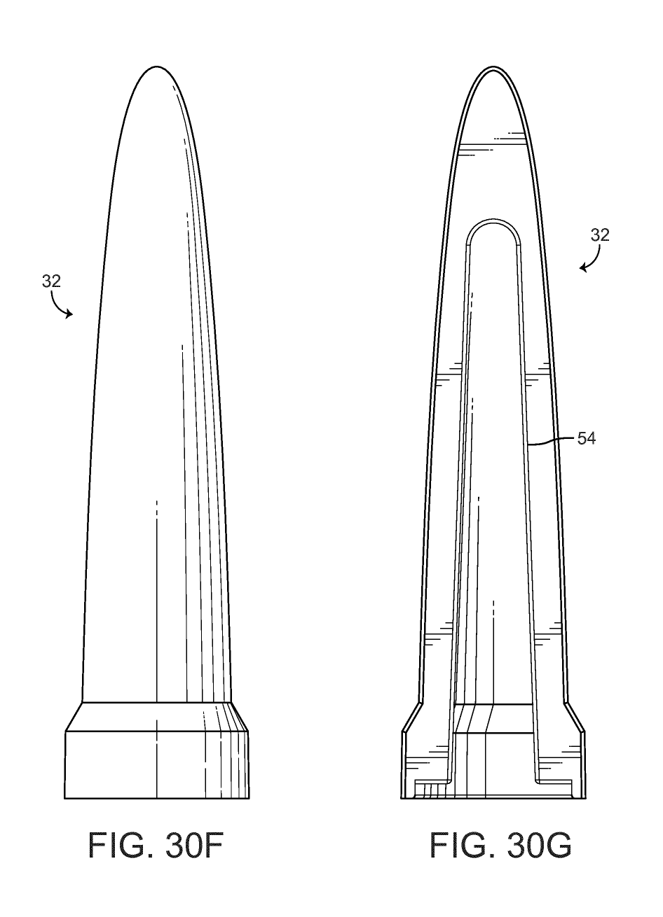

Referring now to FIGS. 30A-G, support member 32 is illustrated in various views according to one embodiment. Support member 32 may cap one row of one or more lamp modules 20. Support member 32 may include a cutout 54 for coupling with a flange 50 or flange 52. Support member 32 may be coupled to first member 12 or lamp module 20. Support member 32 may be aesthetic, may facilitate heat transfer, and/or serve other purposes.

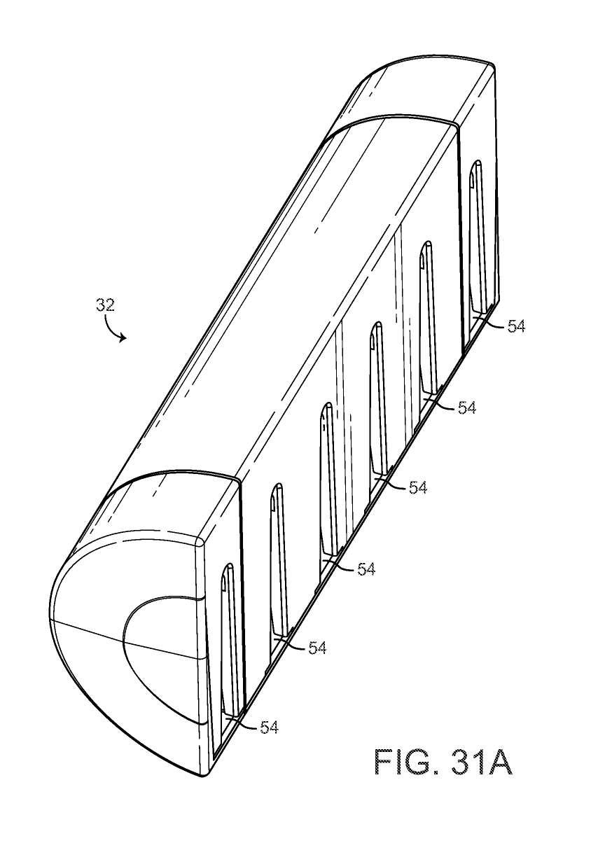

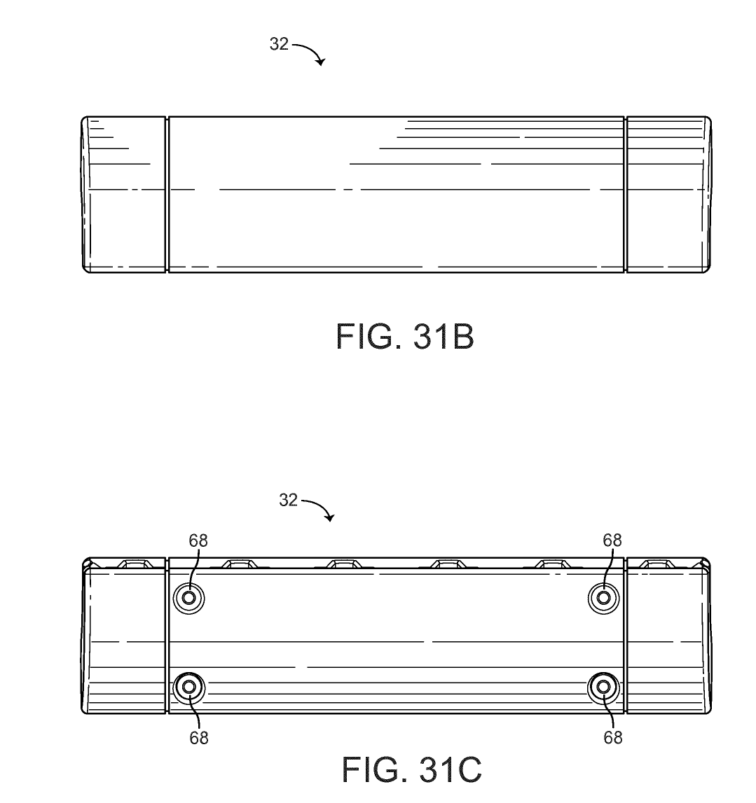

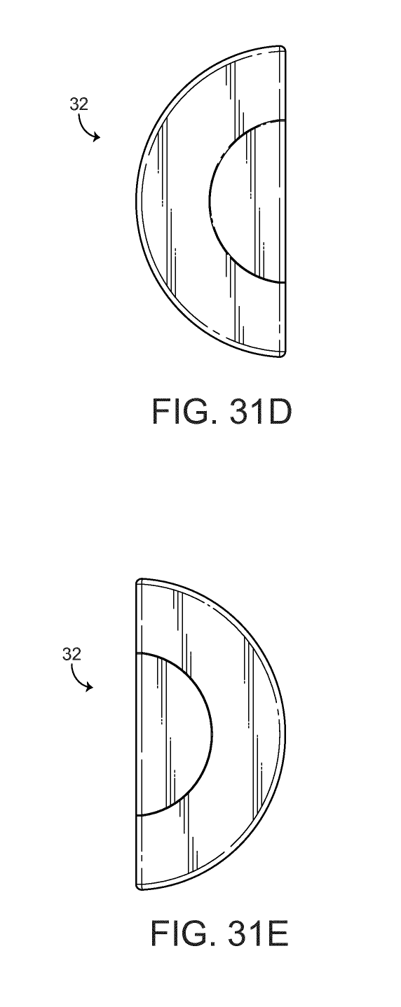

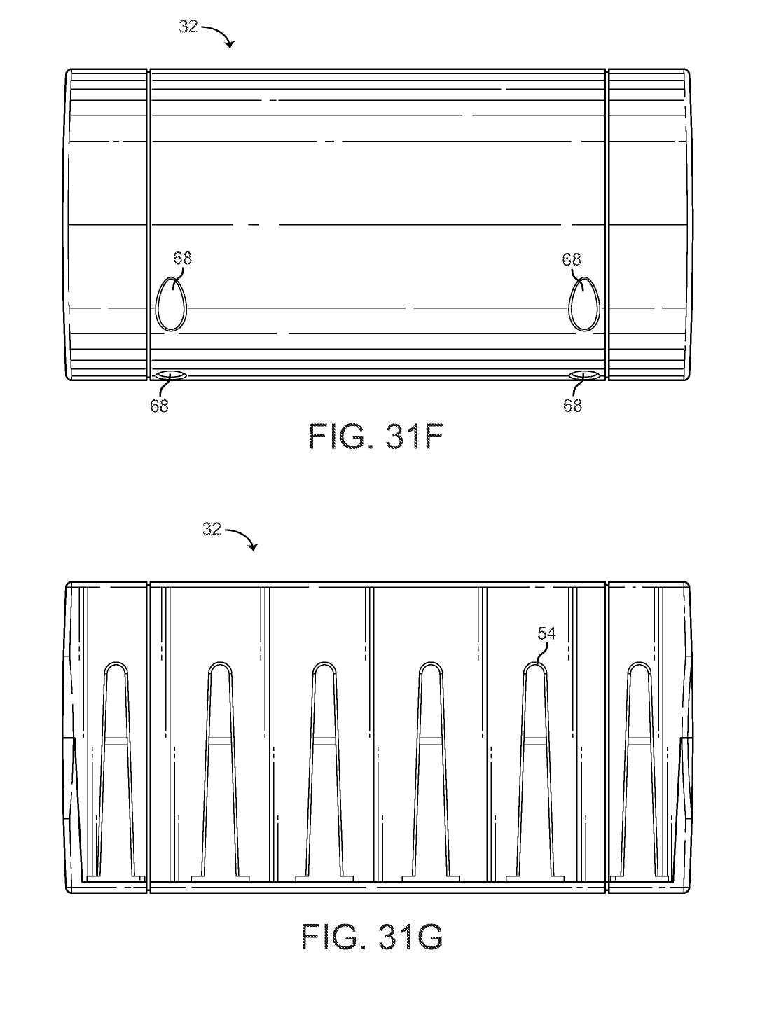

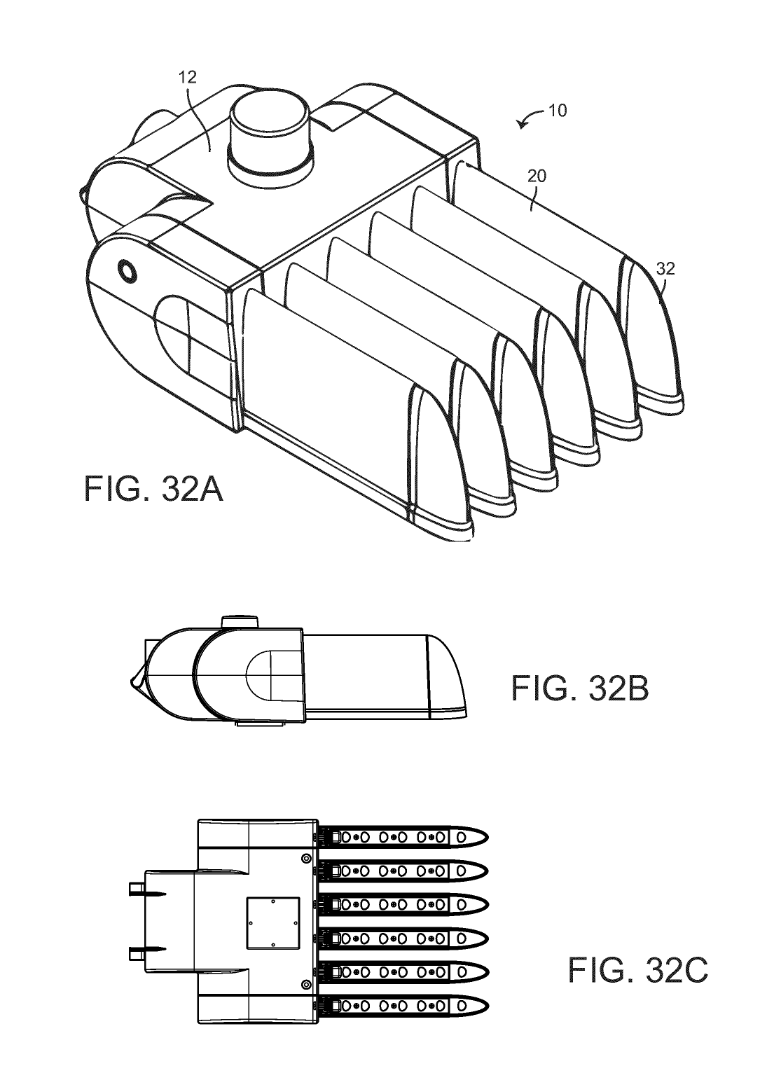

Referring now to FIGS. 31A-G, support member 32 is illustrated in various views according to one embodiment. Support member 32 may cap multiple rows of one or more lamp modules 20. Support member 32 may include cutouts 54 for coupling with flanges 50 or flanges 52. In alternative embodiments, other coupling members may be used (e.g., plates 40, rods 26, and/or other components). Support member 32 may be coupled to first member 12 or lamp modules 20. Support member 32 may be aesthetic, may facilitate heat transfer, and/or serve other purposes.

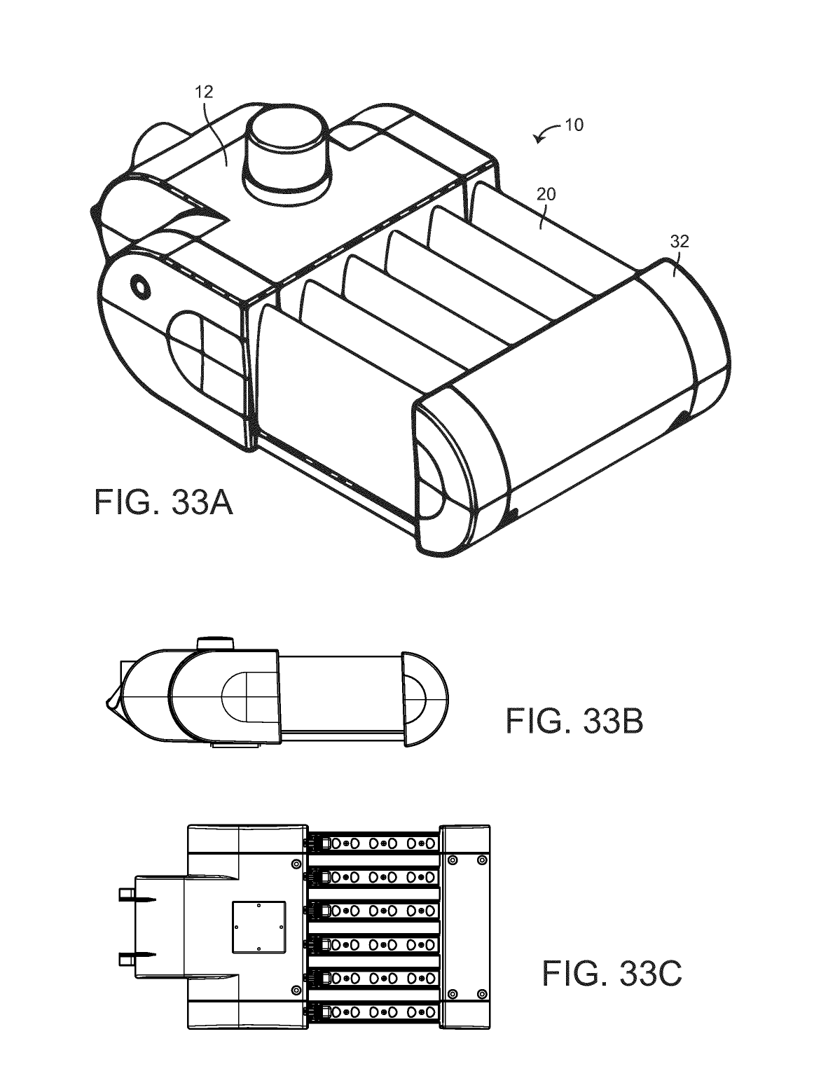

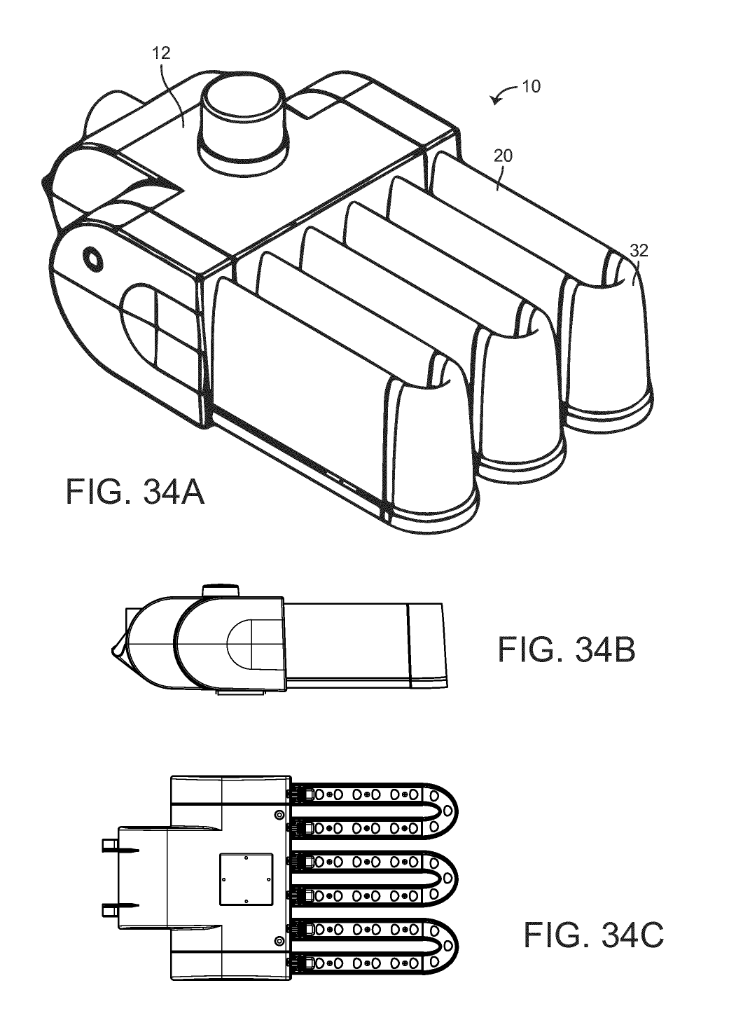

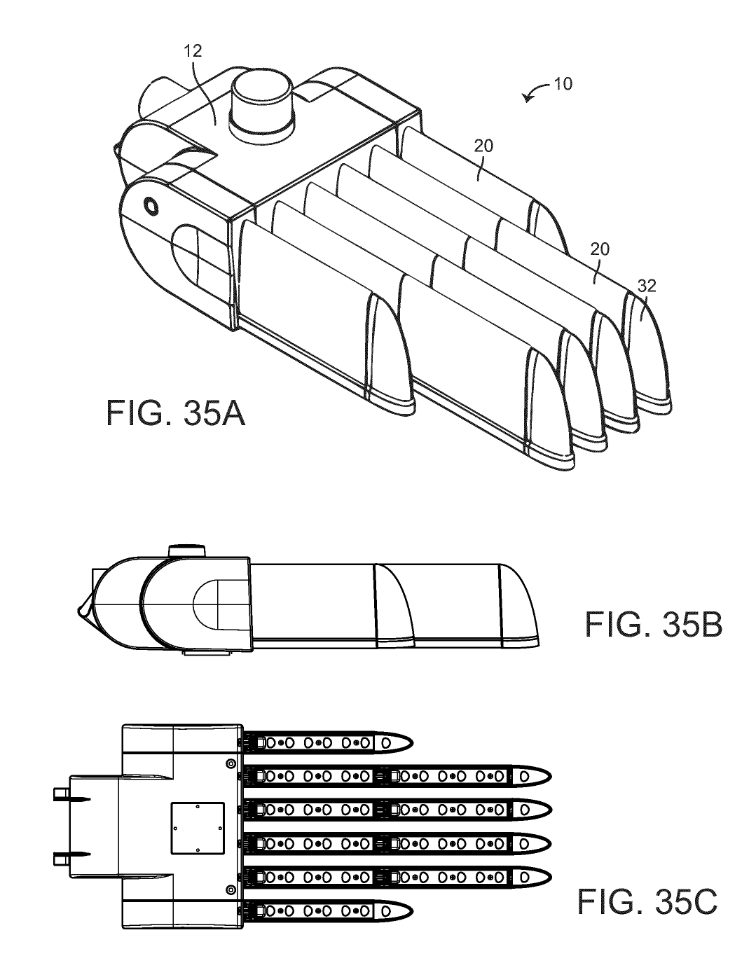

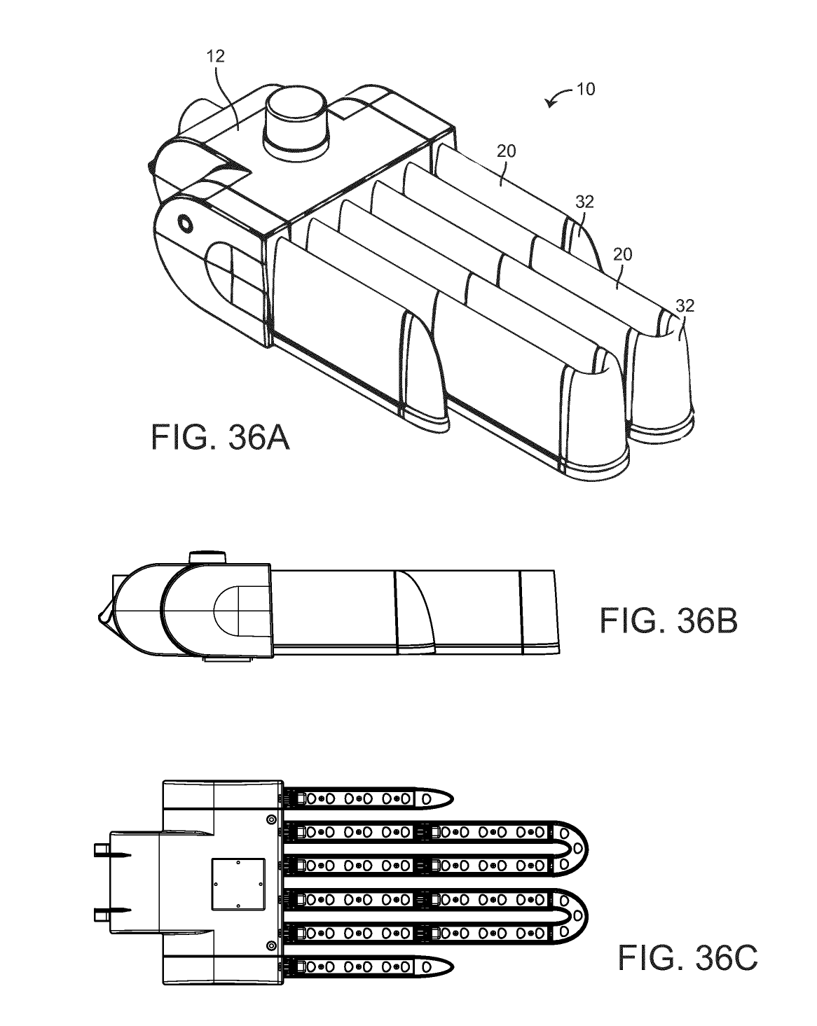

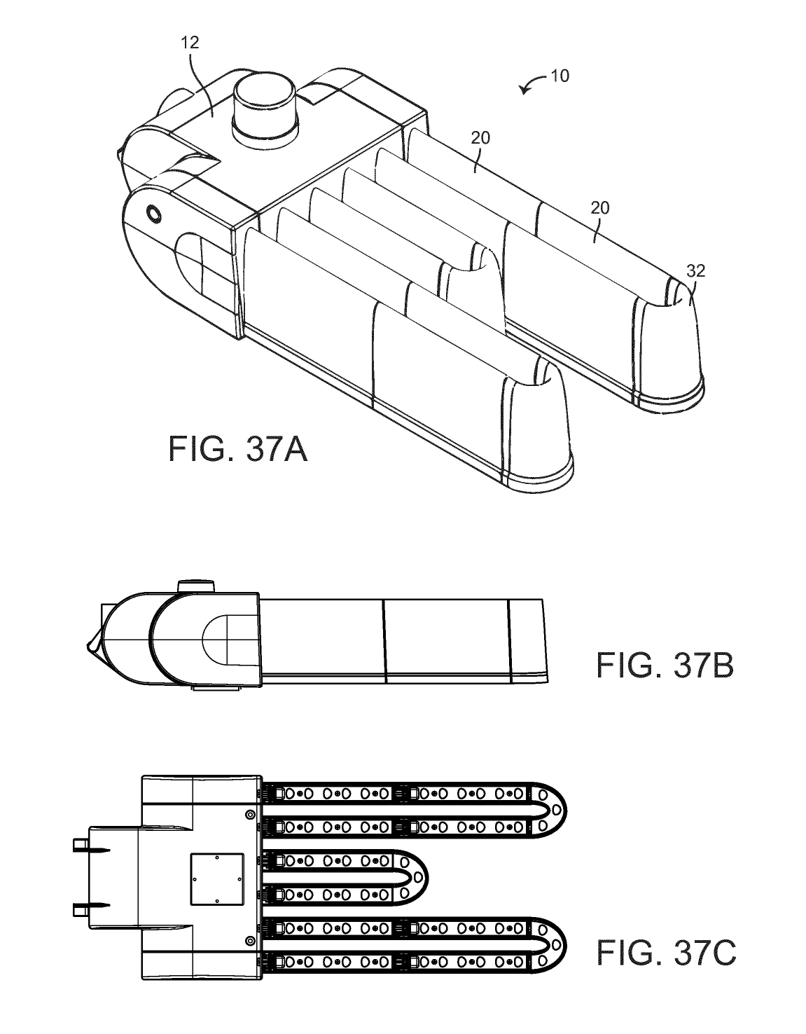

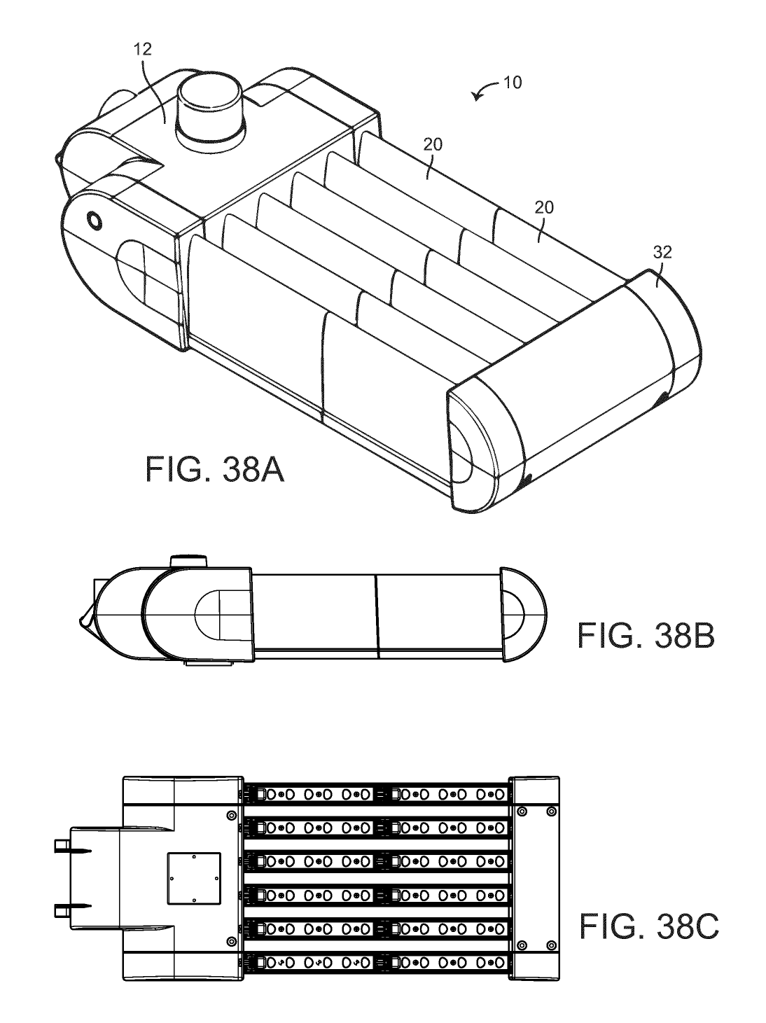

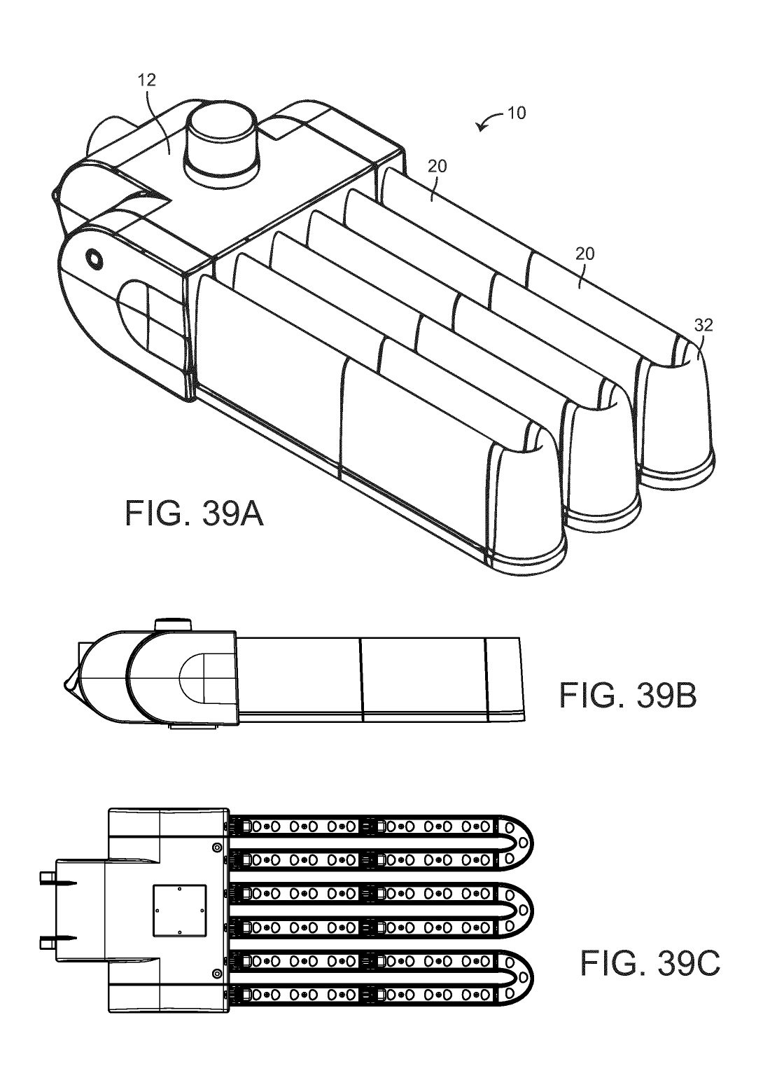

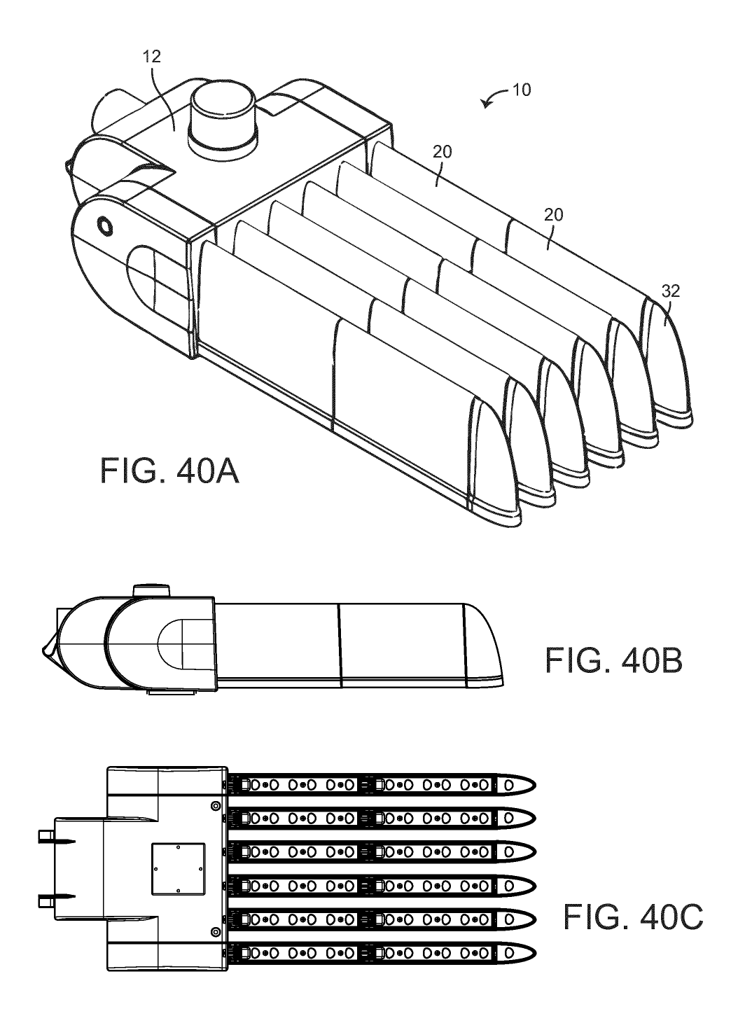

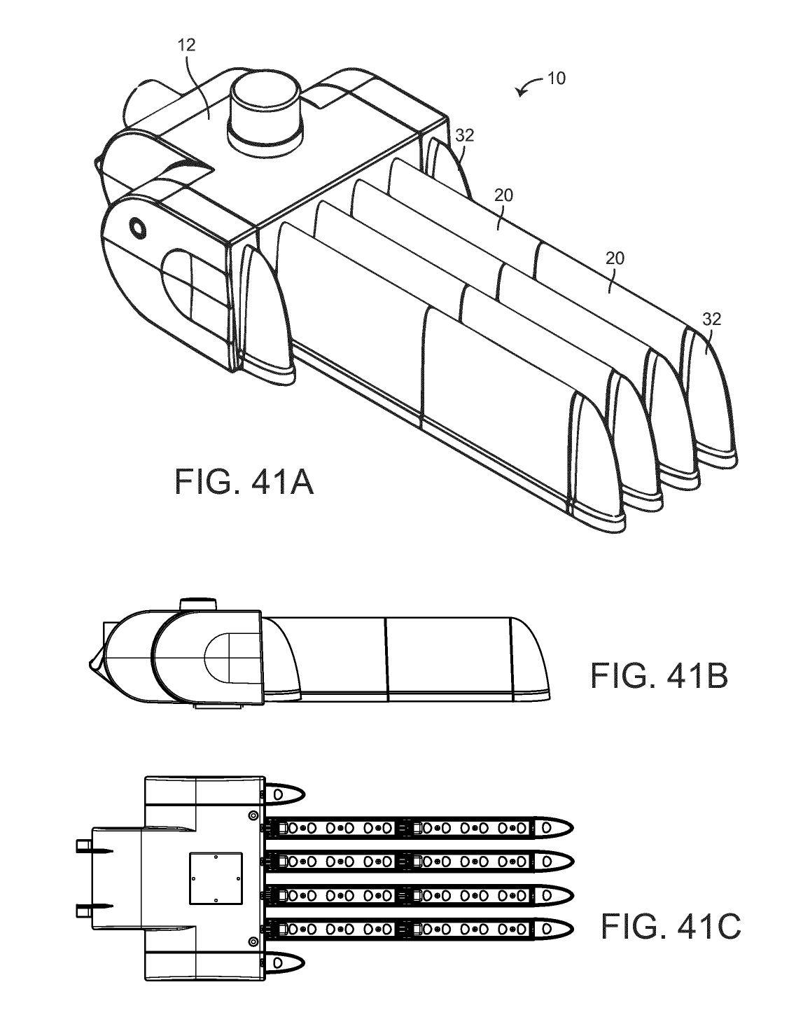

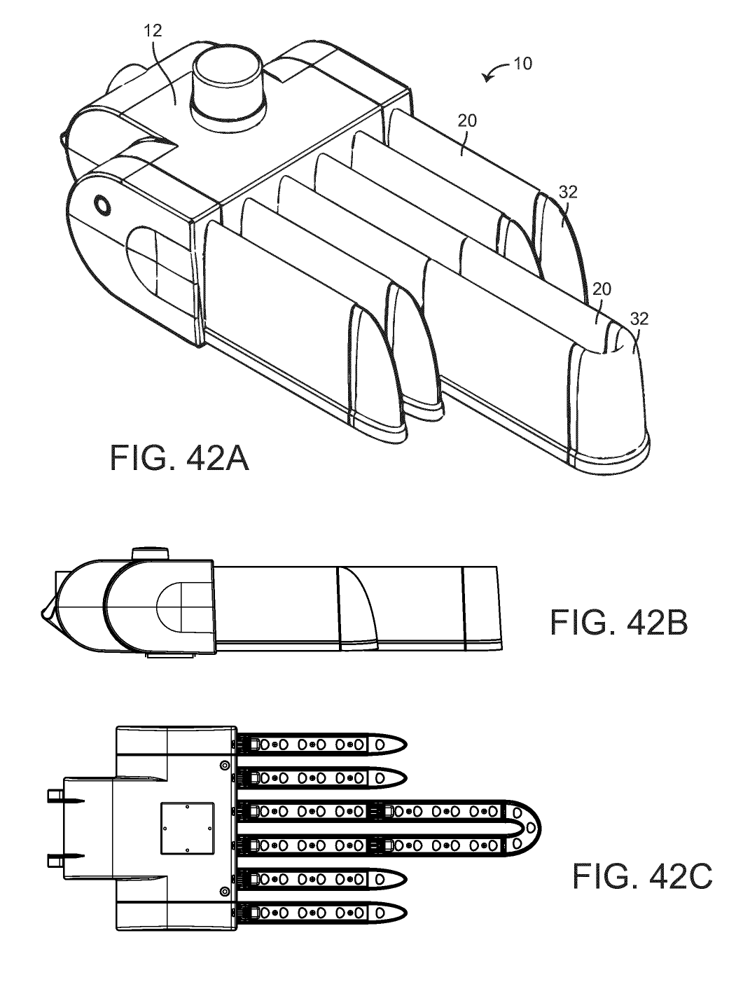

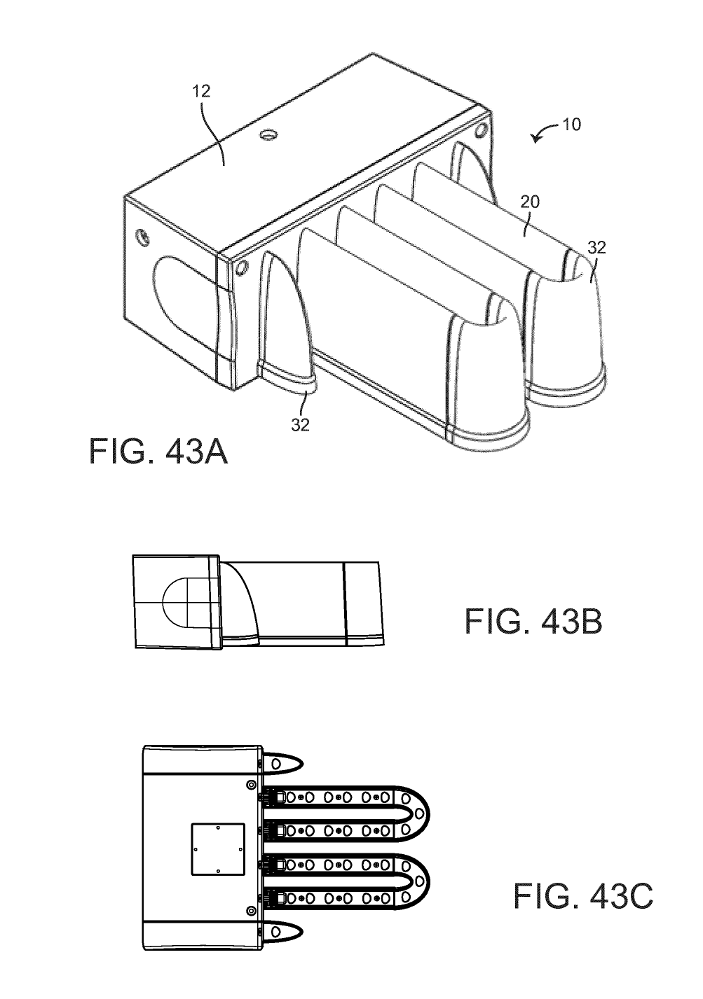

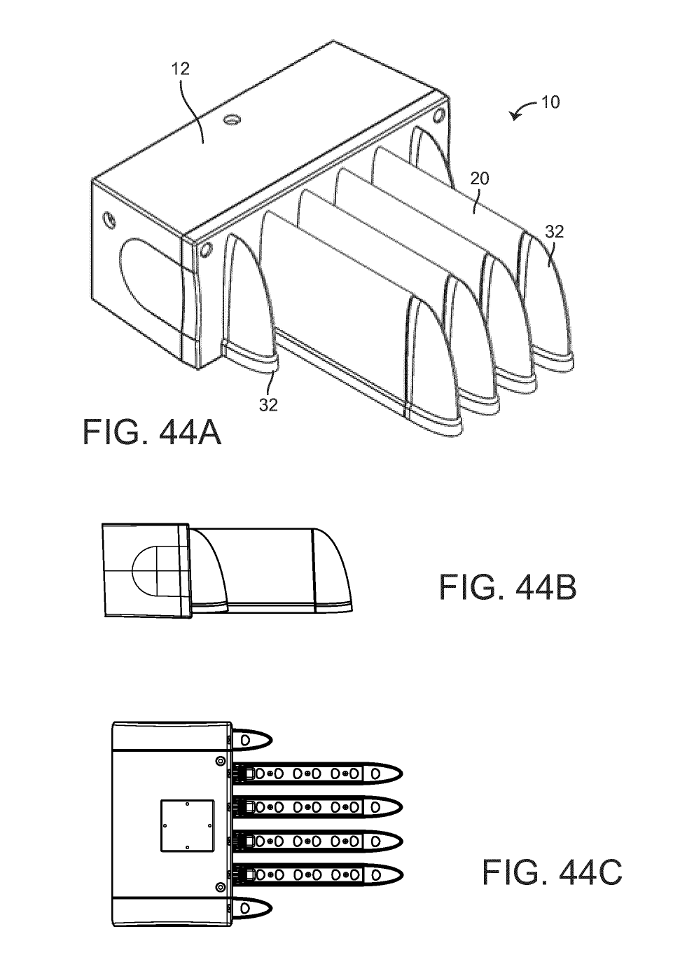

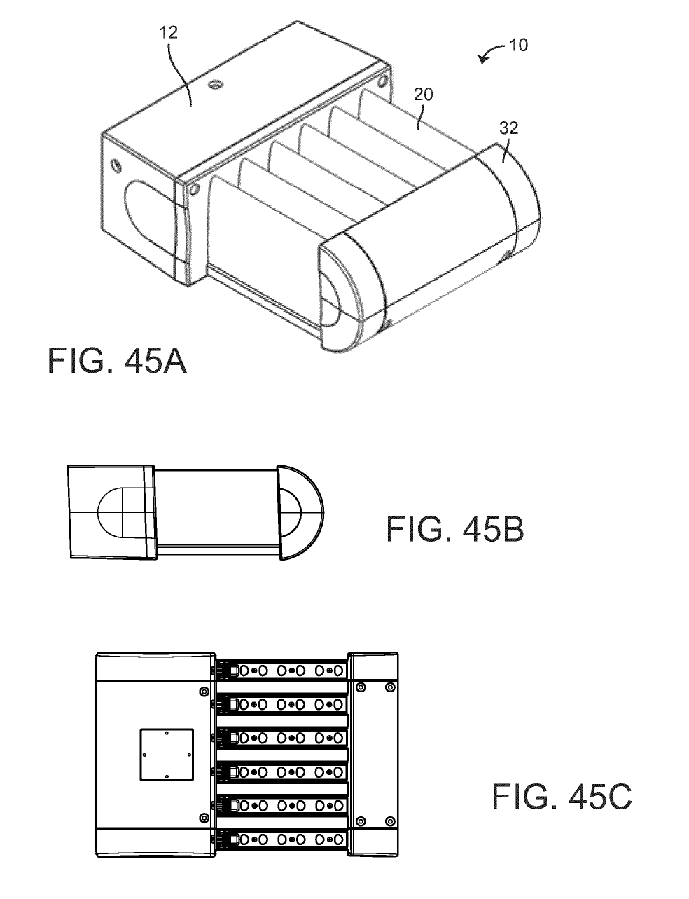

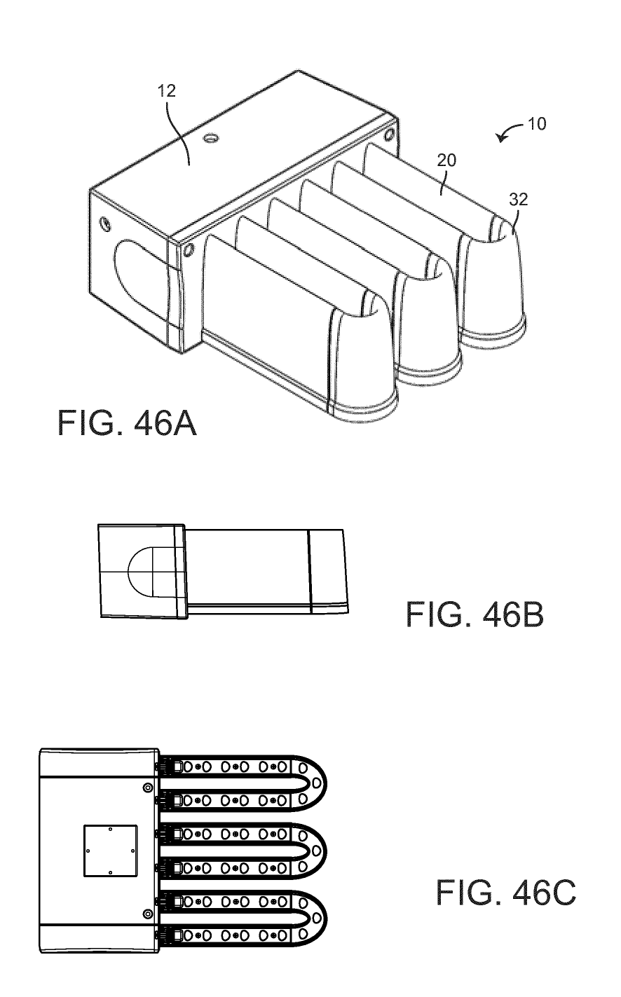

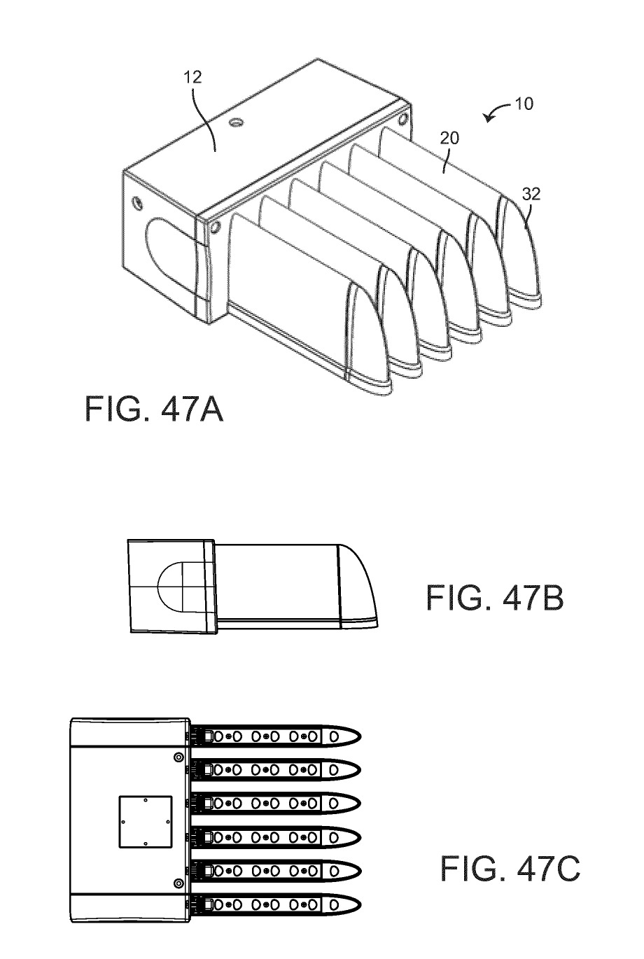

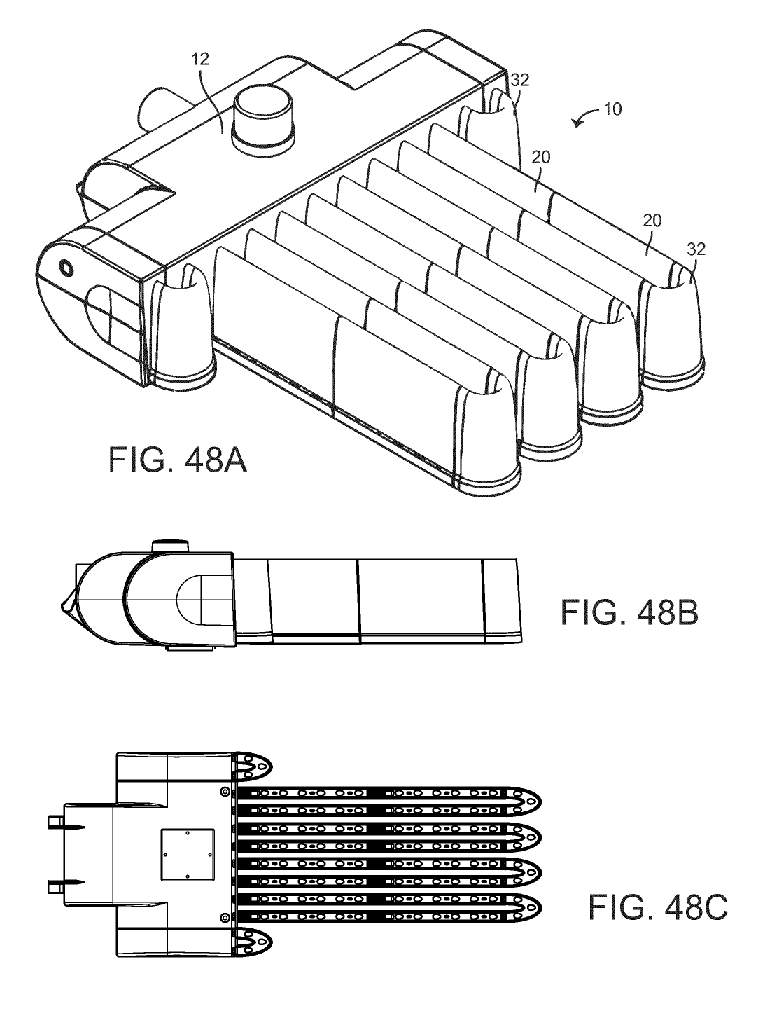

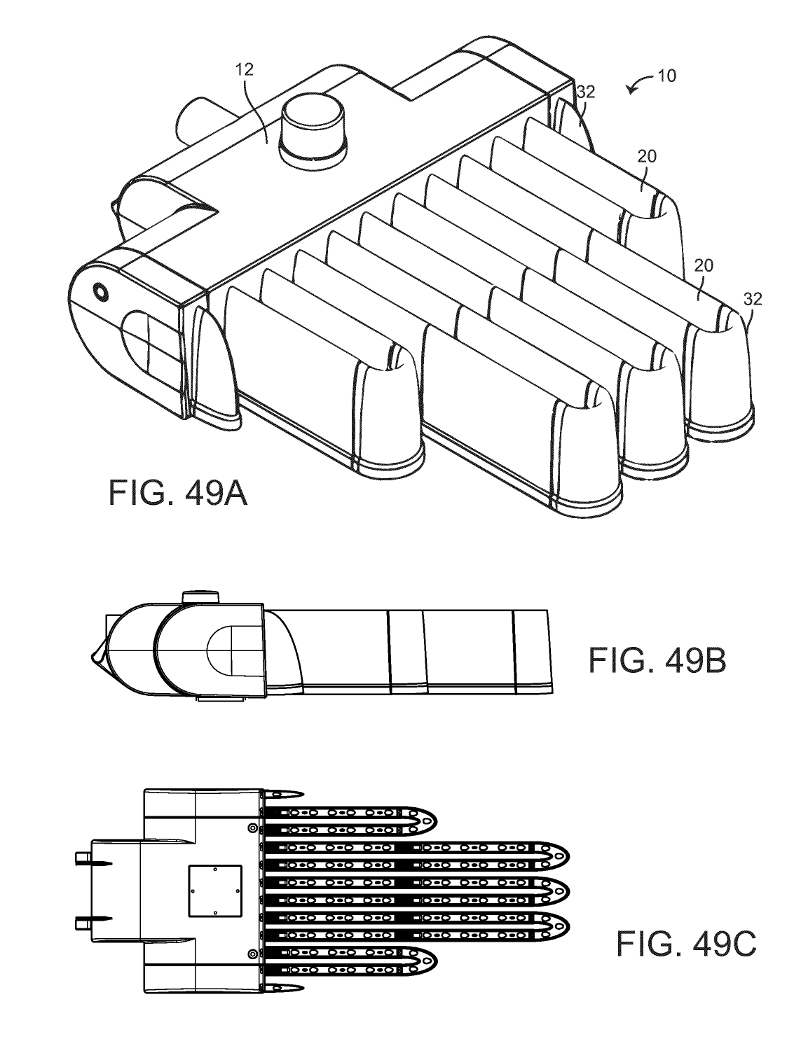

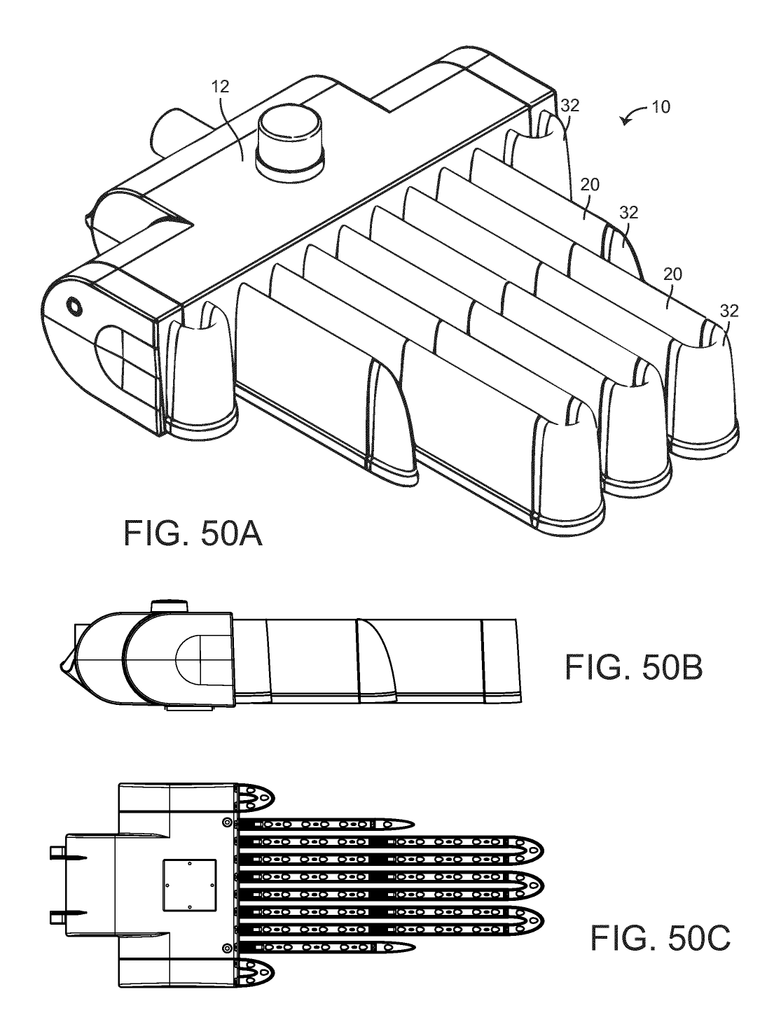

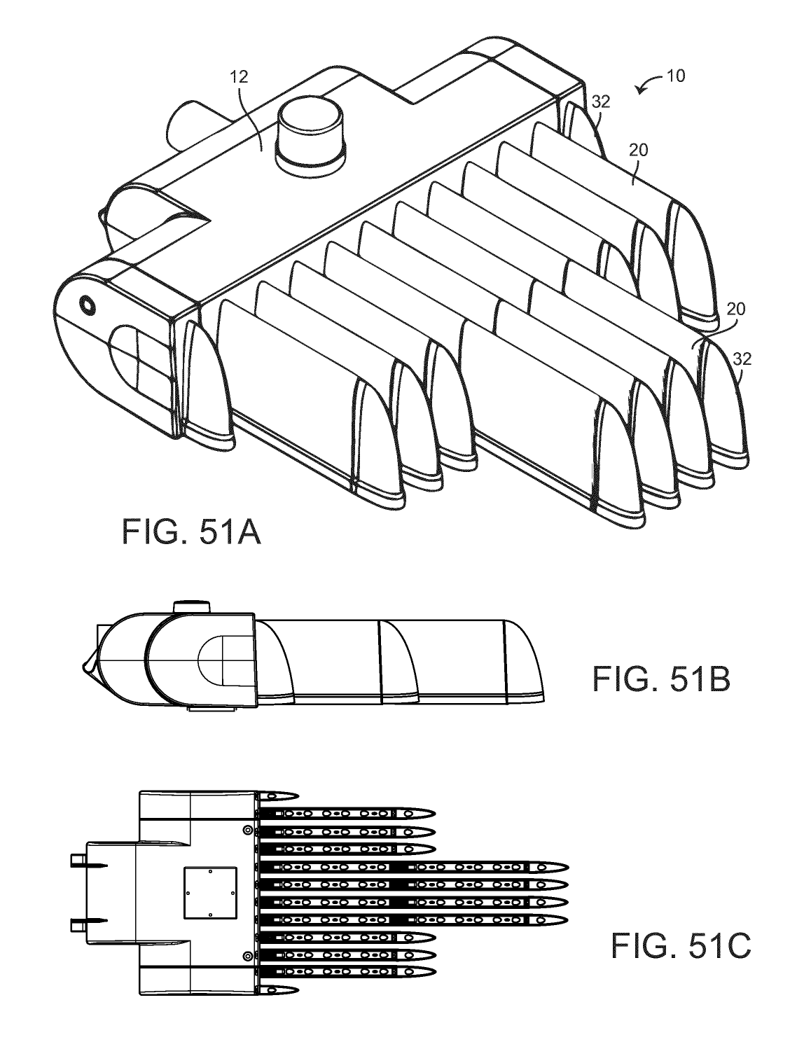

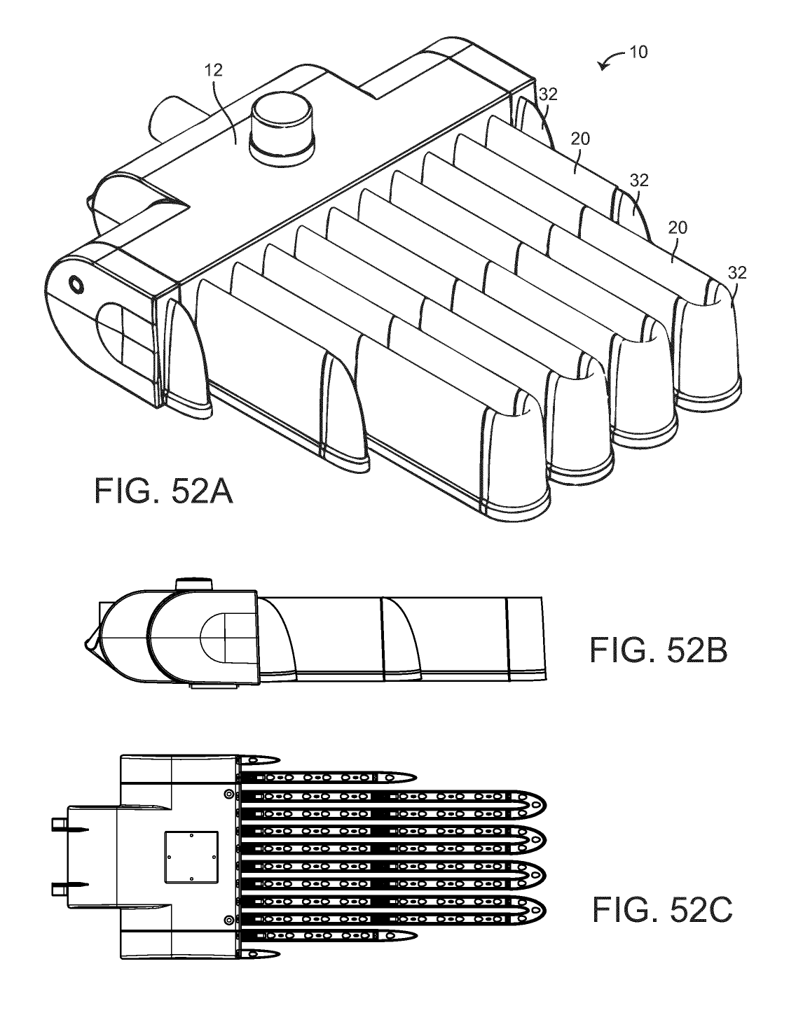

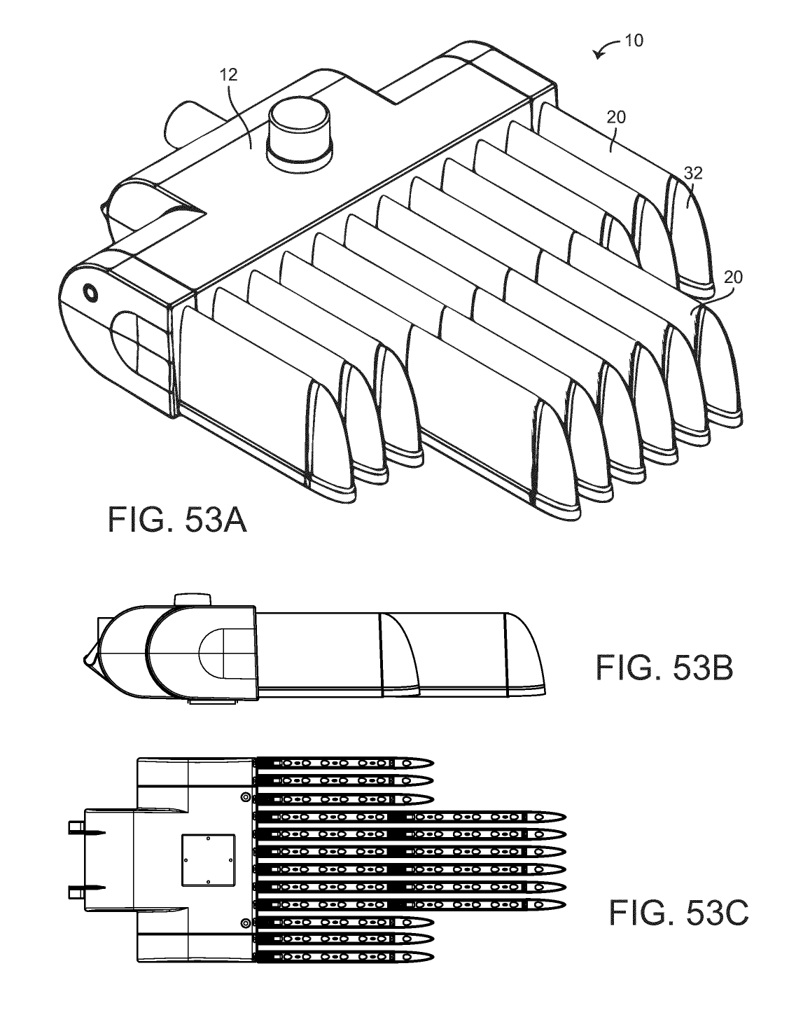

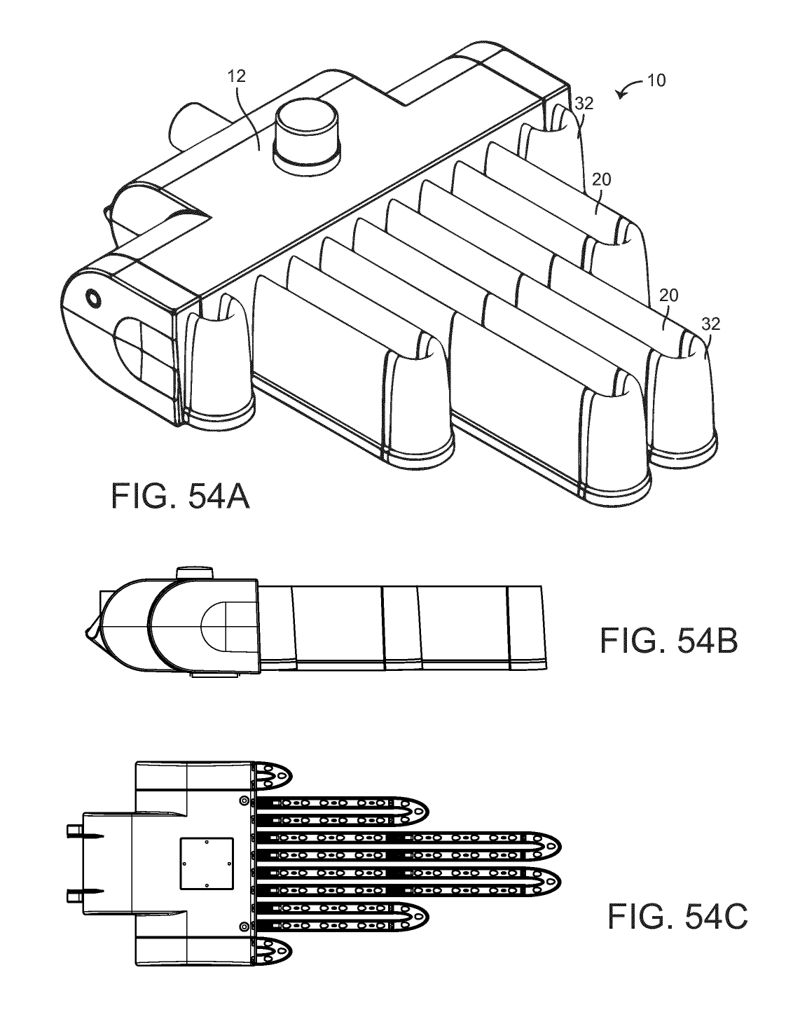

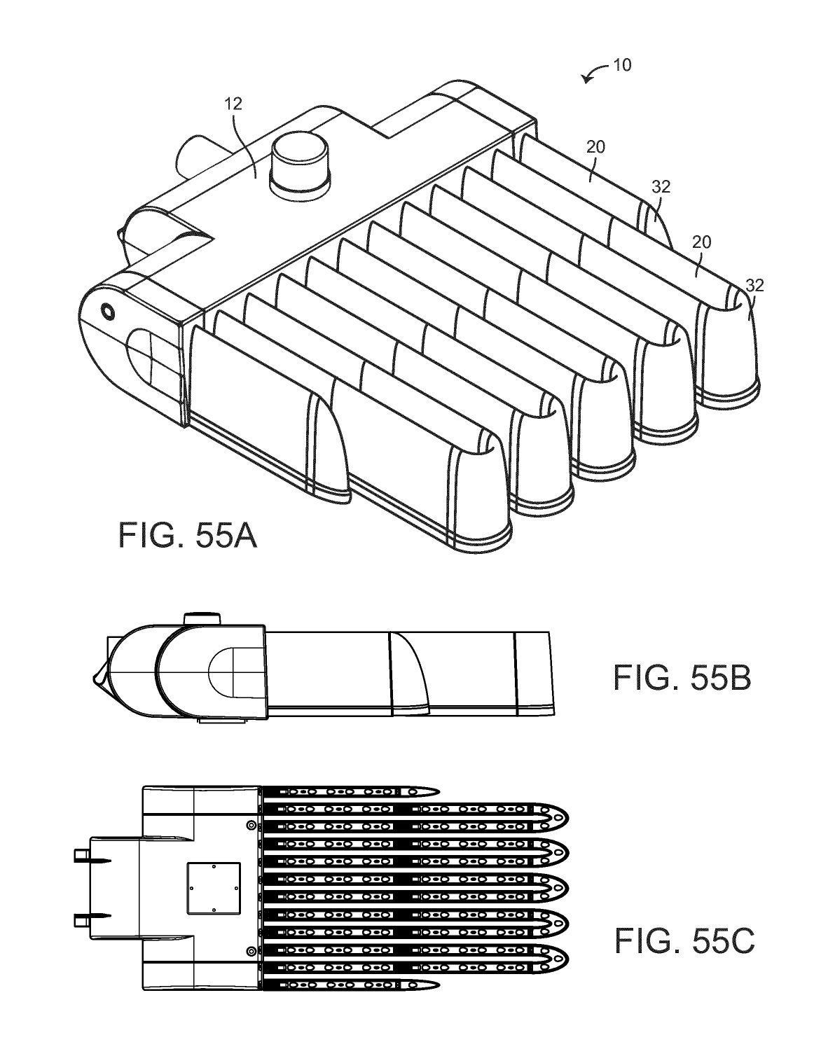

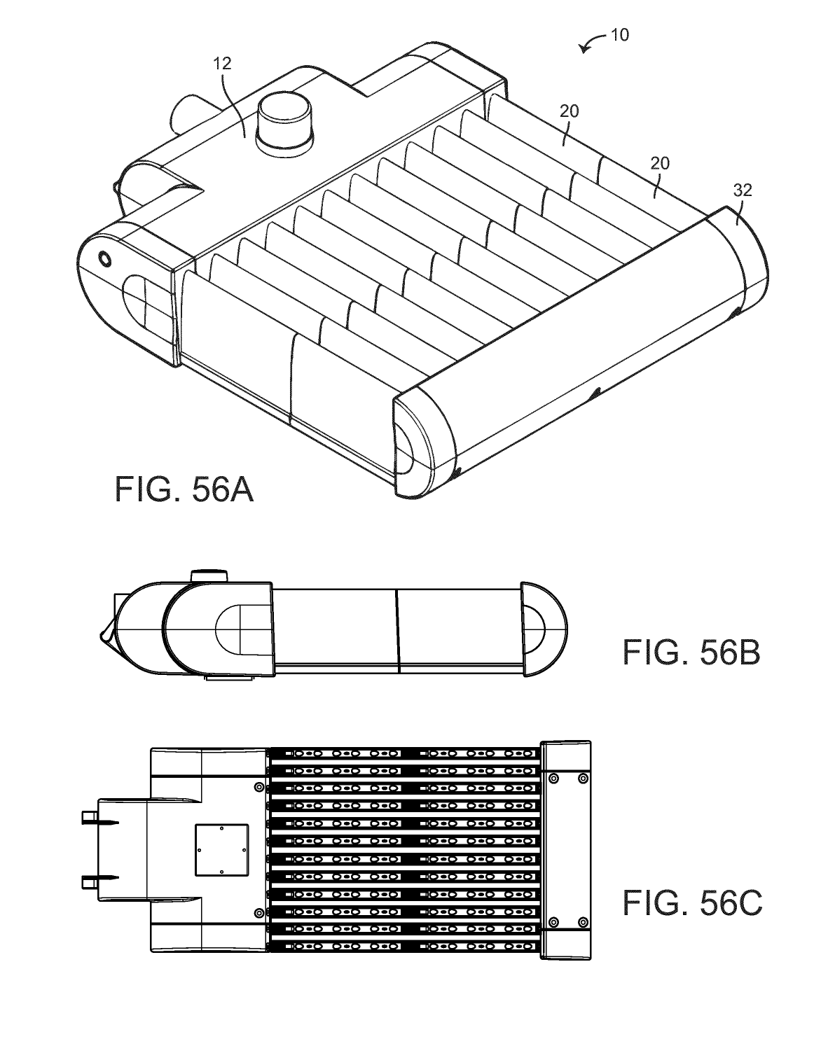

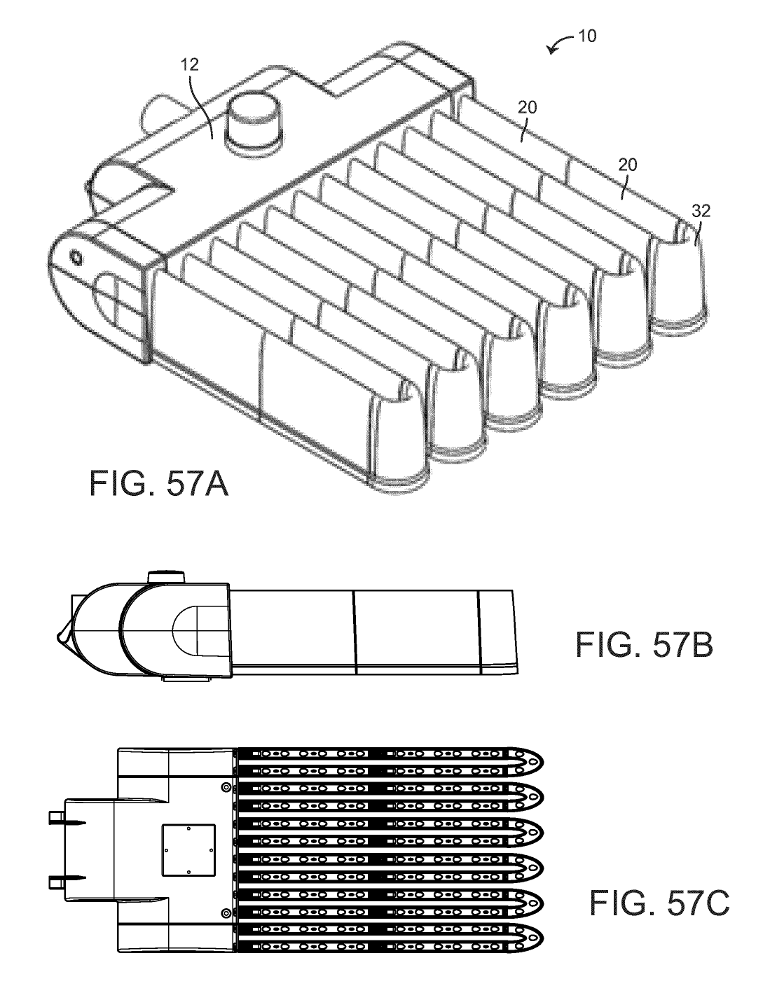

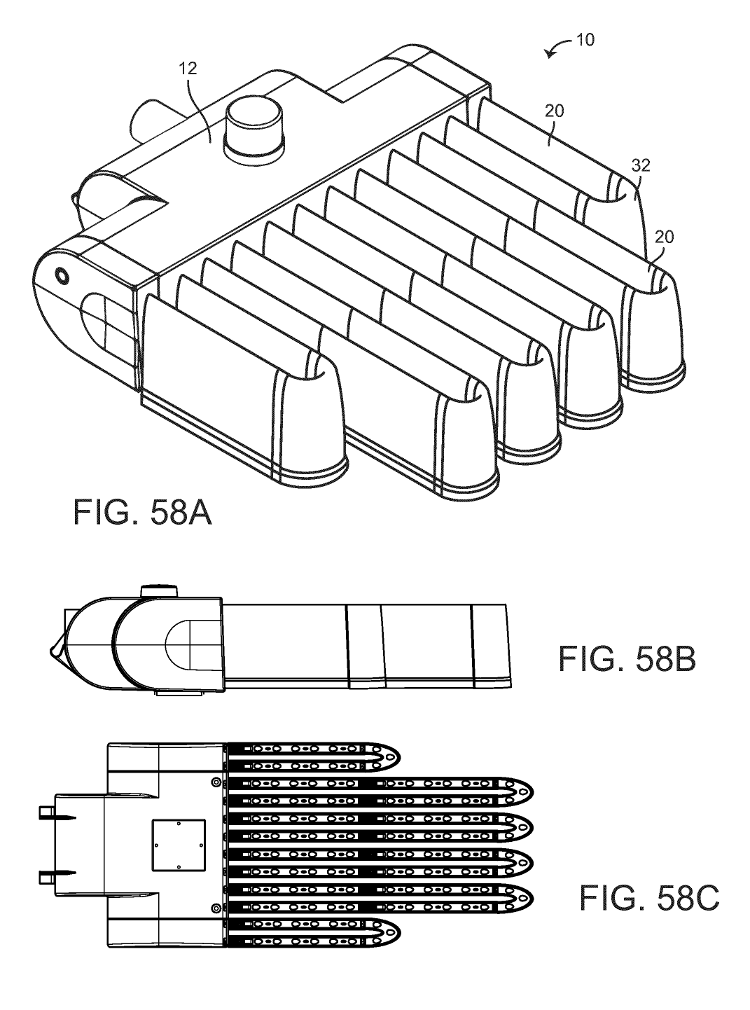

According to the various embodiments shown in FIGS. 32A-58C, core members 12, lamp modules 20, and caps 32 are selectively reconfigurable between a plurality of orientations to provide lighting fixtures 10 having different lighting profiles. As shown in FIGS. 32A-58C, a single cap 32 may be coupled to one lamp module 20, a pair of lamp modules 20, or a plurality of lamp modules 20 (e.g., six, twelve, etc.), according to various embodiments. In one embodiment, connectors coupling one or more of the core members 12, lamp modules 20, and caps 32 are configured to facilitate selectively reconfiguring lighting fixture 10 between two or more of the illustrated multi-tiered operating configurations. As shown in FIGS. 32A-47C, lighting fixture 10 includes six rows of lamp modules 20. As shown in FIGS. 48A-58C, lighting fixture 10 includes twelve rows of lamp modules 20. Lighting fixture 10 may be still otherwise shaped (e.g., with more or fewer tiers, with more or fewer rows, etc.) using another combination of core members 12, lamp modules 20, and caps 32 or still other components, according to other embodiments. Core members 12, and thereby lighting fixtures 10, may have one of many or an indeterminate width (e.g., with a break between the innermost rows of lamp modules 20, etc.). One or more lamp modules 20, and thereby lighting fixture 10, may have one of many or an indeterminate length. Lighting fixture 10 may have an indeterminate length with a break between adjacent tiers of lamp modules 20. While the accompanying drawings illustrate one or more exemplary embodiments, it should be understood that, according to other exemplary embodiments that should be considered to be within the possession of the inventors of the present application at the time this application is being filed, it is contemplated that any illustrated solid lines (or portions thereof) may be converted to broken lines and that any illustrated broken lines (or portions thereof) may be converted to solid lines so as to claim or disclaim portions, components, or sub-components of the designs shown. It is further contemplated that shading may be added or removed to claim or disclaim the corresponding surfaces.

As utilized herein, the terms “approximately,” “about,” “substantially,” “essentially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the lighting fixture as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, manufacturing processes, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

1. A lighting fixture, comprising:
a core member;
a first elongated lamp comprising a first light-emitting device, the first elongated lamp extending outwardly from the core member in a first longitudinal direction;
a second elongated lamp comprising a second light-emitting device, the second elongated lamp extending outwardly from the core member in a second longitudinal direction, wherein the second longitudinal direction is parallel to and offset from the first longitudinal direction such that a space is defined between the first elongated lamp and the second elongated lamp;
a cap coupled to at least one of the first elongated lamp and the second elongated lamp; and
a connector selectively coupling at least one of the first elongated lamp and the second elongated lamp to the core member,
wherein the first elongated lamp and the second elongated lamp are positioned such that the space at least one of (a) allows debris to pass therethrough and (b) increases the heat transfer coefficient of the first elongated lamp and the second elongated lamp by at least reducing an overlap between boundary layers, developed from natural convection, associated with the first elongated lamp and the second elongated lamp.

2. The lighting fixture of claim 1, wherein the first elongated lamp and the second elongated lamp are positioned such that the space is only wide enough to eliminate the overlap between boundary layers, developed from natural convection, associated with the first elongated lamp and the second elongated lamp.

3. The lighting fixture of claim 1, wherein the first elongated lamp and the second elongated lamp are positioned such that the space extends longitudinally between the core member and the cap.

4. The lighting fixture of claim 1, wherein the first elongated lamp comprises a first cover positioned above the first light-emitting device and the second elongated lamp comprises a second cover positioned above the second light-emitting device, the first cover and the second cover forming heat-dissipating bodies above and behind the first light-emitting device and the second light-emitting device.

5. The lighting fixture of claim 4, wherein the first light-emitting device comprises a first light-emitting diode thermally coupled to the first cover and the second light-emitting device comprises a second light-emitting diode thermally coupled to the second cover, the first cover and the second cover configured to radiate heat generated by the first light-emitting diode and the second light-emitting diode, respectively.

6. The lighting fixture of claim 5, wherein the first cover is tapered from a bottom end proximate the first light-emitting device to a top end opposite the bottom end, wherein the second cover is tapered from a bottom end proximate the second light-emitting device to a top end opposite the bottom end.

7. The lighting fixture of claim 6, wherein the first cover and the second cover have at least one of (a) substantially triangular profiles and (b) substantially parabolic profiles with curved upper portions merging into sloped sidewalls.

8. A lighting fixture, comprising:
a core member;
a first modular lamp comprising a first light-emitting device and a first cover configured to be positioned above the first light-emitting device, wherein the first modular lamp is configured to extend outwardly from the core member in a longitudinal direction;
a second modular lamp comprising a second light-emitting device and a second cover configured to be positioned above the second light-emitting device, wherein the second modular lamp is configured to extend outwardly from the core member in the longitudinal direction;
a cap configured to be coupled to at least one of the first modular lamp and the second modular lamp; and
a connector configured to selectively couple at least one of (a) the first modular lamp to the core member, (b) the second modular lamp to the core member, and (c) the first modular lamp to the second modular lamp such that the first modular lamp and the second modular lamp are selectively reconfigurable between a plurality of orientations to provide a plurality of different lighting profiles.

9. The lighting fixture of claim 8, wherein the connector comprises a first element defined by the first modular lamp and a second element defined by the second modular lamp such that each of the modular lamps are configured to be coupled to additional modular lamps.

10. The lighting fixture of claim 9, wherein the first element comprises at least one of a stud and a flange and the second element comprises a corresponding aperture.

11. The lighting fixture of claim 8, wherein the connector comprises a rod configured to extend along at least one of the first modular lamp and the second modular lamp.

12. The lighting fixture of claim 11, wherein the connector comprises a plate that defines an aperture configured to engage the rod and thereby secure at least one of the first modular lamp and the second modular lamp to the core member.

13. The lighting fixture of claim 8, wherein the core member is configured to be coupled to a plurality of modular lamps.

14. The lighting fixture of claim 8, wherein the first modular lamp and the second modular lamp are interchangeable and have substantially the same shape and construction.

15. A lighting fixture, comprising:
a core member; and
a first set of one or more elongated lamps each comprising a light-emitting device and a cover positioned above the light-emitting device, the first set of one or more elongated lamps having a proximal end and an opposing distal end;
a second set of one or more elongated lamps each comprising a light-emitting device and a cover positioned above the light-emitting device, the second set of one or more elongated lamps having a proximal end and an opposing distal end;
a cap coupled to the second set of one or more elongated lamps; and
one or more connectors coupling (a) the proximal end of the first set of one or more elongated lamps to the core member and (b) the proximal end of the second set of one or more elongated lamps to the opposing distal end of the first set of one or more elongated lamps, the one or more connectors configured to facilitate selectively reconfiguring the lighting fixture between two or more multi-tiered operating configurations.

16. The lighting fixture of claim 15, wherein the one or more connectors comprise a first element defined by the first set of one or more elongated lamps and a second element defined by the second set of one or more elongated lamps, wherein the first element comprises at least one of a stud and a flange and the second element comprises a corresponding aperture.

17. The lighting fixture of claim 15, wherein the one or more connectors comprise a rod extending along at least one of the first set of one or more elongated lamps and the second set of one or more elongated lamps.

18. The lighting fixture of claim 17, wherein the one or more connectors comprise a plate that defines an aperture configured to engage the rod and thereby secure at least one of the first set of one or more elongated lamps and the second set of one or more elongated lamps to the core member.

19. The lighting fixture of claim 15, wherein the core member is configured to be coupled to the first set of one or more elongated lamps.

20. The lighting fixture of claim 15, wherein the first set of one or more elongated lamps and the second set of one or more elongated lamps are interchangeable and have substantially the same shape and construction.
